(19) United States
(12) Patent Application Publication
(10) Pub. No.: US 2024/0147490 A1
(43) Pub. Date: May 2, 2024

(54) METHOD AND APPARATUS FOR BEAM INDICATION AND ASSOCIATION FOR CONTROL AND DATA CHANNELS

(71) Applicant: Samsung Electronics Co., Ltd., Suwon-si (KR)

(72) Inventors: Dalin Zhu, Allen, TX (US); Eko Onggosanusi, Coppell, TX (US); Emad Nader Farag, Flanders, NJ (US)

(21) Appl. No.: 18/486,130

(22) Filed: Oct. 12, 2023

Related U.S. Application Data
(60) Provisional application No. 63/419,583, filed on Oct. 26, 2022.
(60) Provisional application No. 63/419,597, filed on Oct. 26, 2022.
(60) Provisional application No. 63/420,987, filed on Oct. 31, 2022.
(60) Provisional application No. 63/426,989, filed on Nov. 21, 2022.
(60) Provisional application No. 63/443,255, filed on Feb. 3, 2023.
(60) Provisional application No. 63/446,715, filed on Feb. 17, 2023.

(51) Int. Cl. H04W 72/23; H04B 7/06; H04B 7/08

(52) U.S. Cl. CPC H04W 72/23; H04B 7/0686; H04B 7/0802

(57) ABSTRACT

Methods and apparatuses for beam indication and association for control and data channels. A method by a user equipment (UE) includes receiving a first radio resource control (RRC) configuration related to one or more transmission configuration indication (TCI) states for reception of a physical downlink control channel (PDCCH); receiving a second RRC configuration related to one or more TCI states for reception of a physical downlink shared channel (PDSCH); receiving, in downlink control information (DCI), an indicator related to the one or more TCI states for reception of the PDSCH; and receiving a timing threshold for reception of the PDSCH. The method further includes identifying, based on the first RRC configuration, one or more TCI states to use for reception of the PDCCH and identifying, based on (i) the timing threshold and (ii) the second RRC configuration or the indicator in the DCI, one or more TCI states to use for reception of the PDSCH.

### CROSS-REFERENCE TO RELATED AND CLAIM OF PRIORITY

The present application claims priority under 35 U.S.C. § 119(e) to U.S. Provisional Patent Application No. 63/419,583 filed on Oct. 26, 2022; U.S. Provisional Patent Application No. 63/419,597 filed on Oct. 26, 2022; U.S. Provisional Patent Application No. 63/420,987 filed on Oct. 31, 2022; U.S. Provisional Patent Application No. 63/426,989 filed on Nov. 21, 2022; U.S. Provisional Patent Application No. 63/443,255 filed on Feb. 3, 2023; and U.S. Provisional Patent Application 63/446,715 filed on Feb. 17, 2023, which is hereby incorporated by reference in their entirety.

### TECHNICAL FIELD

The present disclosure relates generally to wireless communication systems and, more specifically, the present disclosure relates to methods and apparatus for beam indication and association for control and data channels.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to beam indication and association for control and data channels.

In one embodiment, a user equipment (UE) is provided. The UE includes a transceiver configured to receive a first radio resource control (RRC) configuration related to one or more transmission configuration indication (TCI) states for reception of a physical downlink control channel (PDCCH); receive a second RRC configuration related to one or more TCI states for reception of a physical downlink shared channel (PDSCH); receive, in downlink control information (DCI), an indicator related to the one or more TCI states for reception of the PDSCH; and receive a timing threshold for reception of the PDSCH. The UE further includes a processor operably coupled to the transceiver. The processor is configured to identify, based on the first RRC configuration, one or more TCI states to use for reception of the PDCCH and identify, based on (i) the timing threshold and (ii) the second RRC configuration or the indicator in the DCI, one or more TCI states to use for reception of the PDSCH.

In another embodiment, a base station (BS) is provided. The BS includes a transceiver configured to transmit a first RRC configuration related to one or more TCI states for reception of a PDCCH; transmit a second RRC configuration related to one or more TCI states for reception of a PDSCH; transmit, in DCI, an indicator related to the one or more TCI states for reception of the PDSCH; and transmit a timing threshold for reception of the PDSCH. The first RRC configuration indicates one or more TCI states to use for reception of the PDCCH. The timing threshold and the second RRC configuration or the indicator in the DCI indicate one or more TCI states to use for reception of the PDSCH.

In yet another embodiment, a method performed by a UE is provided. The method includes receiving a first RRC configuration related to one or more TCI states for reception of a PDCCH; receiving a second RRC configuration related to one or more TCI states for reception of a PDSCH; receiving, in DCI, an indicator related to the one or more TCI states for reception of the PDSCH; and receiving a timing threshold for reception of the PDSCH. The method further includes identifying, based on the first RRC configuration, one or more TCI states to use for reception of the PDCCH and identifying, based on (i) the timing threshold and (ii) the second RRC configuration or the indicator in the DCI, one or more TCI states to use for reception of the PDSCH.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates an example of a multiple transmission and reception point (multi-TRP) system according to embodiments of the present disclosure;

FIG. 8 illustrates a flowchart of an example algorithm for determining which of the indicated transmission configuration indication (TCI) state(s) to use for receiving physical downlink control channel (PDCCH) candidates according to embodiments of the present disclosure;

FIG. 9 illustrates a flowchart of an example procedure for determining which of the indicated TCI state(s) to use for physical downlink shared channel (PDSCH) reception(s) according to embodiments of the present disclosure; and

FIG. 10 illustrates a flowchart of another example procedure for determining which of the indicated TCI state(s) to use for PDSCH reception(s) according to embodiments of the present disclosure.

### DETAILED DESCRIPTION

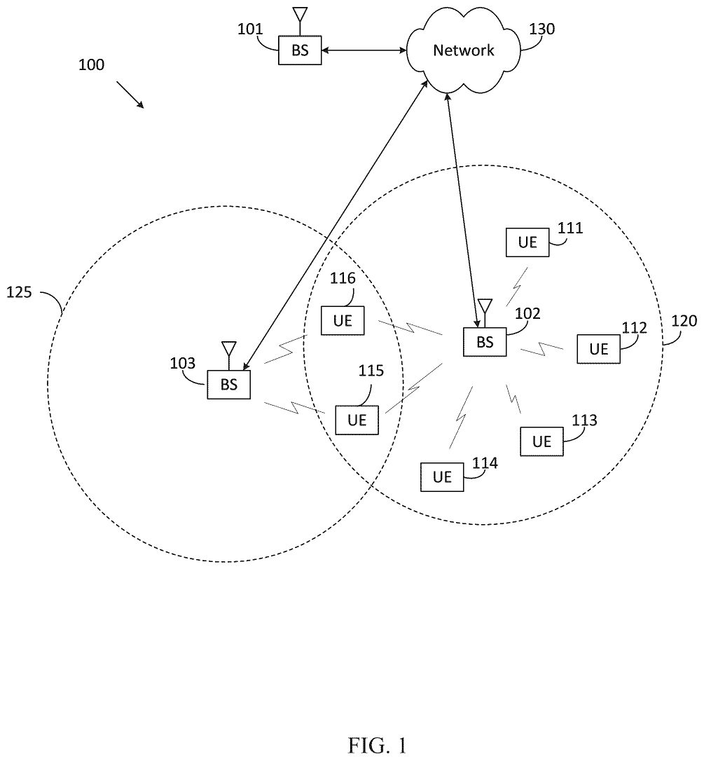

FIGS. 1-10, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v16.1.0, “NR; Physical channels and modulation;” [2] 3GPP TS 38.212 v16.1.0, “NR; Multiplexing and Channel coding;” [3] 3GPP TS 38.213 v16.1.0, “NR; Physical Layer Procedures for Control;” [4] 3GPP TS 38.214 v16.1.0, “NR; Physical Layer Procedures for Data;” [5] 3GPP TS 38.321 v16.1.0, “NR; Medium Access Control (MAC) protocol specification;” and [6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing beam indication and association for control and data channels. In certain embodiments, one or more of the BSs 101-103 include circuitry, programing, or a combination thereof to support beam indication and association for control and data channels.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

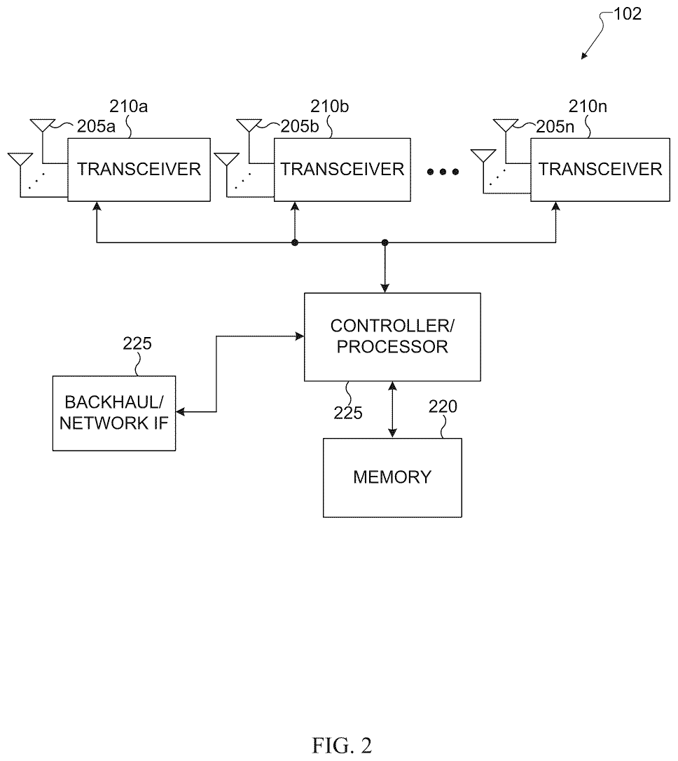

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting beam indication and association for control and data channels. Any of a wide variety of other functions could be supported in the gNB 102 by the controller/processor 225.

The controller/processor 225 is also capable of executing programs and other processes resident in the memory 230, such as processes to support beam indication and association for control and data channels. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

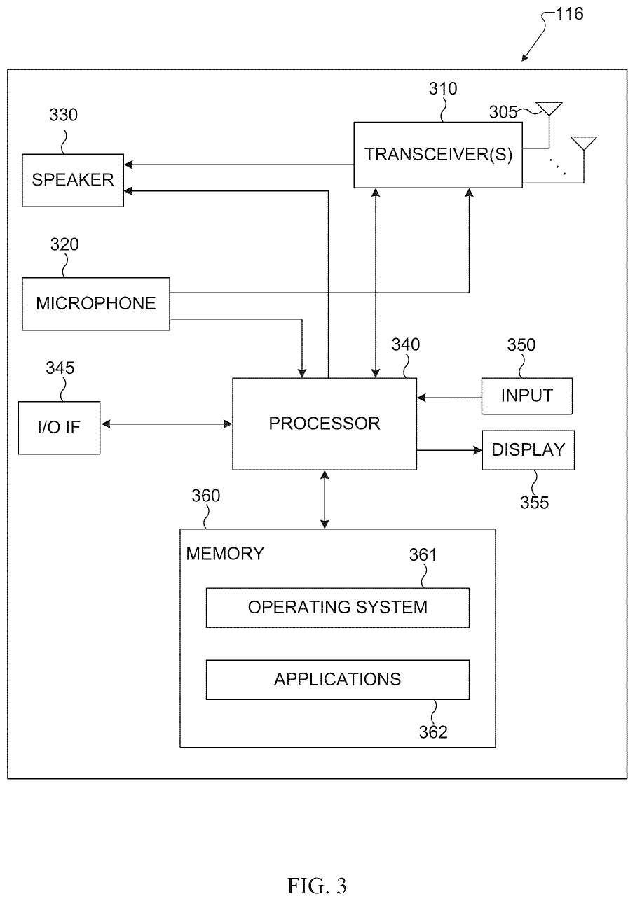

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing beam indication and association for control and data channels as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

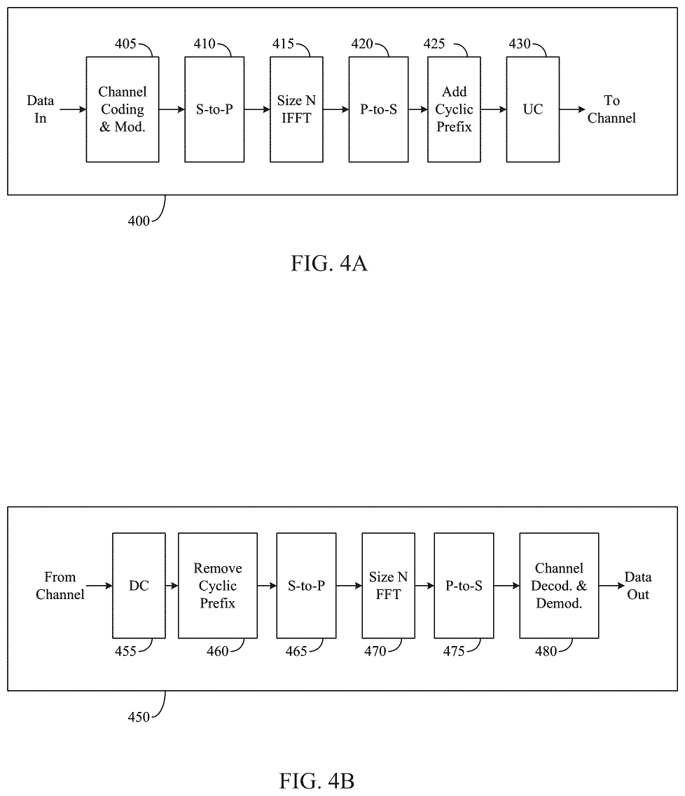

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured to support beam indication and association for control and data channels as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or sounding reference signal (SRS). In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

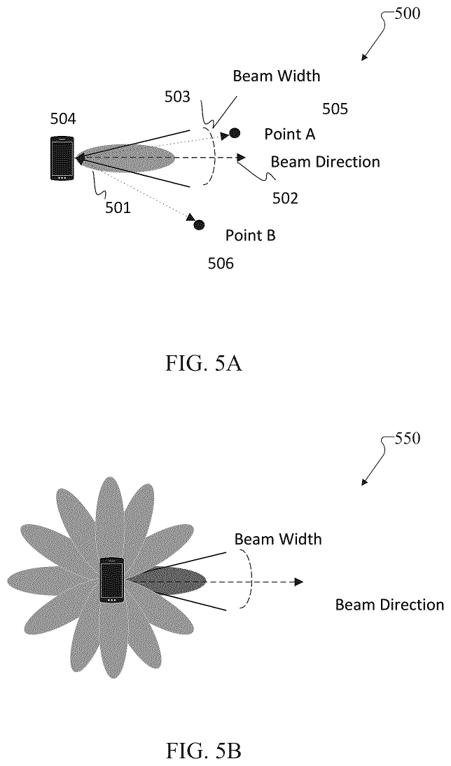

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by gNB 102 of FIG. 2. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

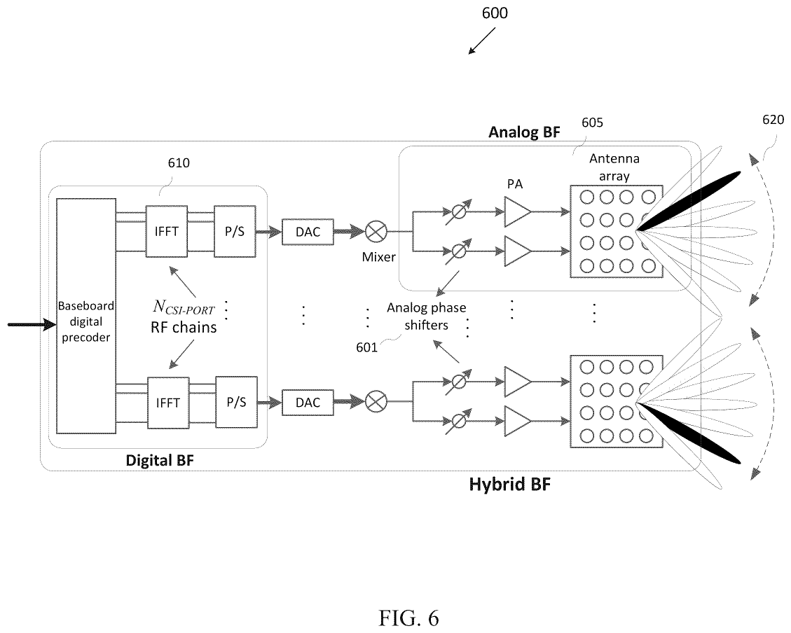

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosure herein that changes in the embodiments and examples shown may be made without departing from the scope of the present disclosure. The transmitter structure 600 for beamforming is for illustration only and other embodiments can be used without departing from the scope of the present disclosure.

The flowcharts herein illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

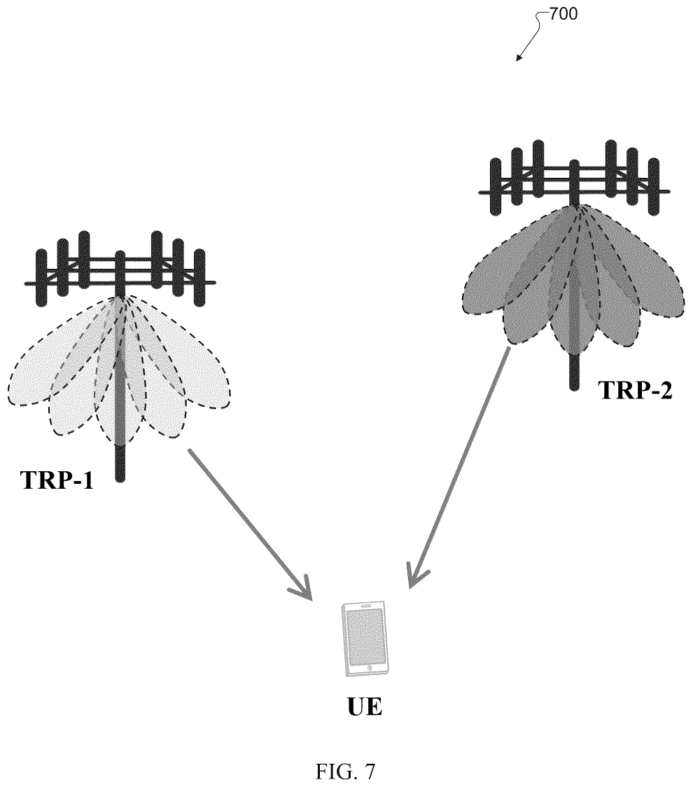

FIG. 7 illustrates an example of a multiple transmission and reception point (multi-TRP) system 700 according to embodiments of the present disclosure. For example, system 700 can be utilized by the gNB 102 of FIG. 2 and, more particularly, the multiple antennas 205a-205n. This example is for illustration only and other embodiments can be used without departing from the scope of the present disclosure.

With reference to FIG. 7, a UE could simultaneously receive from multiple physically non-co-located TRPs various channels/RSs such as PDCCHs and/or PDSCHs using either a single receive (RX) panel or multiple RX panels. In the present disclosure, a RX panel could correspond to a set of RX antenna elements/ports at the UE 116, a set of measurement RS resources such as SRS resources, a spatial domain RX filter, etc. Further, a TRP in the multi-TRP (MTRP) system can represent a collection of measurement antenna ports, measurement RS resources and/or control resource sets (CORESETs). For example, a TRP could be associated with one or more of:
A plurality of CSI-RS resources;
A plurality of CRIs (CSI-RS resource indices/indicators);
A measurement RS resource set, for example, a CSI-RS resource set along with its indicator;
A plurality of CORESETs associated with a CORESETPoolIndex; and/or
A plurality of CORESETs associated with a TRP-specific index/indicator/identity.

A cell/TRP could be a non-serving cell/TRP. In the present disclosure, the non-serving cell(s) or the non-serving cell TRP(s) could have/broadcast different physical cell IDs (PCIs) and/or other higher layer signaling index values from that of the serving cell or the serving cell TRP (i.e., the serving cell PCI).

In one example, the serving cell or the serving cell TRP could be associated with the serving cell ID (SCI) and/or the serving cell PCI. That is, for the inter-cell operation evaluated in the present disclosure, different cells/TRPs could broadcast different PCIs and/or one or more cells/TRPs (referred to/defined as non-serving cells/TRPs) could broadcast different PCIs from that of the serving cell/TRP (i.e., the serving cell PCI) and/or one or more cells/TRPs are not associated with valid SCI (e.g., provided by the higher layer parameter ServCellIndex). In the present disclosure, a non-serving cell PCI can also be referred to as an additional PCI, another PCI, or a different PCI (with respect to the serving cell PCI).

The UE 116 could be configured by the network 130 with one or more transmission configuration information (TCI) states which indicate the QCL information/assumptions for one or more RSs/channels such as PDCCHs and/or PDSCHs. The TCI state update/indication for PDCCH and/or PDSCH can also be referred to as beam indication. For instance, for data transmissions on the shared channel (such as the physical downlink shared channel in NR, i.e., PDSCH), the corresponding beam indication procedure under the 3GPP Rel. 15/16 TCI framework can be summarized herein. A UE can be first higher layer configured by the network 130 (e.g., via high layer RRC signaling) with a set/pool of TCI states. The UE 116 could then receive from the network 130 a medium access control (MAC) control element (CE) command activating one or more TCI states from the set/pool of RRC configured TCI states. The UE 116 could be indicated by the network 130 via dynamic downlink control information (DCI) signaling that one or more of the MAC CE activated TCI states are active for the reception of the PDSCH(s).

Embodiments of the present disclosure recognize, under the Rel. 17 unified TCI framework, wherein a UE could be provided by the network 130 one or more separate/joint DL or UL TCI state for various DL or UL channels/signals, various design aspects related to beam indication for control resource sets (CORESETs), PDSCH, physical uplink shared channel (PUSCH), physical uplink control channel (PUCCH), CSI-RS and/or SRS need to be specified.

The present disclosure evaluates various design aspects/enhancements related to beam indication for CORESETs/PDCCHs, PDSCH, PUCCH, PUSCH, CSI-RS and/or SRS in a multi-TRP system or an inter-cell system wherein at least a PCI different from the serving cell PCI is deployed under the Rel. 17 unified TCI framework.

As described in US provisional patent application 63/144,328 filed on Feb. 1, 2021, a unified TCI framework could indicate/include N≥1 DL TCI states and/or M≥1 UL TCI states, wherein the indicated TCI state could be at least one of:
A DL TCI state and/or its corresponding/associated TCI state ID;
An UL TCI state and/or its corresponding/associated TCI state ID;
A joint DL and UL TCI state and/or its corresponding/associated TCI state ID; and/or
Separate DL TCI state and UL TCI state and/or their corresponding/associated TCI state ID(s).

There could be various design options/channels to indicate to the UE 116 a beam (i.e., a TCI state) for the transmission/reception of a PDCCH or a PDSCH, as described in US provisional patent application 63/144,328 filed on Feb. 1, 2021.

In one example, a MAC CE could be used to indicate to the UE 116 a beam (i.e., a TCI state and/or a TCI state ID) for the transmission/reception of a PDCCH or a PDSCH.

In another example, a DCI could be used to indicate to the UE 116 a beam (i.e., a TCI state and/or a TCI state ID) for the transmission/reception of a PDCCH or a PDSCH.

For example, a DL related DCI (e.g., DCI format 1_0, DCI format 1_1 or DCI format 1_2) could be used to indicate to the UE 116 a beam (i.e., a TCI state and/or a TCI state ID) for the transmission/reception of a PDCCH or a PDSCH, wherein the DL related DCI may or may not include a DL assignment.

For another example, an UL related DCI (e.g., DCI format 0_0, DCI format 0_1, DCI format 0_2) could be used to indicate to the UE 116 a beam (i.e., a TCI state and/or a TCI state ID) for the transmission/reception of a PDCCH or a PDSCH, wherein the UL related DCI may or may not include an UL scheduling grant.

Yet for another example, a custom/purpose designed DCI format could be used to indicate to the UE 116 a beam (i.e., a TCI state and/or a TCI state ID) for the transmission/reception of a PDCCH or a PDSCH.

Rel-17 introduced the unified TCI framework, where a unified or master or main TCI state is signaled to the UE 116. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources.

As discussed herein, a UE could be provided by the network 130, e.g., via MAC CE or DCI (e.g., DCI format 1_1 or 1_2 with or without DL assignment) based signaling via higher layer parameters DLorJointTCIState or UL-TCIState, M>1 joint DL and UL TCI states or M>1 separate UL TCI states or a first combination of M>1 joint DL and UL TCI states and separate UL TCI states or N>1 separate DL TCI states or a second combination of N>1 joint DL and UL TCI states and separate DL TCI states or a third combination of N>1 joint DL and UL TCI states, separate DL TCI states and separate UL Rel. 17 unified TCI for UE-dedicated reception on PDSCH/PDCCH or dynamic-grant/configured-grant based PUSCH and all of dedicated PUCCH resources.

Throughout the present disclosure, the term “configuration” or “higher layer configuration” and variations thereof (such as “configured” and so on) could be used to refer to one or more of: a system information signaling such as by a master information block (MIB) or a system information block SIB (such as SIB1), a common or cell-specific higher layer/RRC signaling, or a dedicated or UE-specific or bandwidth part (BWP)-specific higher layer/RRC signaling.

The UE 116 can be configured with a list of up to M TCI-State configurations within the higher layer parameter PDSCH-Config to decode PDSCH according to a detected PDCCH with DCI intended for the UE 116 and the given serving cell, where M depends on the UE 116 capability maxNumberConfiguredTCIstatesPerCC. Each TCI-State contains parameters for configuring a quasi-co-location relationship between one or two downlink reference signals and the demodulation reference signal (DM-RS) ports of the PDSCH, the DM-RS port of PDCCH or the CSI-RS port(s) of a CSI-RS resource. The quasi-co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi-co-location types corresponding to each DL RS are given by the higher layer parameter qcl-Type in QCL-Info and may take one of the following values:
‘typeA’: {Doppler shift, Doppler spread, average delay, delay spread};
‘typeB’: {Doppler shift, Doppler spread};
‘typeC’: {Doppler shift, average delay}, or
‘typeD’: {Spatial Rx parameter}.

The UE 116 can be configured with a list of up to 128 DLorJointTCIState configurations, within the higher layer parameter PDSCH-Config for providing a reference signal for the quasi co-location for DM-RS of PDSCH and DM-RS of PDCCH in a CC, for CSI-RS, and to provide a reference, if applicable, for determining UL TX spatial filter for dynamic-grant and configured-grant based PUSCH and PUCCH resource in a CC, and SRS.

If the DLorJointTCIState or UL-TCIState configurations are absent in a BWP of the CC, the UE 116 can apply the DLorJointTCIState or UL-TCIState configurations from a reference BWP of a reference CC. The UE 116 is not expected to be configured with TCI-State, SpatialRelationInfo or PUCCH-SpatialRelationInfo, except SpatialRelationInfoPos in a CC in a band, if the UE 116 is configured with DLorJointTCIState or UL-TCIState in any CC in the same band. The UE 116 can assume that when the UE 116 is configured with TCI-State in any CC in the CC list configured by simultaneousTCI-UpdateList1-r16, simultaneousTCI-UpdateList2-r16, simultaneousSpatial-UpdatedList1-r16, or simultaneousSpatial-UpdatedList2-r16, the UE 116 is not configured with DLorJointTCIState or UL-TCIState in any CC within the same band in the CC list.

The UE 116 receives an activation command, as described in document and standard [5], used to map up to 8 TCI states and/or pairs of TCI states, with one TCI state for DL channels/signals and one TCI state for UL channels/signals to the codepoints of the DCI field ‘Transmission Configuration Indication’ for one or for a set of CCs/DL BWPs, and if applicable, for one or for a set of CCs/UL BWPs. When a set of TCI state IDs are activated for a set of CCs/DL BWPs and, if applicable, for a set of CCs/UL BWPs, where the applicable list of CCs is determined by the indicated CC in the activation command, the same set of TCI state IDs are applied for all DL and/or UL BWPs in the indicated CCs.

The Unified TCI States Activation/Deactivation MAC CE is identified by a MAC subheader with eLCID as specified document and standard [5]. It has a variable size including the following fields:
Serving Cell ID: This field indicates the identity of the Serving Cell for which the MAC CE applies. The length of the field is 5 bits. If the indicated Serving Cell is configured as part of a simultaneousU-TCI-UpdateList1, simultaneousU-TCI-UpdateList2, simultaneousU-TCI-UpdateList3 or simultaneousU-TCI-UpdateList4 as specified in document and standard [6], this MAC CE applies to all theServing Cells in the set simultaneousU-TCI-UpdateList1, simultaneousU-TCI-UpdateList2, simultaneousU-TCI-UpdateList3 or simultaneousU-TCI-UpdateList4, respectively.
DL BWP ID: This field indicates a DL BWP for which the MAC CE applies as the codepoint of the DCI bandwidth part indicator field as specified in document and standard [2]. The length of the BWP ID field is 2 bits.
UL BWP ID: This field indicates a UL BWP for which the MAC CE applies as the codepoint of the DCI bandwidth part indicator field as specified in document and standard [2]. The length of the BWP ID field is 2 bits.
Pᵢ: This field indicates whether each TCI codepoint has multiple TCI states or single TCI state. If Pᵢ field set to 1, it indicates that i^{th} TCI codepoint includes the DL TCI state and the UL TCI state. If Pᵢ field set to 0, it indicates that i^{th} TCI codepoint includes only the DL TCI state or the UL TCI state.
D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink.
TCI state ID: This field indicates the TCI state identified by TCI-StateId as specified in document and standard [6]. If D/U is set to 1, 7-bits length TCI state ID i.e. TCI-StateId as specified in document and standard [6] is used. If D/U is set to 0, the most significant bit of TCI state ID is regarded as the reserved bit and remainder 6 bits indicate the UL-TCIState-Id as specified in document and standard [6]. The maximum number of activated TCI states is 16.
R: Reserved bit, set to 0.

The CellGroupConfig IE specified in document and standard [6] is used to configure a master cell group (MCG) or secondary cell group (SCG). A cell group comprises of one MAC entity, a set of logical channels with associated radio link control (RLC) entities and of a primary cell (SpCell) and one or more secondary cells (SCells).

simultaneousTCI-UpdateList1, simultaneousTCI-UpdateList2 are list of serving cells which can be updated simultaneously for TCI relation with a MAC CE. The simultaneousTCI-UpdateList1 and simultaneousTCI-UpdateList2 shall not contain same serving cells. Network should not configure serving cells that are configured with a BWP with two different values for the coresetPoolIndex in these lists.

simultaneousU-TCI-UpdateList1, simultaneousU-TCI-UpdateList2, simultaneousU-TCI-UpdateList3, simultaneousU-TCI-UpdateList4 are list of serving cells for which the Unified TCI States Activation/Deactivation MAC CE applies simultaneously, as specified document and standard [5]. The different lists shall not contain same serving cells. Network only configures in these lists serving cells that are configured with unifiedtci-StateType.

When the bwp-id or cell for QCL-TypeA/D source RS in a QCL-Info of the TCI state configured with DLorJointTCIState is not configured, the UE 116 assumes that QCL-TypeA/D source RS is configured in the CC/DL BWP where TCI state applies.

When tci-PresentInDCI is set as ‘enabled’ or tci-PresentDCI-1-2 is configured for the CORESET, the UE 116 with activated DLorJointTCIState or UL-TCIState receives DCI format 1_1/1_2 providing indicated DLorJointTCIState or UL-TCIState for a CC or all CCs in the same CC list configured by simultaneousTCI-UpdateList1-r17, simultaneousTCI-UpdateList2-r17, simultaneousTCI-UpdateList3-r17, and/or simultaneous TCI-UpdateList4-r17. The DCI format 1_1/1_2 can be with or without, if applicable, DL assignment. If the DCI format 1_1/1_2/is without DL assignment, the UE 116 can assume the following:
CS-radio network temporary identifier (RNTI) is used to scramble the cyclic redundancy check (CRC) for the DCI.
The values of the following DCI fields are set as follows:
   RV=all ‘1’s
   MCS=all ‘1’s
   NDI=0
   Set to all ‘0’s for FDRA Type 0, or all ‘1’s for FDRA Type 1, or all ‘0’s for dynamicSwitch (same as in document and standard [3]).

After a UE receives an initial higher layer configuration of more than one DLorJoint-TCIState and before application of an indicated TCI state from the configured TCI states, the UE 116 assumes that DM-RS of PDSCH, DM-RS of PDCCH, and the CSI-RS applying the indicated TCI state are quasi co-located with the SS/PBCH block the UE 116 identified during the initial access procedure.

After a UE receives an initial higher layer configuration of more than one DLorJoint-TCIState or UL-TCIState and before application of an indicated TCI state from the configured TCI states, the UE 116 assumes that the UL TX spatial filter, if applicable, for dynamic-grant and configured-grant based PUSCH and PUCCH, and for SRS applying the indicated TCI state, is the same as that for a PUSCH transmission scheduled by a random access response (RAR) UL grant during the initial access procedure.

After a UE receives a higher layer configuration of more than one DLorJoint-TCIState as part of a Reconfiguration with sync procedure as described in document and standard [6] and before applying an indicated TCI state from the configured TCI states, the UE 116 assumes that DM-RS of PDSCH, DM-RS of PDCCH, and the CSI-RS applying the indicated TCI state are quasi co-located with the SS/PBCH block or the CSI-RS resource the UE 116 identified during the random access procedure initiated by the Reconfiguration with sync procedure as described in document and standard [6].

After a UE receives a higher layer configuration of more than one DLorJoint-TCIState or UL-TCIState as part of a Reconfiguration with sync procedure as described in document and standard [6] and before applying an indicated TCI state from the configured TCI states, the UE 116 assumes that the UL TX spatial filter, if applicable, for dynamic-grant and configured-grant based PUSCH and PUCCH, and for SRS applying the indicated TCI state, is the same as that for a PUSCH transmission scheduled by a RAR UL grant during random access procedure initiated by the Reconfiguration with sync procedure as described in document and standard [6]

If a UE receives a higher layer configuration of a single DLorJoint-TCIState that can be used as an indicated TCI state, the UE 116 obtains the QCL assumptions from the configured TCI state for DM-RS of PDSCH, DM-RS of PDCCH, and the CSI-RS applying the indicated TCI state.

If a UE receives a higher layer configuration of a single DLorJoint-TCIState or UL-TCIState that can be used as an indicated TCI state, the UE 116 determines an UL TX spatial filter, if applicable, from the configured TCI state for dynamic-grant and configured-grant based PUSCH and PUCCH, and SRS applying the indicated TCI state.

When the UE 116 would transmit the last symbol of a PUCCH with hybrid automatic repeat request acknowledgement (HARQ-ACK) information corresponding to the DCI carrying the TCI State indication and without DL assignment, or corresponding to the PDSCH scheduling by the DCI carrying the TCI State indication, and if the indicated TCI State is different from the previously indicated one, the indicated DLorJointTCIState or UL-TCIstate should be applied starting from the first slot that is at least BeamAppTime_r17 symbols after the last symbol of the PUCCH. The first slot and the BeamAppTime_r17 symbols are both determined on the carrier with the smallest SCS among the carrier(s) applying the beam indication.

If a UE is configured with pdsch-TimeDomainAllocationListForMultiPDSCH-r17 in which one or more rows contain multiple SLIVs for PDSCH on a DL BWP of a serving cell, and the UE 116 is receiving a DCI carrying the TCI-State indication and without DL assignment, the UE 116 does not expect that the number of indicated SLIVs in the row of the pdsch-TimeDomainAllocationListForMultiPDSCH-r 17 by the DCI is more than one.

If the UE 116 is configured with NumberOfAdditionalPCI and with PDCCH-Config that contains two different values of coresetPoolIndex in ControlResourceSet, the UE 116 receives an activation command for CORESET associated with each coresetPoolIndex, as described in document and standard [5], used to map up to 8 TCI states to the codepoints of the DCI field ‘Transmission Configuration Indication’ in one CC/DL BWP. When a set of TCI state IDs are activated for a coresetPoolIndex, the activated TCI states corresponding to one coresetPoolIndex can be associated with one physical cell ID and activated TCI states corresponding to another coresetPoolIndex can be associated with another physical cell ID.

When a UE supports two TCI states in a codepoint of the DCI field ‘Transmission Configuration Indication’ the UE 116 may receive an activation command, as described in document and standard [5], the activation command is used to map up to 8 combinations of one or two TCI states to the codepoints of the DCI field ‘Transmission Configuration Indication’. The UE 116 is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in document and standard [5], only the first S activated codepoints are applied for DCI format 1_2.

When the UE 116 would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot

$$n + 3 {N}_{slot}^{subframe , μ} + \frac{{2}^{μ}}{{2}^{{μ}_{{K}_{mac}}}} \cdot {k}_{mac} ,$$

where m is the SCS configuration for the PUCCH, μ_{K}_{_{mac}} is the subcarrier spacing configuration for k_{mac} with a value of 0 for frequency range 1, and k_{mac} is provided by K-Mac or k_{mac}=0 if K-Mac is not provided. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL, if applicable, after a UE receives an initial higher layer configuration of TCI states and before reception of the activation command, the UE 116 may assume that the DM-RS ports of PDSCH of a serving cell are quasi co-located with the SS/PBCH block determined in the initial access procedure with respect to qcl-Type set to ‘typeA’ and, when applicable, also with respect to qcl-Type set to ‘typeD’.

If a UE is configured with the higher layer parameter tci-PresentInDCI that is set as ‘enabled’ for the CORESET scheduling a PDSCH, the UE 116 assumes that the TCI field is present in the DCI format 1_1 of the PDCCH transmitted on the CORESET. If a UE is configured with the higher layer parameter tci-PresentDCI-1-2 for the CORESET scheduling the PDSCH, the UE 116 assumes that the TCI field with a DCI field size indicated by tci-PresentDCI-1-2 is present in the DCI format 1_2 of the PDCCH transmitted on the CORESET. If the PDSCH is scheduled by a DCI format not having the TCI field present and the time offset between the reception of the DL DCI and the corresponding PDSCH of a serving cell is equal to or greater than a threshold timeDurationForQCL if applicable, where the threshold is based on reported UE capability [13, TS 38.306], for determining PDSCH antenna port quasi co-location, the UE 116 assumes that the TCI state or the QCL assumption for the PDSCH is identical to the TCI state or QCL assumption, whichever is applied for the CORESET used for the PDCCH transmission within the active BWP of the serving cell.

When a UE is configured with both sfnSchemePdcch and sfnSchemePdsch scheduled by DCI format 1_0 or by DCI format 1_1/1_2, if the time offset between the reception of the DL DCI, and the corresponding PDSCH of a serving cell is equal to or greater than a threshold timeDurationForQCL if applicable:
if the UE 116 supports DCI scheduling without TCI field, the UE 116 assumes that the TCI state(s) or the QCL assumption(s) for the PDSCH is identical to the TCI state(s) or QCL assumption(s), whichever is applied for the CORESET used for the reception of the DL DCI within the active BWP of the serving cell regardless of the number of active TCI states of the CORESET. If the UE 116 does not support dynamic switching between single frequency networks (SFN) PDSCH and non-SFN PDSCH, the UE 116 should be activated with the CORESET with two TCI states.
else if the UE 116 does not support DCI scheduling without TCI field, the UE 116 shall expect TCI field present when scheduled by DCI format 1_1/1_2.

When a UE is configured with sfnSchemePdsch and sfnSchemePdcch is not configured, when scheduled by DCI format 1_1/1_2, if the time offset between the reception of the DL DCI, and the corresponding PDSCH of a serving cell is equal to or greater than a threshold timeDurationForQCL if applicable, the UE 116 shall expect TCI field present.

For PDSCH scheduled by DCI format 1_0, 1_1, 1_2, when a UE is configured with sfnSchemePdcch set to ‘sfnSchemeA’, sfnSchemePdsch is not configured, there is no TCI codepoint with two TCI states in the activation command, and if the time offset between the reception of the DL DCI and the corresponding PDSCH is equal or larger than the threshold timeDurationForQCL, if applicable, and the CORESET which schedules the PDSCH is indicated with two TCI states, the UE 116 assumes that the TCI state or the QCL assumption for the PDSCH is identical to the first TCI state or QCL assumption which is applied for the CORESET used for the PDCCH transmission within the active BWP of the serving cell.

If a PDSCH is scheduled by a DCI format having the TCI field present and the TCI field in DCI in the scheduling component carrier points to the activated TCI states in the scheduled component carrier or DL BWP, the UE 116 shall use the TCI-State according to the value of the ‘Transmission Configuration Indication’ field in the detected PDCCH with DCI for determining PDSCH antenna port quasi co-location. The UE 116 may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability [13, TS 38.306]. For a single slot PDSCH, the indicated TCI state(s) should be based on the activated TCI states in the slot with the scheduled PDSCH. For a multi-slot PDSCH or the UE 116 is configured with higher layer parameter pdsch-TimeDomainAllocationListForMultiPDSCH-r17, the indicated TCI state(s) should be based on the activated TCI states in the first slot with the scheduled PDSCH(s). The UE 116 shall expect the activated TCI states are the same across the slots with the scheduled PDSCH(s). When the UE 116 is configured with CORESET associated with a search space set for cross-carrier scheduling and the UE 116 is not configured with enableDefaultBeamForCCS, the UE 116 expects tci-PresentInDCI is set as ‘enabled’ or tci-PresentDCI-1-2 is configured for the CORESET. If one or more of the TCI states configured for the serving cell scheduled by the search space set contains qcl-Type set to ‘typeD’, the UE 116 expects the time offset between the reception of the detected PDCCH in the search space set and a corresponding PDSCH is larger than or equal to the threshold timeDurationForQCL.

Independent of the configuration of tci-PresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’:
the UE 116 may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE 116. In this case, if the qcl-Type is set to ‘typeD’ of the PDSCH DM-RS is different from that of the PDCCH DM-RS with which they overlap in at least one symbol, the UE 116 is expected to prioritize the reception of PDCCH associated with that CORESET. This also applies to the intra-band CA case (when PDSCH and the CORESET are in different component carriers).
If a UE is configured with enableDefaultTCI-StatePerCoresetPoolIndex and the UE 116 is configured by higher layer parameter PDCCH-Config that contains two different values of coresetPoolIndex in different ControlResourceSets, the UE 116 may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE 116. In this case, if the ‘QCL-TypeD’ of the PDSCH DM-RS is different from that of the PDCCH DM-RS with which they overlap in at least one symbol and they are associated with same value of coresetPoolIndex, the UE 116 is expected to prioritize the reception of PDCCH associated with that CORESET. This also applies to the intra-band CA case (when PDSCH and the CORESET are in different component carriers).
If a UE is configured with enable TwoDefaultTCI-States, and at least one TCI codepoint indicates two TCI states, the UE 116 may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE 116 is configured by higher layer parameter repetitionScheme set to ‘tdmSchemeA’ or is configured with higher layer parameter repetitionNumber, and the offset between the reception of the DL DCI and the first PDSCH transmission occasion is less than the threshold timeDurationForQCL, the mapping of the TCI states to PDSCH transmission occasions is determined according to document and standard [4] by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE 116 is expected to prioritize the reception of PDCCH associated with that CORESET. This also applies to the intra-band CA case (when PDSCH and the CORESET are in different component carriers).
If a UE is not configured with sfnSchemePdsch, the UE 116 is configured with sfnSchemePdcch set to ‘sfnSchemeA’. There is no TCI codepoint with two TCI states in the activation command and the CORESET with the lowest ID in the latest slot is indicated with two TCI states. The UE 116 may assume that the DM-RS ports of PDSCH of a serving cell are quasi co-located with the RS(s) with respect to the QCL parameter(s) associated with the first TCI state of two TCI states indicated for the CORESET.
In all cases herein, if none of configured TCI states for the serving cell of scheduled PDSCH is configured with qcl-Type set to ‘typeD’, the UE 116 shall obtain the other QCL assumptions from the indicated TCI state(s) for its scheduled PDSCH irrespective of the time offset between the reception of the DL DCI and the corresponding PDSCH.

If the PDCCH carrying the scheduling DCI is received on one component carrier, and a PDSCH scheduled by that DCI is on another component carrier:
The timeDurationForQCL is determined based on the subcarrier spacing of the scheduled PDSCH. If μ_{PDCCH}<μ_{PDSCH}, an additional timing delay

$$d \frac{{2}^{{μ}_{PDSCH}}}{{2}^{{μ}_{PDCCH}}}$$

is added to the timeDurationForQCL, where d is defined in document and standard [4]. Otherwise, d is zero.
When the UE 116 is configured with enableDefaultBeamForCCS, if the offset between the reception of the DL DCI and the corresponding PDSCH is less than the threshold timeDurationForQCL, or if the DL DCI does not have the TCI field present, the UE 116 obtains its QCL assumption for the scheduled PDSCH from the activated TCI state with the lowest ID applicable to PDSCH in the active BWP of the scheduled cell.

A UE that has indicated a capability beamCorrespondenceWithoutUL-BeamSweeping set to ‘1’, as described in [18, TS 38.822], can determine a spatial domain filter to be used while performing the applicable channel access procedures described in [16, TS 37.213] to transmit a UL transmission on the channel as follows:
if UE is indicated with an SRI corresponding to the UL transmission, the UE 116 may use a spatial domain filter that is same as the spatial domain transmission filter associated with the indicated SRI.
if UE is configured with TCI-State configurations with DLorJointTCIState or UL-TCIState, the UE 116 may use a spatial domain transmit filter that is same as the spatial domain receive filter the UE 116 may use to receive the DL reference signal associated with the indicated TCI state.

When the PDCCH reception includes two PDCCH from two respective search space sets, as described in document and standard [3], for the purpose of determining the time offset between the reception of the DL DCI and the corresponding PDSCH, the PDCCH candidate that ends later in time is used. When the PDCCH reception includes two PDCCH candidates from two respective search space sets, as described document and standard [3], for the configuration of tci-PresentInDCI or tci-PresentDCI-1-2, the UE 116 expects the same configuration in the first and second CORESETs associated with the two PDCCH candidates. If the PDSCH is scheduled by a DCI format not having the TCI field present and if the scheduling offset is equal to or larger than timeDurationForQCL, if applicable, PDSCH QCL assumption is based on the CORESET with lower ID among the first and second CORESETs associated with the two PDCCH candidates.

For a periodic CSI-RS resource in an NZP-CSI-RS-ResourceSet configured with higher layer parameter trs-Info, the UE 116 shall expect that a TCI-State indicates one of the following quasi co-location type(s):
‘typeC’ with an SS/PBCH block and, when applicable, ‘typeD’ with the same SS/PBCH block; or
‘typeC’ with an SS/PBCH block and, when applicable, ‘typeD’ with a CSI-RS resource in an NZP-CSI-RS-ResourceSet configured with higher layer parameter repetition.

For periodic/semi-persistent CSI-RS, the UE 116 can assume that the indicated DLorJointTCIState is not applied.

For an aperiodic CSI-RS resource in an NZP-CSI-RS-ResourceSet configured with higher layer parameter trs-Info, the UE 116 shall expect that a TCI-State indicates qcl-Type set to ‘typeA’ with a periodic CSI-RS resource in a NZP-CSI-RS-ResourceSet configured with higher layer parameter trs-Info and, when applicable, qcl-Type set to ‘typeD’ with the same periodic CSI-RS resource.

For a CSI-RS resource in an NZP-CSI-RS-ResourceSet configured without higher layer parameter trs-Info and without the higher layer parameter repetition, the UE 116 shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource;
‘typeA’ with a CSI-RS resource in a NZP-CSI-RS-ResourceSet configured with higher layer parameter trs-Info and, when applicable, ‘typeD’ with an SS/PBCH block;
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition; or
‘typeB’ with a CSI-RS resource in a NZP-CSI-RS-ResourceSet configured with higher layer parameter trs-Info when ‘typeD’ is not applicable.

For a CSI-RS resource in an NZP-CSI-RS-ResourceSet configured with higher layer parameter repetition, the UE 116 shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource;
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition; or
‘typeC’ with an SS/PBCH block and, when applicable, ‘typeD’ with the same SS/PBCH block, the reference RS may additionally be an SS/PBCH block having a PCI different from the PCI of the serving cell. The UE 116 can assume center frequency, SCS, SFN offset are the same for SS/PBCH block from the serving cell and SS/PBCH block having a PCI different from the serving cell.

For the DM-RS of PDCCH, the UE 116 shall expect that a TCI-State or DLorJointTCIState except an indicated DLorJointTCIState indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource;
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition; or
‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

When a UE is configured with sfnSchemePdcch set to ‘sfnSchemeA’ and CORESET is activated with two TCI states, the UE 116 shall assume that the DM-RS port(s) of the PDCCH in the CORESET is quasi co-located with the DL-RSs of the two TCI states. When a UE is configured with sfnSchemePdcch set to ‘sfnSchemeB’ and a CORESET is activated with two TCI states, the UE 116 shall assume that the DM-RS port(s) of the PDCCH is quasi co-located with the DL-RSs of the two TCI states except for quasi co-location parameters {Doppler shift, Doppler spread} of the second indicated TCI state.

For the DM-RS of PDSCH, the UE 116 shall expect that a TCI-State or DLorJointTCIState except an indicated DLorJointTCIState indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource;
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition; or
typeA′ with a CSI-RS resource in a NZP-CSI-RS-ResourceSet configured without higher layer parameter trs-Info and without higher layer parameter repetition and, when applicable, ‘typeD’ with the same CSI-RS resource.

For the DM-RS of PDCCH, the UE 116 shall expect that an indicated DLorJointTCIState indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource; or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition.

For the DM-RS of PDSCH, the UE 116 shall expect that an indicated DLorJointTCIState indicates one of the following quasi co-location type(s) if the UE 116 is configured TCI-State(s) with tci-StateId_r17:
‘typeA’ with a CSI-RS resource in a NZP-CSI-RS-ResourceSet configured with higher layer parameter trs-Info and, when applicable, ‘typeD’ with the same CSI-RS resource; or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition.

When a UE is configured with sfnSchemePdsch set to ‘sfnSchemeA’ and the UE 116 is indicated with two TCI states in a codepoint of the DCI field ‘Transmission Configuration Indication’ in a DCI scheduling a PDSCH, the UE 116 shall assume that the DM-RS port(s) of the PDSCH is quasi co-located with the DL-RSs of the two TCI states. When a UE is configured with sfnSchemePdsch set to ‘sfnSchemeB’ and the UE 116 is indicated with two TCI states in a codepoint of the DCI field ‘Transmission Configuration Indication’ in a DCI scheduling a PDSCH, the UE 116 shall assume that the DM-RS port(s) of the PDSCH is quasi co-located with the DL-RSs of the two TCI states except for quasi co-location parameters {Doppler shift, Doppler spread} of the second indicated TCI state.

Throughout the present disclosure, the joint (e.g., provided by DLorJoint-TCIState), separate DL (e.g., provided by DLorJoint-TCIState) and/or separate UL (e.g., provided by UL-TCIState) TCI states described/discussed herein could also be referred to as unified TCI states, common TCI states, main TCI states, etc. Furthermore, an indicator/parameter set to ‘1’ (or ‘0’ or ‘00’ or ‘01’ or ‘10’ or ‘11’) could also correspond to or be equivalent to the indicator/parameter set to ‘enabled’. An indicator/parameter set to ‘0’ (or ‘1’ or ‘00’ or ‘01’ or ‘10’ or ‘11’) could also correspond to or be equivalent to the indicator/parameter set to ‘disabled’. In addition, throughout the present disclosure, the following two operations are equivalent: (1) a UE uses/applies a TCI state to receive a channel/signal and (2) the UE 116 assumes the DM-RS antenna port(s) of the channel/signal is quasi co-located with the RS(s) in the RS set(s) provided/indicated/configured in the TCI state. Also, a PDSCH can be a scheduled PDSCH (e.g., by the corresponding scheduling DCI) or a configured PDSCH. In addition, throughout the present disclosure, a TCI state can be a joint TCI state (e.g., provided by DLorJoint-TCIState), a separate DL TCI state (e.g., provided by DLorJoint-TCIState) or a separate UL TCI state (e.g., provided by UL-TCIState), and a pair of TCI states can be a pair of joint (e.g., provided by DLorJoint-TCIState) and/or separate DL (e.g., provided by DLorJoint-TCIState) and/or separate UL (e.g., provided by DLorJoint-TCIState) TCI states.

As discussed herein, a UE could receive a MAC CE activation command, e.g., Unified TCI states activation/deactivation MAC CE command, used to map up to Ncp≥1 (e.g., Ncp=8 or Ncp=16) TCI codepoints of a TCI field in a beam indication DCI (e.g., DCI format 1_1/1_2 with or without DL assignment), wherein a TCI codepoint could contain/comprise/include one or more, e.g., N≥1 or M≥1 (e.g., N=2 or M=2), TCI states (also referred to as indicated/activated TCI states) or pairs of TCI states (also referred to as indicated/activated pairs of TCI states). A TCI state (also referred to as an indicated TCI state) could correspond to a joint TCI state provided by DLorJointTCIState, a separate DL TCI state provided by DLorJointTCIState, or a separate UL TCI state provided by UL-TCIState.

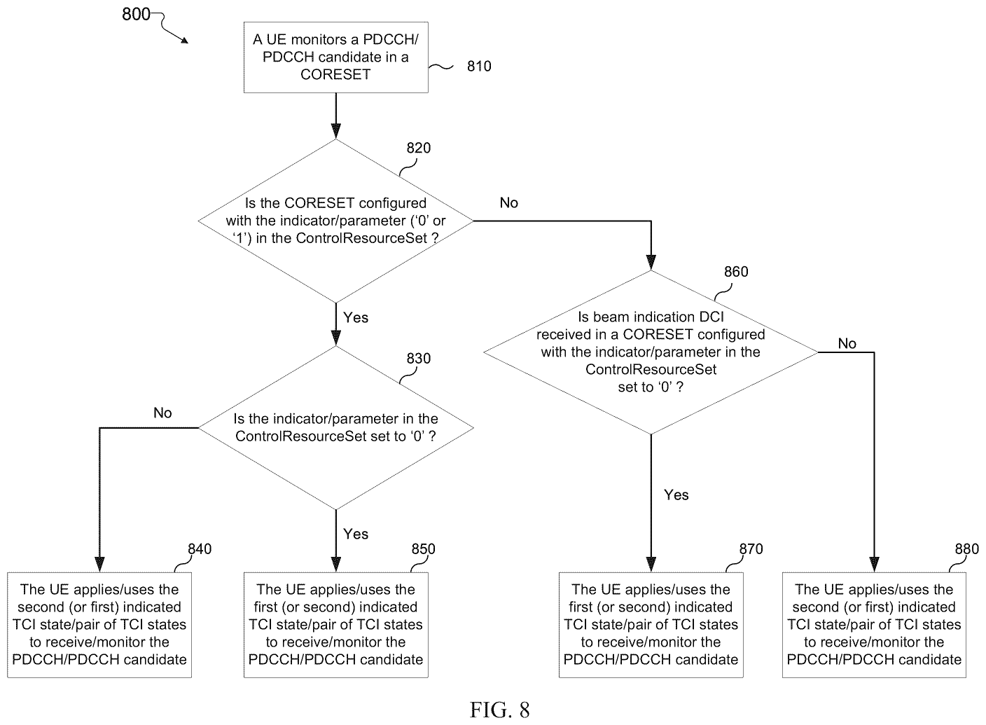

FIG. 8 illustrates a flowchart of an example algorithm 800 for determining which of the indicated transmission configuration indication (TCI) state(s) to use for receiving physical downlink control channel (PDCCH) candidates according to embodiments of the present disclosure. For example, algorithm 800 can be used by any of the UEs 111-116 of FIG. 1 and, more particularly, transceiver(s) 310. This example is for illustration only and other embodiments can be used without departing from the scope of the present disclosure.

The algorithm begins with 810, a UE monitors a PDCCH/PDCCH candidate in a CORESET. In 820, the CORESET can be configured with the indicator/parameter (‘0’ or ‘1’) in the ControlResourceSet. If so, the algorithm then proceeds to 830. Otherwise, the algorithm proceeds to 860. In 830, the indicator/parameter in the ControlResourceSet can be set to ‘0’. If so, in 850, the UE 116 then applies/uses the first (or second) indicated TCI state/pair of TCI states to receive/monitor the PDCCH/PDCCH candidate. Otherwise, in 840, the UE 116 then applies/uses the second (or the first) indicated TCI state/pair of TCI states to receive/monitor the PDCCH/PDCCH candidate. In 860, the beam indication DCI received in a CORESET can be configured with the indicator/parameter in the ControlResourceSet set to ‘0’. If so, in 870, the UE 116 then applies/uses the first (or second) indicated TCI state/pair of TCI states to receive/monitor the PDCCH/PDCCH candidate. Otherwise, in 880, the UE 116 then applies/uses the second (or first) indicated TCI state/pair of TCI states to receive/monitor the PDCCH/PDCCH candidate.

In one embodiment, the UE 116 could be provided/indicated/configured by the network 130, in a higher layer parameter, e.g., ControlResourceSet for a CORESET, an indicator/parameter to inform the UE 116 the association between the indicated TCI state(s) and the PDCCH reception(s), wherein different CORESETs configured with the same indicator/parameter could be in a same CORESET group.

Alternatively, the UE 116 could be provided/indicated/configured by the network 130, in a higher layer parameter, e.g., ControlResourceSet for a CORESET, one or more TCI states/TCI state IDs (e.g., a first TCI state/TCI state ID, a first pair of TCI states/TCI state IDs, a second TCI state/TCI state ID, and/or a second pair of TCI states/TCI state IDs for N=2 or M=2) for PDCCH reception(s).

In the present disclosure, the UE 116 could be provided/indicated/configured/informed by the network 130, e.g., via higher layer RRC signaling and/or MAC CE command and/or dynamic DCI based signaling, that the indicator/parameter provided/indicated/configured in the higher layer parameter, e.g., ControlResourceSet, as specified herein, and/or the TCI state(s)/TCI state ID(s), provided/indicated/configured in the higher layer parameter, e.g., ControlResourceSet, as specified herein, could be used/applied for PDCCH reception(s). For instance, the UE 116 could be provided/indicated/configured/informed by the network 130, e.g., a higher layer parameter ‘beamAssociationPDCCH’, in a higher layer parameter, e.g., PDCCH-Config/PDSCH-Config/ControlResourceSet/etc. For this case, when/if the higher layer parameter ‘beamAssociationPDCCH’ is present/configured or set to ‘enabled’/‘on’, the indicator/parameter provided/indicated/configured in the higher layer parameter, e.g., ControlResourceSet, as specified herein, and/or the TCI state(s)/TCI state ID(s), provided/indicated/configured in the higher layer parameter, e.g., ControlResourceSet, as specified herein, could be used/applied for PDCCH reception(s). Otherwise, i.e., when/if the higher layer parameter ‘beamAssociationPDCCH’ is absent/not present/not configured or set to ‘disabled’/‘off’, the indicator/parameter provided/indicated/configured in the higher layer parameter, e.g., ControlResourceSet, as specified herein, and/or the TCI state(s)/TCI state ID(s), provided/indicated/configured in the higher layer parameter, e.g., ControlResourceSet, as specified herein, could be used/applied for receiving channels/signals (such as PDSCH, CSI-RS) other than PDCCH.

In one example, for N=2 or M=2, the UE 116 could apply/use the first (or second) indicated TCI state/pair of TCI states to monitor PDCCH candidate(s) received in CORESET(s) associated/configured with the indicator/parameter in the corresponding ControlResourceSet set to ‘0’ (or equivalently, the UE 116 could assume that the DM-RS antenna port(s) of the PDCCH received in CORESET(s) associated/configured with the indicator/parameter in the corresponding ControlResourceSet set to ‘0’ is quasi co-located with the RS(s) in the RS set(s) provided/indicated/configured in the first (or second) indicated TCI state/pair of TCI states). The UE 116 could apply/use the second (or first) indicated TCI state/pair of TCI states to monitor PDCCH candidate(s) received in CORESET(s) associated/configured with the indicator/parameter in the corresponding ControlResourceSet set to ‘1’ (or equivalently, the UE 116 could assume that the DM-RS antenna port(s) of the PDCCH received in CORESET(s) associated/configured with the indicator/parameter in the corresponding ControlResourceSet set to ‘1’ is quasi co-located with the RS(s) in the RS set(s) provided/indicated/configured in the second (or first) indicated TCI state/pair of TCI states). Here, the first (or second) indicated TCI state/pair of TCI states could also correspond to (or could be replaced by) the first (or second) TCI state/pair of TCI states provided/indicated/configured, e.g., in form of their respective/corresponding TCI state ID(s), in the higher layer parameter, e.g., ControlResourceSet, as specified herein with or without configuring/enabling/following the indicator/parameter, e.g., in ControlResourceSet.

In another example, for N=2 or M=2, the UE 116 could apply/use the first indicated TCI state/pair of TCI states to monitor first PDCCH candidate(s) received in CORESET(s) associated/configured with the indicator/parameter in the corresponding ControlResourceSet set to ‘0’ (or ‘1’) and the second indicated TCI state/pair of TCI states to monitor second PDCCH candidate(s) received in CORESET(s) associated/configured with the indicator/parameter in the corresponding ControlResourceSet set to ‘0’ (or ‘1’). The UE 116 could apply/use the second indicated TCI state/pair of TCI states to monitor first PDCCH candidate(s) received in CORESET(s) associated/configured with the indicator/parameter in the corresponding ControlResourceSet set to ‘1’ (or ‘0’) and the first indicated TCI state/pair of TCI states to monitor second PDCCH candidate(s) received in CORESET(s) associated/configured with the indicator/parameter in the corresponding ControlResourceSet set to ‘1’ (or ‘0’). Here, the first (or second) indicated TCI state/pair of TCI states could also correspond to (or could be replaced by) the first (or second) TCI state/pair of TCI states provided/indicated/configured, e.g., in form of their respective/corresponding TCI state ID(s), in the higher layer parameter, e.g., ControlResourceSet, as specified herein with or without configuring/enabling/following the indicator/parameter, e.g., in ControlResourceSet.

In yet another example, for N=2 or M=2, the UE 116 could apply/use the first (or second) indicated TCI state/pair of TCI states to monitor PDCCH candidate(s) received in CORESET(s) associated/configured with the indicator/parameter in the corresponding ControlResourceSet set to ‘00’ (‘01’, ‘10’, or ‘11’). Equivalently, the UE 116 could assume that the DM-RS antenna port(s) of the PDCCH received in CORESET(s) associated/configured with the indicator/parameter in the corresponding ControlResourceSet set to ‘00’ (‘01’, 10’, or ‘11’) is quasi co-located with the RS(s) in the RS set(s) provided/indicated/configured in the first (or second) indicated TCI state/pair of TCI states. The UE 116 could apply/use the second (or first) indicated TCI state/pair of TCI states to monitor PDCCH candidate(s) received in CORESET(s) associated/configured with the indicator/parameter in the corresponding ControlResourceSet set to ‘01’ (‘00’, ‘10’, or ‘11’). Equivalently, the UE 116 could assume that the DM-RS antenna port(s) of the PDCCH received in CORESET(s) associated/configured with the indicator/parameter in the corresponding ControlResourceSet set to ‘01’ (‘00’, ‘10’, or ‘11’) is quasi co-located with the RS(s) in the RS set(s) provided/indicated/configured in the second (or first) indicated TCI state/pair of TCI states). The UE 116 could apply/use the first indicated TCI state/pair of TCI states to monitor first PDCCH candidate(s) received in CORESET(s) associated/configured with the indicator/parameter in the corresponding ControlResourceSet set to ‘10’ (‘00’, ‘01’, or ‘11’) and the second indicated TCI state/pair of TCI states to monitor second PDCCH candidate(s) received in CORESET(s) associated/configured with the indicator/parameter in the corresponding ControlResourceSet set to ‘10’ (‘00’, ‘01’, or ‘11’).

Alternatively, the UE 116 could apply/use the second indicated TCI state/pair of TCI states to monitor first PDCCH candidate(s) received in CORESET(s) associated/configured with the indicator/parameter in the corresponding ControlResourceSet set to ‘11’ (‘00’, ‘01’, or ‘10’) and the first indicated TCI state/pair of TCI states to monitor second PDCCH candidate(s) received in CORESET(s) associated/configured with the indicator/parameter in the corresponding ControlResourceSet set to ‘11’ (‘00’, ‘01’, or ‘10’). Here, the first (or second) indicated TCI state/pair of TCI states could also correspond to (or could be replaced by) the first (or second) TCI state/pair of TCI states provided/indicated/configured, e.g., in form of their respective/corresponding TCI state ID(s), in the higher layer parameter, e.g., ControlResourceSet, as specified herein with or without configuring/enabling/following the indicator/parameter, e.g., in ControlResourceSet.

In yet another example, for N=2 or M=2, when/if the beam indication DCI is received in CORESET(s) associated/configured with the indicator/parameter in the corresponding ControlResourceSet set to ‘0’, the UE 116 could apply/use the first (or second) indicated TCI state/pair of TCI states to monitor PDCCH candidate(s), wherein the PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘0’ or ‘1’. When/if the beam indication DCI is received in CORESET(s) associated/configured with the indicator/parameter in the corresponding ControlResourceSet set to ‘1’, the UE 116 could apply/use the second (or first) indicated TCI state/pair of TCI states to monitor PDCCH candidate(s), wherein the PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘0’ or ‘1’. Here, the first (or second) indicated TCI state/pair of TCI states could also correspond to (or could be replaced by) the first (or second) TCI state/pair of TCI states provided/indicated/configured, e.g., in form of their respective/corresponding TCI state ID(s), in the higher layer parameter, e.g., ControlResourceSet, as specified herein with or without configuring/enabling/following the indicator/parameter, e.g., in ControlResourceSet.

In yet another example, for N=2 or M=2, when/if the beam indication DCI is received in CORESET(s) associated/configured with the indicator/parameter in the corresponding ControlResourceSet set to ‘0’ (or ‘1’), the UE 116 could apply/use the first indicated TCI state/pair of TCI states to monitor first PDCCH candidate(s) and the second indicated TCI state/pair of TCI states to monitor second PDCCH candidate(s), wherein the first and/or second PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘0’ or ‘1’. When/if the beam indication DCI is received in CORESET(s) associated/configured with the indicator/parameter in the corresponding ControlResourceSet set to ‘1’ (or ‘0’), the UE 116 could apply/use the second indicated TCI state/pair of TCI states to monitor the first PDCCH candidate(s) and the first indicated TCI state/pair of TCI states to monitor the second PDCCH candidate(s), wherein the first and/or second PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘0’ or ‘1’. Here, the first (or second) indicated TCI state/pair of TCI states could also correspond to (or could be replaced by) the first (or second) TCI state/pair of TCI states provided/indicated/configured, e.g., in form of their respective/corresponding TCI state ID(s), in the higher layer parameter, e.g., ControlResourceSet, as specified herein with or without configuring/enabling/following the indicator/parameter, e.g., in ControlResourceSet.

In yet another example, for N=2 or M=2, when/if the beam indication DCI is received in CORESET(s) associated/configured with the indicator/parameter in the corresponding ControlResourceSet set to ‘00’ (‘01’, ‘10’ or ‘11’), the UE 116 could apply/use the first (or second) indicated TCI state/pair of TCI states to monitor PDCCH candidate(s), wherein the PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘00’ or ‘01’ or ‘10’ or ‘11’. When/if the beam indication DCI is received in CORESET(s) associated/configured with the indicator/parameter in the corresponding ControlResourceSet set to ‘01’ (‘00’, ‘10’, or ‘11’), the UE 116 could apply/use the second (or first) indicated TCI state/pair of TCI states to monitor PDCCH candidate(s), wherein the PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘00’ or ‘01’ or ‘10’ or ‘11’. When/if the beam indication DCI is received in CORESET(s) associated/configured with the indicator/parameter in the corresponding ControlResourceSet set to ‘10’ (‘00’, ‘01’, or ‘11’), the UE 116 could apply/use the first indicated TCI state/pair of TCI states to monitor first PDCCH candidate(s) and the second indicated TCI state/pair of TCI states to monitor second PDCCH candidate(s), wherein the first and/or second PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘00’ or ‘01’ or ‘10’ or ‘11’. When/if the beam indication DCI is received in CORESET(s) associated/configured with the indicator/parameter in the corresponding ControlResourceSet set to ‘11’ (‘00’, ‘01’ or ‘10’), the UE 116 could apply/use the second indicated TCI state/pair of TCI states to monitor the first PDCCH candidate(s) and the first indicated TCI state/pair of TCI states to monitor the second PDCCH candidate(s), wherein the first and/or second PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘00’ or ‘01’ or ‘10’ or ‘11’. Here, the first (or second) indicated TCI state/pair of TCI states could also correspond to (or could be replaced by) the first (or second) TCI state/pair of TCI states provided/indicated/configured, e.g., in form of their respective/corresponding TCI state ID(s), in the higher layer parameter, e.g., ControlResourceSet, as specified herein with or without configuring/enabling/following the indicator/parameter, e.g., in ControlResourceSet.

For the examples described herein, the UE 116 may use/apply none of the indicated TCI states/pairs of TCI states to receive PDCCH(s) in a CORESET when/if the indicator/parameter provided in the higher layer parameter ControlResourceSet that configures the CORESET, as specified herein—e.g., following one or more examples described herein—is set to (i) ‘none’ or ‘disabled’ or ‘off’ or ‘not present’/‘absent’ or ‘not configured’ and/or (ii) a predetermined value ‘0’, ‘1’, ‘00’, ‘01’, ‘10’ or ‘11’ that is designated for indicating that none of the indicated TCI states/pairs of TCI states could be used/applied for PDCCH reception(s) in the CORESET. The UE 116 could first follow one or more examples described herein to determine the association between the indicated TCI state(s) and the PDCCH reception(s). The UE 116 could then follow one or more examples described herein to determine the association between the indicated TCI state(s) and the PDCCH reception(s) according to/based on one or more events or one or more conditions discussed/specified herein.

In one example, for N=2 or M=2, the UE 116 could monitor category-1 PDCCH candidate(s) received in CORESET(s) associated/configured with the indicator/parameter in the corresponding ControlResourceSet set to ‘0’ or ‘1’ or ‘00’ or ‘01’ or ‘10’ or ‘11’, and the UE 116 could monitor category-2 PDCCH candidate(s) received in CORESET(s) not associated/configured with the indicator/parameter specified/defined herein (e.g., in the corresponding ControlResourceSet). The UE 116 could apply/use the first (or second) indicated TCI state/pair of TCI states to monitor the category-1 PDCCH candidate(s) received in CORESET(s) associated/configured with the indicator/parameter in the corresponding ControlResourceSet set to ‘0’ (or equivalently, the UE 116 could assume that the DM-RS antenna port(s) of the category-1 PDCCH candidate(s) received in CORESET(s) associated/configured with the indicator/parameter in the corresponding ControlResourceSet set to ‘0’ is quasi co-located with the RS(s) in the RS set(s) provided/indicated/configured in the first (or second) indicated TCI state/pair of TCI states), and the UE 116 could apply/use the second (or first) indicated TCI state/pair of TCI states to monitor the category-1 PDCCH candidate(s) received in CORESET(s) associated/configured with the indicator/parameter in the corresponding ControlResourceSet set to ‘1’ (or equivalently, the UE 116 could assume that the DM-RS antenna port(s) of the category-1 PDCCH candidate(s) received in CORESET(s) associated/configured with the indicator/parameter in the corresponding ControlResourceSet set to ‘1’ is quasi co-located with the RS(s) in the RS set(s) provided/indicated/configured in the second (or first) indicated TCI state/pair of TCI states).

For example, for the category-2 PDCCH candidate(s), when/if the beam indication DCI is received in CORESET(s) associated/configured with the indicator/parameter in the corresponding ControlResourceSet set to ‘0’, the UE 116 could apply/use the first (or second) indicated TCI state/pair of TCI states to monitor the category-2 PDCCH candidate(s). When/if the beam indication DCI is received in CORESET(s) associated/configured with the indicator/parameter in the corresponding ControlResourceSet set to ‘1’, the UE 116 could apply/use the second (or first) indicated TCI state/pair of TCI states to monitor the category-2 PDCCH candidate(s).

For another example, when/if the beam indication DCI is received in CORESET(s) associated/configured with the indicator/parameter in the corresponding ControlResourceSet set to ‘0’ (or ‘1’), the UE 116 could apply/use the first indicated TCI state/pair of TCI states to monitor first category-2 PDCCH candidate(s) and the second indicated TCI state/pair of TCI states to monitor second category-2 PDCCH candidate(s). When/if the beam indication DCI is received in CORESET(s) associated/configured with the indicator/parameter in the corresponding ControlResourceSet set to ‘1’ (or ‘0’), the UE 116 could apply/use the second indicated TCI state/pair of TCI states to monitor the first category-2 PDCCH candidate(s) and the first indicated TCI state/pair of TCI states to monitor the second category-2 PDCCH candidate(s).

Yet for another example, when/if the beam indication DCI is received in CORESET(s) associated/configured with the indicator/parameter in the corresponding ControlResourceSet set to ‘00’ (‘01’, ‘10’, or ‘11’), the UE 116 could apply/use the first (or second) indicated TCI state/pair of TCI states to monitor category-2 PDCCH candidate(s). When/if the beam indication DCI is received in CORESET(s) associated/configured with the indicator/parameter in the corresponding ControlResourceSet set to ‘01’ (‘00’, ‘10’, or ‘11’), the UE 116 could apply/use the second (or first) indicated TCI state/pair of TCI states to monitor category-2 PDCCH candidate(s). When/if the beam indication DCI is received in CORESET(s) associated/configured with the indicator/parameter in the corresponding ControlResourceSet set to ‘10’ (‘00’, ‘01’, or ‘11’), the UE 116 could apply/use the first indicated TCI state/pair of TCI states to monitor first category-2 PDCCH candidate(s) and the second indicated TCI state/pair of TCI states to monitor second category-2 PDCCH candidate(s). When/if the beam indication DCI is received in CORESET(s) associated/configured with the indicator/parameter in the corresponding ControlResourceSet set to ‘11’ (‘00’, ‘01’, or ‘10’), the UE 116 could apply/use the second indicated TCI state/pair of TCI states to monitor the first category-2 PDCCH candidate(s) and the first indicated TCI state/pair of TCI states to monitor the second category-2 PDCCH candidate(s).

In another example, for N=2 or M=2, the UE 116 could monitor category-1 PDCCH candidate(s) received in CORESET(s) associated/configured with the indicator/parameter in the corresponding ControlResourceSet set to ‘0’ or ‘1’ or ‘00’ or ‘01’ or ‘10’ or ‘11’, and the UE 116 could monitor category-2 PDCCH candidate(s) received in CORESET(s) not associated/configured with the indicator/parameter specified/defined herein (e.g., in the corresponding ControlResourceSet). The UE 116 could apply/use the first indicated TCI state/pair of TCI states to monitor first category-1 PDCCH candidate(s) received in CORESET(s) associated/configured with the indicator/parameter in the corresponding ControlResourceSet set to ‘0’ (or ‘1’) and the second indicated TCI state/pair of TCI states to monitor second category-1 PDCCH candidate(s) received in CORESET(s) associated/configured with the indicator/parameter in the corresponding ControlResourceSet set to ‘0’ (or ‘1’). The UE 116 could apply/use the second indicated TCI state/pair of TCI states to monitor first category-1 PDCCH candidate(s) received in CORESET(s) associated/configured with the indicator/parameter in the corresponding ControlResourceSet set to ‘1’ (or ‘0’) and the first indicated TCI state/pair of TCI states to monitor second category-1 PDCCH candidate(s) received in CORESET(s) associated/configured with the indicator/parameter in the corresponding ControlResourceSet set to ‘1’ (or ‘0’).

For example, when/if the beam indication DCI is received in CORESET(s) associated/configured with the indicator/parameter in the corresponding ControlResourceSet set to ‘0’, the UE 116 could apply/use the first (or second) indicated TCI state/pair of TCI states to monitor the category-2 PDCCH candidate(s). When/if the beam indication DCI is received in CORESET(s) associated/configured with the indicator/parameter in the corresponding ControlResourceSet set to ‘1’, the UE 116 could apply/use the second (or first) indicated TCI state/pair of TCI states to monitor the category-2 PDCCH candidate(s).

For another example, when/if the beam indication DCI is received in CORESET(s) associated/configured with the indicator/parameter in the corresponding ControlResourceSet set to ‘0’ (or ‘1’), the UE 116 could apply/use the first indicated TCI state/pair of TCI states to monitor first category-2 PDCCH candidate(s) and the second indicated TCI state/pair of TCI states to monitor second category-2 PDCCH candidate(s). When/if the beam indication DCI is received in CORESET(s) associated/configured with the indicator/parameter in the corresponding ControlResourceSet set to ‘1’ (or ‘0’), the UE 116 could apply/use the second indicated TCI state/pair of TCI states to monitor the first category-2 PDCCH candidate(s) and the first indicated TCI state/pair of TCI states to monitor the second category-2 PDCCH candidate(s).

Yet for another example, when/if the beam indication DCI is received in CORESET(s) associated/configured with the indicator/parameter in the corresponding ControlResourceSet set to ‘00’ (‘01’, ‘10’, or ‘11’), the UE 116 could apply/use the first (or second) indicated TCI state/pair of TCI states to monitor category-2 PDCCH candidate(s). When/if the beam indication DCI is received in CORESET(s) associated/configured with the indicator/parameter in the corresponding ControlResourceSet set to ‘01’ (‘00’, ‘10’, or ‘11’), the UE 116 could apply/use the second (or first) indicated TCI state/pair of TCI states to monitor category-2 PDCCH candidate(s). When/if the beam indication DCI is received in CORESET(s) associated/configured with the indicator/parameter in the corresponding ControlResourceSet set to ‘10’ (‘00’, ‘01’, or ‘11’), the UE 116 could apply/use the first indicated TCI state/pair of TCI states to monitor first category-2 PDCCH candidate(s) and the second indicated TCI state/pair of TCI states to monitor second category-2 PDCCH candidate(s). When/if the beam indication DCI is received in CORESET(s) associated/configured with the indicator/parameter in the corresponding ControlResourceSet set to ‘11’ (‘00’, ‘01’, or ‘10’), the UE 116 could apply/use the second indicated TCI state/pair of TCI states to monitor the first category-2 PDCCH candidate(s) and the first indicated TCI state/pair of TCI states to monitor the second category-2 PDCCH candidate(s).

In yet another example, for N=2 or M=2, the UE 116 could monitor category-1 PDCCH candidate(s) received in CORESET(s) associated/configured with the indicator/parameter in the corresponding ControlResourceSet set to ‘0’ or ‘1’ or ‘00’ or ‘01’ or ‘10’ or ‘11’. The UE 116 could monitor category-2 PDCCH candidate(s) received in CORESET(s) not associated/configured with the indicator/parameter specified/defined herein (e.g., in the corresponding ControlResourceSet). The UE 116 could apply/use the first (or second) indicated TCI state/pair of TCI states to monitor category-1 PDCCH candidate(s) received in CORESET(s) associated/configured with the indicator/parameter in the corresponding ControlResourceSet set to ‘00’ (‘01’, ‘10’, or ‘11’).

Equivalently, the UE 116 could assume that the DM-RS antenna port(s) of the category-1 PDCCH received in CORESET(s) associated/configured with the indicator/parameter in the corresponding ControlResourceSet set to ‘00’ (‘01’, 10’, or ‘11’) is quasi co-located with the RS(s) in the RS set(s) provided/indicated/configured in the first (or second) indicated TCI state/pair of TCI states. The UE 116 could apply/use the second (or first) indicated TCI state/pair of TCI states to monitor category-1 PDCCH candidate(s) received in CORESET(s) associated/configured with the indicator/parameter in the corresponding ControlResourceSet set to ‘01’ (‘00’, ‘10’, or ‘11’).

Equivalently, the UE 116 could assume that the DM-RS antenna port(s) of the category-1 PDCCH received in CORESET(s) associated/configured with the indicator/parameter in the corresponding ControlResourceSet set to ‘01’ (‘00’, ‘10’, or ‘11’) is quasi co-located with the RS(s) in the RS set(s) provided/indicated/configured in the second (or first) indicated TCI state/pair of TCI states). The UE 116 could apply/use the first indicated TCI state/pair of TCI states to monitor first category-1 PDCCH candidate(s) received in CORESET(s) associated/configured with the indicator/parameter in the corresponding ControlResourceSet set to ‘10’ (‘00’, ‘01’, or ‘11’) and the second indicated TCI state/pair of TCI states to monitor second category-1 PDCCH candidate(s) received in CORESET(s) associated/configured with the indicator/parameter in the corresponding ControlResourceSet set to ‘10’ (‘00’, ‘01’, or ‘11’).

Alternatively, the UE 116 could apply/use the second indicated TCI state/pair of TCI states to monitor first category-1 PDCCH candidate(s) received in CORESET(s) associated/configured with the indicator/parameter in the corresponding ControlResourceSet set to ‘11’ (‘00’, ‘01’, or ‘10’) and the first indicated TCI state/pair of TCI states to monitor second category-1 PDCCH candidate(s) received in CORESET(s) associated/configured with the indicator/parameter in the corresponding ControlResourceSet set to ‘11’ (‘00’, ‘01’, or ‘10’).

For example, when/if the beam indication DCI is received in CORESET(s) associated/configured with the indicator/parameter in the corresponding ControlResourceSet set to ‘0’, the UE 116 could apply/use the first (or second) indicated TCI state/pair of TCI states to monitor the category-2 PDCCH candidate(s). When/if the beam indication DCI is received in CORESET(s) associated/configured with the indicator/parameter in the corresponding ControlResourceSet set to ‘1’, the UE 116 could apply/use the second (or first) indicated TCI state/pair of TCI states to monitor the category-2 PDCCH candidate(s).

For another example, when/if the beam indication DCI is received in CORESET(s) associated/configured with the indicator/parameter in the corresponding ControlResourceSet set to ‘0’ (or ‘1’), the UE 116 could apply/use the first indicated TCI state/pair of TCI states to monitor first category-2 PDCCH candidate(s) and the second indicated TCI state/pair of TCI states to monitor second category-2 PDCCH candidate(s). When/if the beam indication DCI is received in CORESET(s) associated/configured with the indicator/parameter in the corresponding ControlResourceSet set to ‘1’ (or ‘0’), the UE 116 could apply/use the second indicated TCI state/pair of TCI states to monitor the first category-2 PDCCH candidate(s) and the first indicated TCI state/pair of TCI states to monitor the second category-2 PDCCH candidate(s).

Yet for another example, when/if the beam indication DCI is received in CORESET(s) associated/configured with the indicator/parameter in the corresponding ControlResourceSet set to ‘00’ (‘01’, ‘10’ or ‘11’), the UE 116 could apply/use the first (or second) indicated TCI state/pair of TCI states to monitor category-2 PDCCH candidate(s). When/if the beam indication DCI is received in CORESET(s) associated/configured with the indicator/parameter in the corresponding ControlResourceSet set to ‘01’ (‘00’, ‘10’, or ‘11’), the UE 116 could apply/use the second (or first) indicated TCI state/pair of TCI states to monitor category-2 PDCCH candidate(s). When/if the beam indication DCI is received in CORESET(s) associated/configured with the indicator/parameter in the corresponding ControlResourceSet set to ‘10’ (‘00’, ‘01’, or ‘11’), the UE 116 could apply/use the first indicated TCI state/pair of TCI states to monitor first category-2 PDCCH candidate(s) and the second indicated TCI state/pair of TCI states to monitor second category-2 PDCCH candidate(s). When/if the beam indication DCI is received in CORESET(s) associated/configured with the indicator/parameter in the corresponding ControlResourceSet set to ‘11’ (‘00’, ‘01’, or ‘10’), the UE 116 could apply/use the second indicated TCI state/pair of TCI states to monitor the first category-2 PDCCH candidate(s) and the first indicated TCI state/pair of TCI states to monitor the second category-2 PDCCH candidate(s).

The UE 116 could first follow one or more examples described herein to determine the association between the indicated TCI state(s) and the PDCCH reception(s). The UE 116 could then follow one or more examples described herein to determine the association between the indicated TCI state(s) and the PDCCH reception(s) according to/based on one or more events, or one or more conditions discussed/specified herein.

In one example, for N=2 or M=2, when/if the beam indication DCI is received in CORESET(s) associated/configured with the indicator/parameter in the corresponding ControlResourceSet set to ‘0’, the UE 116 could apply/use the first (or second) indicated TCI state/pair of TCI states to monitor PDCCH candidate(s), wherein the PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘0’ or ‘1’ or ‘00’ or ‘01’ or ‘10’ or ‘11’. When/if the beam indication DCI is received in CORESET(s) associated/configured with the indicator/parameter in the corresponding ControlResourceSet set to ‘1’, the UE 116 could apply/use the second (or first) indicated TCI state/pair of TCI states to monitor PDCCH candidate(s), wherein the PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘0’ or ‘1’ or ‘00’ or ‘01’ or ‘10’ or ‘11’.

For example, when/if the beam indication DCI is received in CORESET(s) not associated/configured with the indicator/parameter specified/defined herein (e.g., in the corresponding ControlResourceSet), the UE 116 could apply/use the first (or second) indicated TCI state/pair of TCI states to monitor PDCCH candidate(s) received in CORESET(s) associated/configured with the indicator/parameter in the corresponding ControlResourceSet set to ‘0’ (or equivalently, the UE 116 could assume that the DM-RS antenna port(s) of the PDCCH received in CORESET(s) associated/configured with the indicator/parameter in the corresponding ControlResourceSet set to ‘0’ is quasi co-located with the RS(s) in the RS set(s) provided/indicated/configured in the first (or second) indicated TCI state/pair of TCI states). The UE 116 could apply/use the second (or first) indicated TCI state/pair of TCI states to monitor PDCCH candidate(s) received in CORESET(s) associated/configured with the indicator/parameter in the corresponding ControlResourceSet set to ‘1’ (or equivalently, the UE 116 could assume that the DM-RS antenna port(s) of the PDCCH received in CORESET(s) associated/configured with the indicator/parameter in the corresponding ControlResourceSet set to ‘1’ is quasi co-located with the RS(s) in the RS set(s) provided/indicated/configured in the second (or first) indicated TCI state/pair of TCI states).

For another example, the UE 116 could apply/use the first indicated TCI state/pair of TCI states to monitor first PDCCH candidate(s) received in CORESET(s) associated/configured with the indicator/parameter in the corresponding ControlResourceSet set to ‘0’ (or ‘1’) and the second indicated TCI state/pair of TCI states to monitor second PDCCH candidate(s) received in CORESET(s) associated/configured with the indicator/parameter in the corresponding ControlResourceSet set to ‘0’ (or ‘1’). The UE 116 could apply/use the second indicated TCI state/pair of TCI states to monitor first PDCCH candidate(s) received in CORESET(s) associated/configured with the indicator/parameter in the corresponding ControlResourceSet set to ‘1’ (or ‘0’) and the first indicated TCI state/pair of TCI states to monitor second PDCCH candidate(s) received in CORESET(s) associated/configured with the indicator/parameter in the corresponding ControlResourceSet set to ‘1’ (or ‘0’).

Yet for another example, the UE 116 could apply/use the first (or second) indicated TCI state/pair of TCI states to monitor PDCCH candidate(s) received in CORESET(s) associated/configured with the indicator/parameter in the corresponding ControlResourceSet set to ‘00’ (‘01’, ‘10’, or ‘11’). Equivalently, the UE 116 could assume that the DM-RS antenna port(s) of the PDCCH received in CORESET(s) associated/configured with the indicator/parameter in the corresponding ControlResourceSet set to ‘00’ (‘01’, ‘10’, or ‘11’) is quasi co-located with the RS(s) in the RS set(s) provided/indicated/configured in the first (or second) indicated TCI state/pair of TCI states, the UE 116 could apply/use the second (or first) indicated TCI state/pair of TCI states to monitor PDCCH candidate(s) received in CORESET(s) associated/configured with the indicator/parameter in the corresponding ControlResourceSet set to ‘01’ (‘00’, ‘10’ or ‘11’). Equivalently, the UE 116 could assume that the DM-RS antenna port(s) of the PDCCH received in CORESET(s) associated/configured with the indicator/parameter in the corresponding ControlResourceSet set to ‘01’ (‘00’, ‘10’ or ‘11’) is quasi co-located with the RS(s) in the RS set(s) provided/indicated/configured in the second (or first) indicated TCI state/pair of TCI states). The UE 116 could apply/use the first indicated TCI state/pair of TCI states to monitor first PDCCH candidate(s) received in CORESET(s) associated/configured with the indicator/parameter in the corresponding ControlResourceSet set to ‘10’ (‘00’, ‘01’ or ‘11’) and the second indicated TCI state/pair of TCI states to monitor second PDCCH candidate(s) received in CORESET(s) associated/configured with the indicator/parameter in the corresponding ControlResourceSet set to ‘10’ (‘00’, ‘01’ or ‘11’).

Alternatively, the UE 116 could apply/use the second indicated TCI state/pair of TCI states to monitor first PDCCH candidate(s) received in CORESET(s) associated/configured with the indicator/parameter in the corresponding ControlResourceSet set to ‘11’ (‘00’, ‘01’ or ‘10’) and the first indicated TCI state/pair of TCI states to monitor second PDCCH candidate(s) received in CORESET(s) associated/configured with the indicator/parameter in the corresponding ControlResourceSet set to ‘11’ (‘00’, ‘01’, or ‘10’).

In another example, for N=2 or M=2, when/if the beam indication DCI is received in CORESET(s) associated/configured with the indicator/parameter in the corresponding ControlResourceSet set to ‘0’ (or ‘1’), the UE 116 could apply/use the first indicated TCI state/pair of TCI states to monitor first PDCCH candidate(s) and the second indicated TCI state/pair of TCI states to monitor second PDCCH candidate(s), wherein the first and/or second PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘0’ or ‘1’ or ‘00’ or ‘01’ or ‘10’ or ‘11’. When/if the beam indication DCI is received in CORESET(s) associated/configured with the indicator/parameter in the corresponding ControlResourceSet set to ‘1’ (or ‘0’), the UE 116 could apply/use the second indicated TCI state/pair of TCI states to monitor the first PDCCH candidate(s) and the first indicated TCI state/pair of TCI states to monitor the second PDCCH candidate(s), wherein the first and/or second PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘0’ or ‘1’ or ‘00’ or ‘01’ or ‘10’ or ‘11’.

For example, when/if the beam indication DCI is received in CORESET(s) not associated/configured with the indicator/parameter specified/defined herein (e.g., in the corresponding ControlResourceSet), the UE 116 could apply/use the first (or second) indicated TCI state/pair of TCI states to monitor PDCCH candidate(s) received in CORESET(s) associated/configured with the indicator/parameter in the corresponding ControlResourceSet set to ‘0’ (or equivalently, the UE 116 could assume that the DM-RS antenna port(s) of the PDCCH received in CORESET(s) associated/configured with the indicator/parameter in the corresponding ControlResourceSet set to ‘0’ is quasi co-located with the RS(s) in the RS set(s) provided/indicated/configured in the first (or second) indicated TCI state/pair of TCI states). The UE 116 could apply/use the second (or first) indicated TCI state/pair of TCI states to monitor PDCCH candidate(s) received in CORESET(s) associated/configured with the indicator/parameter in the corresponding ControlResourceSet set to ‘1’ (or equivalently, the UE 116 could assume that the DM-RS antenna port(s) of the PDCCH received in CORESET(s) associated/configured with the indicator/parameter in the corresponding ControlResourceSet set to ‘1’ is quasi co-located with the RS(s) in the RS set(s) provided/indicated/configured in the second (or first) indicated TCI state/pair of TCI states).

For another example, the UE 116 could apply/use the first indicated TCI state/pair of TCI states to monitor first PDCCH candidate(s) received in CORESET(s) associated/configured with the indicator/parameter in the corresponding ControlResourceSet set to ‘0’ (or ‘1’) and the second indicated TCI state/pair of TCI states to monitor second PDCCH candidate(s) received in CORESET(s) associated/configured with the indicator/parameter in the corresponding ControlResourceSet set to ‘0’ (or ‘1’). The UE 116 could apply/use the second indicated TCI state/pair of TCI states to monitor first PDCCH candidate(s) received in CORESET(s) associated/configured with the indicator/parameter in the corresponding ControlResourceSet set to ‘1’ (or ‘0’) and the first indicated TCI state/pair of TCI states to monitor second PDCCH candidate(s) received in CORESET(s) associated/configured with the indicator/parameter in the corresponding ControlResourceSet set to ‘1’ (or ‘0’).

Yet for another example, the UE 116 could apply/use the first (or second) indicated TCI state/pair of TCI states to monitor PDCCH candidate(s) received in CORESET(s) associated/configured with the indicator/parameter in the corresponding ControlResourceSet set to ‘00’ (‘01’, ‘10’, or ‘11’). Equivalently, the UE 116 could assume that the DM-RS antenna port(s) of the PDCCH received in CORESET(s) associated/configured with the indicator/parameter in the corresponding ControlResourceSet set to ‘00’ (‘01’, ‘10’, or ‘11’) is quasi co-located with the RS(s) in the RS set(s) provided/indicated/configured in the first (or second) indicated TCI state/pair of TCI states. The UE 116 could apply/use the second (or first) indicated TCI state/pair of TCI states to monitor PDCCH candidate(s) received in CORESET(s) associated/configured with the indicator/parameter in the corresponding ControlResourceSet set to ‘01’ (‘00’, ‘10’, or ‘11’). Equivalently, the UE 116 could assume that the DM-RS antenna port(s) of the PDCCH received in CORESET(s) associated/configured with the indicator/parameter in the corresponding ControlResourceSet set to ‘01’ (‘00’, ‘10’, or ‘11’) is quasi co-located with the RS(s) in the RS set(s) provided/indicated/configured in the second (or first) indicated TCI state/pair of TCI states). The UE 116 could apply/use the first indicated TCI state/pair of TCI states to monitor first PDCCH candidate(s) received in CORESET(s) associated/configured with the indicator/parameter in the corresponding ControlResourceSet set to ‘10’ (‘00’, ‘01’, or ‘11’) and the second indicated TCI state/pair of TCI states to monitor second PDCCH candidate(s) received in CORESET(s) associated/configured with the indicator/parameter in the corresponding ControlResourceSet set to ‘10’ (‘00’, ‘01’, or ‘11’), or the UE 116 could apply/use the second indicated TCI state/pair of TCI states to monitor first PDCCH candidate(s) received in CORESET(s) associated/configured with the indicator/parameter in the corresponding ControlResourceSet set to ‘11’ (‘00’, ‘01’, or ‘10’) and the first indicated TCI state/pair of TCI states to monitor second PDCCH candidate(s) received in CORESET(s) associated/configured with the indicator/parameter in the corresponding ControlResourceSet set to ‘11’ (‘00’, ‘01’, or ‘10’).

In yet another example, for N=2 or M=2, when/if the beam indication DCI is received in CORESET(s) associated/configured with the indicator/parameter in the corresponding ControlResourceSet set to ‘00’ (‘01’, ‘10’ or ‘11’), the UE 116 could apply/use the first (or second) indicated TCI state/pair of TCI states to monitor PDCCH candidate(s), wherein the PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘0’ or ‘1’ or ‘00’ or ‘01’ or ‘10’ or ‘11’. When/if the beam indication DCI is received in CORESET(s) associated/configured with the indicator/parameter in the corresponding ControlResourceSet set to ‘01’ (‘00’, ‘10’, or ‘11’), the UE 116 could apply/use the second (or first) indicated TCI state/pair of TCI states to monitor PDCCH candidate(s), wherein the PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘0’ or ‘1’ or ‘00’ or ‘01’ or ‘10’ or ‘11’. When/if the beam indication DCI is received in CORESET(s) associated/configured with the indicator/parameter in the corresponding ControlResourceSet set to ‘10’ (‘00’, ‘01’, or ‘11’), the UE 116 could apply/use the first indicated TCI state/pair of TCI states to monitor first PDCCH candidate(s) and the second indicated TCI state/pair of TCI states to monitor second PDCCH candidate(s), wherein the first and/or second PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘0’ or ‘1’ or ‘00’ or ‘01’ or ‘10’ or ‘11’. When/if the beam indication DCI is received in CORESET(s) associated/configured with the indicator/parameter in the corresponding ControlResourceSet set to ‘11’ (‘00’, ‘01’, or ‘10’), the UE 116 could apply/use the second indicated TCI state/pair of TCI states to monitor the first PDCCH candidate(s) and the first indicated TCI state/pair of TCI states to monitor the second PDCCH candidate(s), wherein the first and/or second PDCCH candidate(s) could be received in any CORESET(s) or CORESET(s) not associated/configured with the indicator/parameter specified/defined herein (e.g., in the corresponding ControlResourceSet) or CORESET(s) associated/configured with the indicator/parameter in the corresponding ControlResourceSet set to ‘0’ or ‘1’ or ‘00’ or ‘01’ or ‘10’ or ‘11’.

For example, when/if the beam indication DCI is received in CORESET(s) not associated/configured with the indicator/parameter specified/defined herein (e.g., in the corresponding ControlResourceSet, the UE 116 could apply/use the first (or second) indicated TCI state/pair of TCI states to monitor PDCCH candidate(s) received in CORESET(s) associated/configured with the indicator/parameter in the corresponding ControlResourceSet set to ‘0’ (or equivalently, the UE 116 could assume that the DM-RS antenna port(s) of the PDCCH received in CORESET(s) associated/configured with the indicator/parameter in the corresponding ControlResourceSet set to ‘0’ is quasi co-located with the RS(s) in the RS set(s) provided/indicated/configured in the first (or second) indicated TCI state/pair of TCI states). The UE 116 could apply/use the second (or first) indicated TCI state/pair of TCI states to monitor PDCCH candidate(s) received in CORESET(s) associated/configured with the indicator/parameter in the corresponding ControlResourceSet set to ‘1’ (or equivalently, the UE 116 could assume that the DM-RS antenna port(s) of the PDCCH received in CORESET(s) associated/configured with the indicator/parameter in the corresponding ControlResourceSet set to ‘1’ is quasi co-located with the RS(s) in the RS set(s) provided/indicated/configured in the second (or first) indicated TCI state/pair of TCI states).

For another example, the UE 116 could apply/use the first indicated TCI state/pair of TCI states to monitor first PDCCH candidate(s) received in CORESET(s) associated/configured with the indicator/parameter in the corresponding ControlResourceSet set to ‘0’ (or ‘1’) and the second indicated TCI state/pair of TCI states to monitor second PDCCH candidate(s) received in CORESET(s) associated/configured with the indicator/parameter in the corresponding ControlResourceSet set to ‘0’ (or ‘1’). The UE 116 could apply/use the second indicated TCI state/pair of TCI states to monitor first PDCCH candidate(s) received in CORESET(s) associated/configured with the indicator/parameter in the corresponding ControlResourceSet set to ‘1’ (or ‘0’) and the first indicated TCI state/pair of TCI states to monitor second PDCCH candidate(s) received in CORESET(s) associated/configured with the indicator/parameter in the corresponding ControlResourceSet set to ‘1’ (or ‘0’).

Yet for another example, the UE 116 could apply/use the first (or second) indicated TCI state/pair of TCI states to monitor PDCCH candidate(s) received in CORESET(s) associated/configured with the indicator/parameter in the corresponding ControlResourceSet set to ‘00’ (‘01’, ‘10’, or ‘11’). Equivalently, the UE 116 could assume that the DM-RS antenna port(s) of the PDCCH received in CORESET(s) associated/configured with the indicator/parameter in the corresponding ControlResourceSet set to ‘00’ (‘01’, ‘10’, or ‘11’) is quasi co-located with the RS(s) in the RS set(s) provided/indicated/configured in the first (or second) indicated TCI state/pair of TCI states. The UE 116 could apply/use the second (or first) indicated TCI state/pair of TCI states to monitor PDCCH candidate(s) received in CORESET(s) associated/configured with the indicator/parameter in the corresponding ControlResourceSet set to ‘01’ (‘00’, ‘10’, or ‘11’). Equivalently, the UE 116 could assume that the DM-RS antenna port(s) of the PDCCH received in CORESET(s) associated/configured with the indicator/parameter in the corresponding ControlResourceSet set to ‘01’ (‘00’, ‘10’, or ‘11’) is quasi co-located with the RS(s) in the RS set(s) provided/indicated/configured in the second (or first) indicated TCI state/pair of TCI states), the UE 116 could apply/use the first indicated TCI state/pair of TCI states to monitor first PDCCH candidate(s) received in CORESET(s) associated/configured with the indicator/parameter in the corresponding ControlResourceSet set to ‘10’ (‘00’, ‘01’, or ‘11’) and the second indicated TCI state/pair of TCI states to monitor second PDCCH candidate(s) received in CORESET(s) associated/configured with the indicator/parameter in the corresponding ControlResourceSet set to ‘10’ (‘00’, ‘01’, or ‘11’).

Alternatively, the UE 116 could apply/use the second indicated TCI state/pair of TCI states to monitor first PDCCH candidate(s) received in CORESET(s) associated/configured with the indicator/parameter in the corresponding ControlResourceSet set to ‘11’ (‘00’, ‘01’ or ‘10’) and the first indicated TCI state/pair of TCI states to monitor second PDCCH candidate(s) received in CORESET(s) associated/configured with the indicator/parameter in the corresponding ControlResourceSet set to ‘11’ (‘00’, ‘01’, or ‘10’).

Furthermore, the UE 116 could be indicated/configured/provided by the network 130, e.g., via higher layer RRC signaling/parameter and/or MAC CE command and/or dynamic DCI based L1 signaling, to follow one or more examples (e.g., one or more examples described herein) herein to determine the association between the indicated TCI state(s) and the PDCCH reception(s).

For example, when/if the UE 116 receives from the network 130, e.g., via higher layer RRC signaling (e.g., in PDCCH-Config, PDSCH-Config or ControlResourceSet), a higher layer parameter ‘beamSelectionPDCCH’ set to ‘enabled’, the UE 116 could follow the indicator/parameter provided/indicated/configured in the higher layer parameter PDSCH-Config as specified herein to determine the association between the indicated TCI state(s) and the PDSCH reception(s). Otherwise, e.g., when/if the higher layer parameter ‘beamSelectionPDSCH’ is set to ‘disabled’, the UE 116 could follow the dynamic TRP(s) selection/switching methods specified herein to determine the association between the indicated TCI state(s) and the PDSCH reception(s).

Throughout the one or more examples described herein, a CORESET (or CORESET(s)) associated/configured with the indicator/parameter in the corresponding ControlResourceSet set to ‘0’, ‘1’, ‘00’, ‘01’, ‘10’ or ‘11’ could also correspond to (or could be replaced by) a CORESET (or CORESET(s)) with their corresponding/respective ControlResourceSet providing/indicating/configuring a first TCI state/TCI state ID, a first pair of TCI states/TCI state IDs, a second TCI state/TCI state ID, a second pair of TCI states/TCI state IDs, both of the first TCI state/TCI state ID and the second TCI state/TCI state ID, both of the first pair of TCI states/TCI state IDs and the second pair of TCI states/TCI state IDs, or both of the first (or second) TCI state/TCI state ID and the first (or second) pair of TCI states/TCI state IDs. Equivalently, the indicator/parameter that is provided in the higher layer parameter, e.g., ControlResourceSet, and set to ‘0’, ‘1’, ‘00’, ‘01’, ‘10’ or ‘11’ as specified herein could also correspond to (or could be replaced by) a first TCI state/TCI state ID, a first pair of TCI states/TCI state IDs, a second TCI state/TCI state ID, a second pair of TCI states/TCI state IDs, both of the first TCI state/TCI state ID and the second TCI state/TCI state ID, both of the first pair of TCI states/TCI state IDs and the second pair of TCI states/TCI state IDs, or both of the first (or second) TCI state/TCI state ID and the first (or second) pair of TCI states/TCI state IDs that is provided in the higher layer parameter, e.g., ControlResourceSet, as specified herein. Throughout the one or more examples described herein, a CORESET (or CORESET(s)) not associated/configured with the indicator/parameter in the corresponding ControlResourceSet as specified herein or associated/configured with the indicator/parameter in the corresponding ControlResourceSet as specified herein absent/not present/not configured or set to ‘disabled’ or ‘off’ or ‘none’ could also correspond to (or could be replaced by) a CORESET (or CORESET(s)) with their corresponding/respective ControlResourceSet not providing/indicating/configuring any TCI state(s)/TCI state ID(s). Equivalently, the indicator/parameter that is absent/not present/not configured or set to ‘disabled’ or ‘off’ or ‘none’ in the higher layer parameter, e.g., ControlResourceSet, as specified herein could also correspond to (or could be replaced by) the higher layer parameter, e.g., ControlResourceSet, not providing/indicating/configuring any TCI state(s)/TCI state ID(s).

Throughout the examples specified herein, the first (or second) indicated TCI state/pair of TCI states could also correspond to (or could be replaced by) the first (or second) TCI state/pair of TCI states provided/indicated/configured, e.g., in form of their respective/corresponding TCI state ID(s), in the higher layer parameter, e.g., ControlResourceSet, as specified herein.

In one embodiment, the UE 116 could follow one or more fixed rules to determine which indicated TCI state(s) to use/apply for monitoring PDCCH candidates, wherein the fixed rule(s) could be determined/defined/described as in one or more of the following examples.

For example, for N=2 or M=2, the UE 116 could use/apply the first indicated TCI state/pair of TCI states to receive/monitor all PDCCH candidates.

For another example, for N=2 or M=2, the UE 116 could use/apply the second indicated TCI state/pair of TCI states to receive/monitor all PDCCH candidates.

Yet for another example, for N=2 or M=2, the UE 116 could use/apply the first indicated TCI state/pair of TCI states to receive/monitor first (or second) PDCCH candidate(s).

Yet for another example, for N=2 or M=2, the UE 116 could use/apply the second indicated TCI state/pair of TCI states to receive/monitor first (or second) PDCCH candidate(s).

Yet for another example, for N=2 or M=2, the UE 116 could use/apply the first indicated TCI state/pair of TCI states to receive first PDCCH candidate(s) and the second indicated TCI state/pair of TCI states to receive second PDCCH candidate(s), e.g., at the same time or simultaneously or in one beam/TCI state indication/update instance.

Yet for another example, for N=2 or M=2, the UE 116 could use/apply the first indicated TCI state/pair of TCI states to receive second PDCCH candidate(s) and the second indicated TCI state/pair of TCI states to receive first PDCCH candidate(s), e.g., at the same time or simultaneously or in one beam/TCI state indication/update instance.

Yet for another example, for N=2 or M=2, the UE 116 could use/apply the first indicated TCI state/pair of TCI states to receive all PDCCH candidates and the second indicated TCI state/pair of TCI states to receive all PDCCH candidates, e.g., at the same time or simultaneously or in one beam/TCI state indication/update instance, when/if the PDCCH candidates are received in CORESET(s) associated/configured/activated with two active TCI states/pairs of TCI states.

Yet for another example, for N=2 or M=2, the UE 116 could use/apply the first indicated TCI state/pair of TCI states to receive all PDCCH candidates, the second indicated TCI state/pair of TCI states to receive all PDCCH candidates, the first indicated TCI state/pair of TCI states to receive all PDCCH candidates, and the second indicated TCI state/pair of TCI states to receive all PDCCH candidates—e.g., at the same time or simultaneously or in one beam/TCI state indication or update instance—when/if the PDCCH candidates are received in CORESET(s) associated/configured/activated with two active TCI states/pairs of TCI states.

Yet for another example, for N=2 or M=2, the UE 116 could use/apply the first indicated TCI state/pair of TCI states to receive all PDCCH candidates, the second indicated TCI state/pair of TCI states to receive all PDCCH candidates, and the first indicated TCI state/pair of TCI states to receive first PDCCH candidates and the second indicated TCI state/pair of TCI states to receive second PDCCH candidates—e.g., at the same time or simultaneously or in one beam/TCI state indication or update instance.

Yet for another example, for N=2 or M=2, the UE 116 could use/apply the first indicated TCI state/pair of TCI states to receive all PDCCH candidates, the second indicated TCI state/pair of TCI states to receive all PDCCH candidates, the first indicated TCI state/pair of TCI states to receive second PDCCH candidates, and the second indicated TCI state/pair of TCI states to receive first PDCCH candidates—e.g., at the same time or simultaneously or in one beam/TCI state indication or update instance.

Yet for another example, for N=2 or M=2, the UE 116 could use/apply the first indicated TCI state/pair of TCI states to receive first (or second) PDCCH candidates, the second indicated TCI state/pair of TCI states to receive first (or second) PDCCH candidates, the first indicated TCI state/pair of TCI states to receive first PDCCH candidates, and the second indicated TCI state/pair of TCI states to receive second PDCCH candidates—e.g., at the same time or simultaneously or in one beam/TCI state indication or update instance.

Yet for another example, for N=2 or M=2, the UE 116 could use/apply the first indicated TCI state/pair of TCI states to receive first (or second) PDCCH candidates, the second indicated TCI state/pair of TCI states to receive first (or second) PDCCH candidates, the first indicated TCI state/pair of TCI states to receive second PDCCH candidates, and the second indicated TCI state/pair of TCI states to receive first PDCCH candidates—e.g., at the same time or simultaneously or in one beam/TCI state indication or update instance.

Yet for another example, for N=2 or M=2, the UE 116 could use/apply the first indicated TCI state/pair of TCI states to receive first (or second) PDCCH candidates, the second indicated TCI state/pair of TCI states to receive first (or second) PDCCH candidates, the first indicated TCI state/pair of TCI states to receive all PDCCH candidates, and the second indicated TCI state/pair of TCI states to receive all PDCCH candidates—e.g., at the same time or simultaneously or in one beam/TCI state indication or update instance—when/if the PDCCH candidates are received in CORESET(s) associated/configured/activated with two active TCI states/pairs of TCI states.

For the described examples (e.g., one or more examples described herein), the first (or second) TCI state/pair of TCI states—when/if they are provided/indicated/configured, e.g., in form of their respective/corresponding TCI state ID(s), in the higher layer parameter, e.g., ControlResourceSet, as specified herein—could also be applied/used for PDCCH reception(s) by replacing the first (or second) indicated TCI state/pair of TCI states in the examples described herein.

In one embodiment, the UE 116 could follow one or more predefined rules to determine which indicated TCI state(s) to use/apply for receiving/monitoring PDCCH candidate(s), wherein the predefined rule(s) could be determined/defined/described as in one or more examples herein.

For instance, the UE 116 could first determine a first TCI state/pair of TCI states as the first TCI state/pair of TCI states in/of a TCI codepoint corresponding to the lowest (or highest) TCI codepoint among all first TCI codepoints activated/provided by the MAC CE command for beam indication/activation, e.g., the Unified TCI States Activation/Deactivation MAC CE or Enhanced Unified TCI States Activation/Deactivation MAC CE, and/or a second TCI state/pair of TCI states as the second TCI state/pair of TCI states in/of a TCI codepoint corresponding to the lowest (or highest) TCI codepoint among all the first TCI codepoints activated/provided by the MAC CE command for beam indication/activation, e.g., the Unified TCI States Activation/Deactivation MAC CE or Enhanced Unified TCI States Activation/Deactivation MAC CE, wherein more than one (e.g., 2) joint/DL/UL TCI states or more than one (e.g., 2) pairs of joint/DL/UL TCI states could be mapped to each of the first TCI codepoints described/specified herein in the present disclosure.

Alternatively, the UE 116 could first determine a first TCI state/pair of TCI states as the first TCI state/pair of TCI states in/of a TCI codepoint corresponding to the lowest (or highest) TCI codepoint among all second TCI codepoints activated/provided by the MAC CE command for beam indication/activation, e.g., the Unified TCI States Activation/Deactivation MAC CE or Enhanced Unified TCI States Activation/Deactivation MAC CE, and/or a second TCI state/pair of TCI states as the second TCI state/pair of TCI states in/of a TCI codepoint corresponding to the lowest (or highest) TCI codepoint among all the second TCI codepoints activated/provided by the MAC CE command for beam indication/activation, e.g., the Unified TCI States Activation/Deactivation MAC CE or Enhanced Unified TCI States Activation/Deactivation MAC CE, wherein a single (i.e., 1) joint/DL/UL TCI state or a single (i.e., 1) pair of joint/DL/UL TCI states could be mapped to each of the second TCI codepoints described/specified herein. Optionally, the UE 116 could first determine a first TCI state/pair of TCI states as the first TCI state/pair of TCI states in/of a TCI codepoint corresponding to the lowest (or highest) TCI codepoint among all the TCI codepoints activated/provided by the MAC CE command for beam indication/activation, e.g., the Unified TCI States Activation/Deactivation MAC CE or Enhanced Unified TCI States Activation/Deactivation MAC CE, and/or a second TCI state/pair of TCI states as the second TCI state/pair of TCI states in/of a TCI codepoint corresponding to the lowest (or highest) TCI codepoint among all the TCI codepoints activated/provided by the MAC CE command for beam indication/activation, e.g., the Unified TCI States Activation/Deactivation MAC CE or Enhanced Unified TCI States Activation/Deactivation MAC CE, wherein all the TCI codepoints activated/provided by the MAC CE command for beam indication/activation could comprise/include/contain/provide one or more first TCI codepoints and/or one or more second TCI codepoints described/specified herein.

For example, for N=2 or M=2, the UE 116 could use/apply the first indicated TCI state/pair of TCI states to receive/monitor all PDCCH candidates.

For another example, for N=2 or M=2, the UE 116 could use/apply the second indicated TCI state/pair of TCI states to receive/monitor all PDCCH candidates.

Yet for another example, for N=2 or M=2, the UE 116 could use/apply the first indicated TCI state/pair of TCI states to receive/monitor first (or second) PDCCH candidate(s).

Yet for another example, for N=2 or M=2, the UE 116 could use/apply the second indicated TCI state/pair of TCI states to receive/monitor first (or second) PDCCH candidate(s).

Yet for another example, for N=2 or M=2, the UE 116 could use/apply the first indicated TCI state/pair of TCI states to receive first PDCCH candidate(s) and the second indicated TCI state/pair of TCI states to receive second PDCCH candidate(s), e.g., at the same time or simultaneously or in one beam/TCI state indication/update instance.

Yet for another example, for N=2 or M=2, the UE 116 could use/apply the first indicated TCI state/pair of TCI states to receive second PDCCH candidate(s) and the second indicated TCI state/pair of TCI states to receive first PDCCH candidate(s), e.g., at the same time or simultaneously or in one beam/TCI state indication/update instance.

Yet for another example, for N=2 or M=2, the UE 116 could use/apply the first indicated TCI state/pair of TCI states to receive all PDCCH candidates and the second indicated TCI state/pair of TCI states to receive all PDCCH candidates, e.g., at the same time or simultaneously or in one beam/TCI state indication/update instance, when/if the PDCCH candidates are received in CORESET(s) associated/configured/activated with two active TCI states/pairs of TCI states.

Yet for another example, for N=2 or M=2, the UE 116 could use/apply the first indicated TCI state/pair of TCI states to receive all PDCCH candidates, the second indicated TCI state/pair of TCI states to receive all PDCCH candidates, the first indicated TCI state/pair of TCI states to receive all PDCCH candidates, and the second indicated TCI state/pair of TCI states to receive all PDCCH candidates—e.g., at the same time or simultaneously or in one beam/TCI state indication or update instance—when/if the PDCCH candidates are received in CORESET(s) associated/configured/activated with two active TCI states/pairs of TCI states.

Yet for another example, for N=2 or M=2, the UE 116 could use/apply the first indicated TCI state/pair of TCI states to receive all PDCCH candidates, the second indicated TCI state/pair of TCI states to receive all PDCCH candidates, the first indicated TCI state/pair of TCI states to receive first PDCCH candidates, and the second indicated TCI state/pair of TCI states to receive second PDCCH candidates—e.g., at the same time or simultaneously or in one beam/TCI state indication or update instance.

Yet for another example, for N=2 or M=2, the UE 116 could use/apply the first indicated TCI state/pair of TCI states to receive all PDCCH candidates, the second indicated TCI state/pair of TCI states to receive all PDCCH candidates, the first indicated TCI state/pair of TCI states to receive second PDCCH candidates, and the second indicated TCI state/pair of TCI states to receive first PDCCH candidates—e.g., at the same time or simultaneously or in one beam/TCI state indication or update instance.

Yet for another example, for N=2 or M=2, the UE 116 could use/apply the first indicated TCI state/pair of TCI states to receive first (or second) PDCCH candidates, the second indicated TCI state/pair of TCI states to receive first (or second) PDCCH candidates, the first indicated TCI state/pair of TCI states to receive first PDCCH candidates, and the second indicated TCI state/pair of TCI states to receive second PDCCH candidates—e.g., at the same time or simultaneously or in one beam/TCI state indication or update instance.

Yet for another example, for N=2 or M=2, the UE 116 could use/apply the first indicated TCI state/pair of TCI states to receive first (or second) PDCCH candidates, the second indicated TCI state/pair of TCI states to receive first (or second) PDCCH candidates, the first indicated TCI state/pair of TCI states to receive second PDCCH candidates, and the second indicated TCI state/pair of TCI states to receive first PDCCH candidates—e.g., at the same time or simultaneously or in one beam/TCI state indication or update instance.

Yet for another example, for N=2 or M=2, the UE 116 could use/apply the first indicated TCI state/pair of TCI states to receive first (or second) PDCCH candidates, the second indicated TCI state/pair of TCI states to receive first (or second) PDCCH candidates, the first indicated TCI state/pair of TCI states to receive all PDCCH candidates, and the second indicated TCI state/pair of TCI states to receive all PDCCH candidates—e.g., at the same time or simultaneously or in one beam/TCI state indication or update instance—when/if the PDCCH candidates are received in CORESET(s) associated/configured/activated with two active TCI states/pairs of TCI states.

For the described examples (e.g., one or more examples described herein), the first (or second) TCI state/pair of TCI states—when/if they are provided/indicated/configured, e.g., in form of their respective/corresponding TCI state ID(s), in the higher layer parameter, e.g., ControlResourceSet, as specified herein—could also be applied/used for PDCCH reception(s) by replacing the first (or second) indicated TCI state/pair of TCI states in the descriptions.

In the present disclosure, when/if the indicator/parameter provided in the higher layer parameter ControlResourceSet that configures the CORESET, as specified herein, is (i) absent/not present or not configured, set to (ii) ‘none’ or ‘disabled’ or ‘off’ or ‘not present’/‘absent’ or ‘not configured’, and/or (iii) a predetermined value ‘0’, ‘1’, ‘00’, ‘01’, ‘10’ or ‘11’ that is designated for indicating that none of the indicated TCI states/pairs of TCI states could be used/applied for PDCCH reception(s) in the CORESET, examples are discussed herein.

For example, the UE 116 could follow one or more of the fixed rules as specified in one or more examples described herein to determine which of the indicated TCI state(s)/pair(s) of TCI states to use/apply for PDCCH reception(s).

For another example, the UE 116 could follow one or more of the predefined rules as specified in one or more examples described herein to determine which of the indicated TCI state(s)/pair(s) of TCI states to use/apply for PDCCH reception(s).

Yet for another example, the UE 116 could follow the indicator/parameter provided in the higher layer parameter ControlResourceSet that configures a CORESET, as specified herein—e.g., following one or more examples described herein, to determine which of the indicated TCI state(s)/pair(s) of TCI states to use/apply for PDCCH reception(s), wherein the CORESET could be the latest CORESET received in time and/or the indicator/parameter provided in the higher layer parameter ControlResourceSet that configures the CORESET, as specified herein—e.g., following one or more examples described herein, is present/configured or set to ‘enabled’/′ on′ and/or value(s) of ‘0’, ‘1’, ‘00’, ‘01’, ‘10’ or ‘11’.

Yet for another example, the UE 116 could use/apply one or more of the indicated TCI states/pairs of TCI states, e.g., in the beam indication/activation MAC CE (e.g., the Unified TCI States Activation/Deactivation MAC CE or Enhanced Unified TCI States Activation/Deactivation MAC CE) or by one or more TCI codepoints of one or more (existing) TCI fields in the beam indication DCI (e.g., DCI format 1_1/1_2 with or without DL assignment), for PDCCH reception(s), as specified herein.

In the present disclosure, CORESET(s) associated/configured with the indicator/parameter in the corresponding ControlResourceSet set to ‘0’ (or ‘1’, ‘00’, ‘01’, ‘10’, or ‘11’) could correspond to UE specific search space (USS) CORESET(s) or vice versa, and/or CORESET(s) associated/configured with the indicator/parameter in the corresponding ControlResourceSet set to ‘1’ (or ‘0’, ‘00’, ‘01’, ‘10’, or ‘11’) could correspond to common search space (CSS) CORESET(s) or vice versa. Furthermore, throughout the present disclosure, a scheduling DCI or a beam indication DCI could be a DCI format 1_0, 1_1 and/or 1_2. A beam indication DCI could be with or without DL assignment.

Throughout the present disclosure, a CORESET could correspond to a CORESET other than CORESET with index 0 (or CORESET #0) associated with only UE-dedicated PDCCH reception(s) in a CC, comprising, e.g., CORESET(s) associated with USS set(s) or Type3-PDCCH CSS set(s), a CORESET other than CORESET #0 associated with only non-UE-dedicated PDCCH reception(s) in a CC, comprising, e.g., CORESET(s) associated with all types of CSS sets such as Type0/0A/1/2/3-PDCCH CSS sets or CSS sets other than Type3-PDCCH CSS set(s) such as Type0/0A/1/2-PDCCH CSS sets, a CORESET other than CORESET #0 associated with both UE-dedicated and non-UE-dedicated PDCCH receptions in a CC, or CORESET with index 0. Additionally, a CORESET could be (higher layer) configured with ‘followUnifiedTCIstate’ in their corresponding/respective ControlResourceSet.

Alternatively, a CORESET may not be (higher layer) configured with ‘followUnifiedTCIstate’ in their corresponding/respective ControlResourceSet. Furthermore, a CORESET could be (higher layer) configured with a CORESET pool index (e.g., CORESETPoolIndex value 0 or 1) or a CORESET group index (e.g., CORESETGroupIndex value 0 or 1) in their corresponding/respective ControlResourceSet.

In the present disclosure, the UE 116 could be provided/configured/indicated by the network 130, in a higher layer parameter, e.g., ControlResourceSet, an indicator/parameter to indicate the association between one or more of the indicated TCI states/pairs of TCI states and the corresponding PDSCH reception(s). For this case, the UE 116 could follow the indicator/parameter provided/configured/indicated in ControlResourceSet that configures a CORESET to determine which one or more of the indicated TCI states/pairs of TCI states to use/apply to receive PDSCH(s), e.g., scheduled by PDCCH(s)/DCI(s) received in the CORESET.

Furthermore, the UE 116 could follow one or more examples described herein to determine which one or more of the indicated TCI states/pairs of TCI states to use/apply for PDSCH reception(s) by replacing the indicator/parameter provided/configured/indicated in PDSCH-Config with the indicator/parameter provided/configured/indicated in ControlResourceSet described herein.

In the present disclosure, the first PDCCH(s)/PDCCH candidate(s) and/or the second PDCCH(s)/PDCCH candidate(s) could correspond to or could be determined according to one or more examples described herein.

In one example, the first PDCCH(s)/PDCCH candidate(s) and the second PDCCH(s)/PDCCH candidate(s) could be the same/identical. For this case, the first PDCCH(s)/PDCCH candidate(s) and the second PDCCH(s)/PDCCH candidate(s) could be received in the same CORESET associated/configured with more than one (e.g., two) active/activated TCI states/pairs of TCI states.

In another example, the first PDCCH(s)/PDCCH candidate(s) and the second PDCCH(s)/PDCCH candidate(s) could be received in search space sets/CORESETs that are higher layer linked, e.g., via a higher layer parameter SearchSpaceLinking.

In yet another example, the first (or second) PDCCH(s)/PDCCH candidate(s) could be received in a CORESET associated/configured with more than one (e.g., two) active/activated TCI states/pairs of TCI states, and the second (or first) PDCCH(s)/PDCCH candidate(s) could be received in a search space set/CORESET higher layer configured with a higher layer parameter SearchSpaceLinking.

In yet another example, the first PDCCH(s)/PDCCH candidate(s) could be received in CORESET(s) in a first CORESET group, while the second PDCCH(s)/PDCCH candidate(s) could be received in CORESET(s) in a second CORESET group. The first CORESET group could comprise/contain/include one or more CORESETs associated/configured with the same indicator/parameter in their respective ControlResourceSet as described/specified herein and the second CORESET group could comprise/contain/include one or more CORESETs associated/configured with the same indicator/parameter in their respective ControlResourceSet as described/specified herein. The indicators/parameters provided/indicated/configured in ControlResourceSet for the first and second CORESET groups could be identical or different.

Alternatively, the first CORESET group could comprise/include/contain UE specific search space (USS) CORESET(s) and/or the second CORESET group could comprise/include/contain common search space (CSS) CORESET(s). Optionally, the first CORESET group could comprise/include/contain CSS CORESET(s) and/or the second CORESET group could comprise/include/contain USS CORESET(s).

In one embodiment, the UE 116 could be provided/configured/indicated by the network 130, in a higher layer parameter, e.g., PDSCH-Config, an indicator/parameter to indicate the association between one or more of the indicated TCI states and the corresponding PDSCH reception(s).

Alternatively, the UE 116 could be provided/indicated/configured by the network 130, in a higher layer parameter, e.g., PDSCH-Config, one or more TCI states/TCI state IDs (e.g., a first TCI state/TCI state ID, a first pair of TCI states/TCI state IDs, a second TCI state/TCI state ID, and/or a second pair of TCI states/TCI state IDs for N=2 or M=2) for PDSCH reception(s). In the present disclosure, the UE 116 could be provided/indicated/configured/informed by the network 130, e.g., via higher layer RRC signaling and/or MAC CE command and/or dynamic DCI based signaling, that the indicator/parameter provided/indicated/configured in the higher layer parameter, e.g., PDSCH-Config, as specified herein, and/or the TCI state(s)/TCI state ID(s), provided/indicated/configured in the higher layer parameter, e.g., PDSCH-Config, as specified herein, could be used/applied for PDSCH reception(s). For instance, the UE 116 could be provided/indicated/configured/informed by the network 130, e.g., a higher layer parameter ‘beamAssociationPDSCH’, in a higher layer parameter, e.g., PDCCH-Config/PDSCH-Config/ControlResourceSet/etc. For this case, when/if the higher layer parameter ‘beamAssociationPDSCH’ is present/configured or set to ‘enabled’/‘on’, the indicator/parameter provided/indicated/configured in the higher layer parameter, e.g., PDSCH-Config, as specified herein, and/or the TCI state(s)/TCI state ID(s), provided/indicated/configured in the higher layer parameter, e.g., PDSCH-Config, as specified herein, could be used/applied for PDSCH reception(s). Otherwise, i.e., when/if the higher layer parameter ‘beamAssociationPDSCH’ is absent/not present/not configured or set to ‘disabled’/‘off’, the indicator/parameter provided/indicated/configured in the higher layer parameter, e.g., PDSCH-Config, as specified herein, and/or the TCI state(s)/TCI state ID(s), provided/indicated/configured in the higher layer parameter, e.g., PDSCH-Config, as specified herein, could be used/applied for receiving channels/signals (such as PDCCH, CSI-RS) other than PDSCH.

For example, for N=2 or M=2, the indicator could be a one-bit indicator with ‘0’ (or ‘1’) indicating that the first indicated TCI state/pairs of TCI states could be applied/used for receiving first (or second) PDSCH(s) and with ‘1’ (or ‘0’) indicating that the second indicated TCI state/pairs of TCI states could be applied/used for receiving second (or first) PDSCH(s). Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator/parameter, e.g., in PDSCH-Config.

For another example, for N=2 or M=2, the indicator could be a one-bit indicator with ‘0’ (or ‘1’) indicating that the first indicated TCI state/pairs of TCI states could be applied/used for receiving first PDSCH DM-RS(s) (or equivalently, the RS(s) in the RS set(s) provided in the first indicated TCI state/pair of TCI states could be quasi-co-located (QCL'ed) with first DM-RS antenna port(s) for PDSCH reception(s)), the second indicated TCI state/pairs of TCI states could be applied/used for receiving second PDSCH DM-RS(s) (or equivalently, the RS(s) in the RS set(s) provided in the second indicated TCI state/pair of TCI states could be QCL'ed with second DM-RS antenna port(s) for PDSCH reception(s)), with ‘1’ (or ‘0’) indicating that the first indicated TCI state/pairs of TCI states could be applied/used for receiving the second PDSCH DM-RS(s) (or equivalently, the RS(s) in the RS set(s) provided in the first indicated TCI state/pair of TCI states could be QCL'ed with the second DM-RS antenna port(s) for PDSCH reception(s)), and the second indicated TCI state/pairs of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)). Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator/parameter, e.g., in PDSCH-Config.

Yet for another example, for N=2 or M=2, the indicator could be a 2-bit indicator with ‘00’ (‘01’, ‘10’, or ‘11’) indicating that the first indicated TCI state/pairs of TCI states could be applied/used for receiving the first (or second) PDSCH(s), with ‘01’ (‘00’, ‘10’, or ‘11’) indicating that the second indicated TCI state/pairs of TCI states could be applied/used for receiving the second (or first) PDSCH(s), with ‘10’ (‘00’, ‘01’, or ‘11’) indicating that the first indicated TCI state/pairs of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), the second indicated TCI state/pairs of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), with ‘11’ (‘00’, ‘01’, or ‘10’) indicating that the first indicated TCI state/pairs of TCI states could be applied/used for receiving the second PDSCH DM-RS(s) (or equivalently, the RS(s) in the RS set(s) provided in the first indicated TCI state/pair of TCI states could be QCL'ed with the second DM-RS antenna port(s) for PDSCH reception(s)), and the second indicated TCI state/pairs of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)). Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator/parameter, e.g., in PDSCH-Config.

Yet for another example, the UE 116 could be provided/configured/indicated by the network 130, in a higher layer parameter, e.g., PDSCH-Config, a single indicator/parameter to indicate the association between one or more of the indicated TCI states and the corresponding PDSCH reception(s).

Alternatively, the UE 116 could be provided/indicated/configured by the network 130, in a higher layer parameter, e.g., PDSCH-Config, one or more TCI states/TCI state IDs (e.g., a first TCI state/TCI state ID, a first pair of TCI states/TCI state IDs, a second TCI state/TCI state ID, and/or a second pair of TCI states/TCI state IDs for N=2 or M=2) for PDSCH reception(s).

In the present disclosure, the UE 116 could be provided/indicated/configured/informed by the network 130, e.g., via higher layer RRC signaling and/or MAC CE command and/or dynamic DCI based signaling, that the indicator/parameter provided/indicated/configured in the higher layer parameter, e.g., PDSCH-Config, as specified herein, and/or the TCI state(s)/TCI state ID(s), provided/indicated/configured in the higher layer parameter, e.g., PDSCH-Config, as specified herein, could be used/applied for PDSCH reception(s). For instance, the UE 116 could be provided/indicated/configured/informed by the network 130, e.g., a higher layer parameter ‘beamAssociationPDSCH’, in a higher layer parameter, e.g., PDCCH-Config/PDSCH-Config/ControlResourceSet/etc. For this case, when/if the higher layer parameter ‘beamAssociationPDSCH’ is present/configured or set to ‘enabled’/‘on’, the indicator/parameter provided/indicated/configured in the higher layer parameter, e.g., PDSCH-Config, as specified herein and/or the TCI state(s)/TCI state ID(s), provided/indicated/configured in the higher layer parameter, e.g., PDSCH-Config, as specified herein, could be used/applied for PDSCH reception(s). Otherwise, i.e., when/if the higher layer parameter ‘beamAssociationPDSCH’ is absent/not present/not configured or set to ‘disabled’/‘off’, the indicator/parameter provided/indicated/configured in the higher layer parameter, e.g., PDSCH-Config, as specified herein, and/or the TCI state(s)/TCI state ID(s), provided/indicated/configured in the higher layer parameter, e.g., PDSCH-Config, as specified herein, could be used/applied for receiving channels/signals (such as PDCCH, CSI-RS) other than PDSCH.

For example, for N=2 or M=2, the indicator could be a one-bit indicator with ‘0’ (or ‘1’) indicating that the first indicated TCI state/pair of TCI states could be applied/used for receiving first (or second) PDSCH(s) and with ‘1’ (or ‘0’) indicating that the second indicated TCI state/pair of TCI states could be applied/used for receiving second (or first) PDSCH(s). Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator/parameter, e.g., in PDSCH-Config.

For another example, for N=2 or M=2, the indicator could be a one-bit indicator with ‘0’ (or ‘1’) indicating that the first indicated TCI state/pair of TCI states could be applied/used for receiving first PDSCH(s), the second indicated TCI state/pair of TCI states could be applied/used for receiving second PDSCH(s), with ‘1’ (or ‘0’) indicating that the first indicated TCI state/pair of TCI states could be applied/used for receiving second PDSCH(s), and the second indicated TCI state/pair of TCI states could be applied/used for receiving first PDSCH(s). Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator/parameter, e.g., in PDSCH-Config.

Yet for another example, for N=2 or M=2, the indicator could be a one-bit indicator with ‘0’ (or ‘1’) indicating that the first indicated TCI state/pair of TCI states could be applied/used for receiving first (or second) PDSCH DM-RS(s) in the first (or second) DM-RS code division multiplexing (CDM) group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first (or second) DM-RS antenna port(s) in the first (or second) DM-RS CDM group indicated by the antenna ports field in the DCI for PDSCH reception(s) and ‘1’ (or ‘0’) indicating that the second indicated TCI state/pair of TCI states could be applied/used for receiving second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with second (or first) DM-RS antenna port(s) in the second (or first) DM-RS CDM group indicated by the antenna ports field in the DCI for PDSCH reception(s). Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator/parameter, e.g., in PDSCH-Config.

Yet for another example, for N=2 or M=2, the indicator could be a one-bit indicator with ‘0’ (or ‘1’) indicating that the first indicated TCI state/pair of TCI states could be applied/used for receiving first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first DM-RS antenna port(s) in the first DM-RS CDM group indicated by the antenna ports field in the DCI for PDSCH reception(s) and the second indicated TCI state/pair of TCI states could be applied/used for receiving second PDSCH DM-RS(s) in the second DM-RS CDM group indicated by the antenna ports field in the DCI. Equivalently, the RS(s) in the RS set(s) provided in the second indicated TCI state/pair of TCI states could be quasi-co-located (QCL'ed) with second DM-RS antenna port(s) in the second DM-RS CDM group indicated by the antenna ports field in the DCI for PDSCH reception(s) and with ‘1’ (or ‘0’) indicating that the first indicated TCI state/pair of TCI states could be applied/used for receiving second PDSCH DM-RS(s) in the second DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with second DM-RS antenna port(s) in the second DM-RS CDM group indicated by the antenna ports field in the DCI for PDSCH reception(s) and the second indicated TCI state/pair of TCI states could be applied/used for receiving first PDSCH DM-RS(s) in the first DM-RS CDM group indicated by the antenna ports field in the DCI. Equivalently, the RS(s) in the RS set(s) provided in the second indicated TCI state/pair of TCI states could be quasi-co-located (QCL'ed) with first DM-RS antenna port(s) in the first DM-RS CDM group indicated by the antenna ports field in the DCI for PDSCH reception(s). Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator/parameter, e.g., in PDSCH-Config.

Yet for another example, for N=2 or M=2, the indicator could be a one-bit indicator with ‘0’ (or ‘1’) indicating that the first indicated TCI state/pair of TCI states could be applied/used for receiving first PDSCH DM-RS(s) (or equivalently, the RS(s) in the RS set(s) provided in the first indicated TCI state/pair of TCI states could be quasi-co-located (QCL'ed) with first DM-RS antenna port(s) for PDSCH reception(s)) the second indicated TCI state/pair of TCI states could be applied/used for receiving second PDSCH DM-RS(s) (or equivalently, the RS(s) in the RS set(s) provided in the second indicated TCI state/pair of TCI states could be QCL'ed with second DM-RS antenna port(s) for PDSCH reception(s)), with ‘1’ (or ‘0’) indicating that the first indicated TCI state/pair of TCI states could be applied/used for receiving the second PDSCH DM-RS(s) (or equivalently, the RS(s) in the RS set(s) provided in the first indicated TCI state/pair of TCI states could be QCL'ed with the second DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)). Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator/parameter, e.g., in PDSCH-Config.

Yet for another example, for N=2 or M=2, the indicator could be a 2-bit indicator with ‘00’ (‘01’, ‘10’, or ‘11’) indicating that the first indicated TCI state/pair of TCI states could be applied/used for receiving first (or second) PDSCH(s), with ‘01’ (‘00’, ‘10’, or ‘11’) indicating that the second indicated TCI state/pair of TCI states could be applied/used for receiving second (or first) PDSCH(s), with ‘10’ (‘00’, ‘01’, or ‘11’) indicating that the first indicated TCI state/pair of TCI states could be applied/used for receiving first PDSCH(s) and the second indicated TCI state/pair of TCI states could be applied/used for receiving second PDSCH(s), with ‘11’ (‘00’, ‘01’, or ‘10’) indicating that the first indicated TCI state/pair of TCI states could be applied/used for receiving second PDSCH(s), and the second indicated TCI state/pair of TCI states could be applied/used for receiving first PDSCH(s). The value(s) ‘00’ or ‘01’ or ‘10’ or ‘11’ of the indicator could also be reserved or set to ‘reserved’. Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator/parameter, e.g., in PDSCH-Config.

Yet for another example, for N=2 or M=2, the indicator could be a 2-bit indicator with ‘00’ (‘01’, ‘10’, or ‘11’) indicating that the first indicated TCI state/pair of TCI states could be applied/used for receiving first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first (or second) DM-RS antenna port(s) in the first (or second) DM-RS CDM group indicated by the antenna ports field in the DCI for PDSCH reception(s) with ‘01’ (‘00’, ‘10’ or ‘11’) indicating that the second indicated TCI state/pair of TCI states could be applied/used for receiving second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with second (or first) DM-RS antenna port(s) in the second (or first) DM-RS CDM group indicated by the antenna ports field in the DCI for PDSCH reception(s), with ‘10’ (‘00’, ‘01’, or ‘11’) indicating that the first indicated TCI state/pair of TCI states could be applied/used for receiving first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first DM-RS antenna port(s) in the first DM-RS CDM group indicated by the antenna ports field in the DCI for PDSCH reception(s) and the second indicated TCI state/pair of TCI states could be applied/used for receiving second PDSCH DM-RS(s) in the second DM-RS CDM group indicated by the antenna ports field in the DCI. Equivalently, the RS(s) in the RS set(s) provided in the second indicated TCI state/pair of TCI states could be quasi-co-located (QCL'ed) with second DM-RS antenna port(s) in the second DM-RS CDM group indicated by the antenna ports field in the DCI for PDSCH reception(s), and with ‘11’ (‘00’, ‘01’, or ‘10’) indicating that the first indicated TCI state/pair of TCI states could be applied/used for receiving second PDSCH DM-RS(s) in the second DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with second DM-RS antenna port(s) in the second DM-RS CDM group indicated by the antenna ports field in the DCI for PDSCH reception(s) and the second indicated TCI state/pair of TCI states could be applied/used for receiving first PDSCH DM-RS(s) in the first DM-RS CDM group indicated by the antenna ports field in the DCI. Equivalently, the RS(s) in the RS set(s) provided in the second indicated TCI state/pair of TCI states could be quasi-co-located (QCL'ed) with first DM-RS antenna port(s) in the first DM-RS CDM group indicated by the antenna ports field in the DCI for PDSCH reception(s). The value(s) ‘00’ or ‘01’ or ‘10’ or ‘11’ of the indicator could also be reserved or set to ‘reserved’. Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator/parameter, e.g., in PDSCH-Config.

Yet for another example, for N=2 or M=2, the indicator could be a 2-bit indicator with ‘00’ (‘01’, ‘10’, or ‘11’) indicating that the first indicated TCI state/pair of TCI states could be applied/used for receiving the first (or second) PDSCH(s), with ‘01’ (‘00’, ‘10’, or ‘11’) indicating that the second indicated TCI state/pair of TCI states could be applied/used for receiving the second (or first) PDSCH(s), with ‘10’ (‘00’, ‘01’, or ‘11’) indicating that the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), with ‘11’ (‘00’, ‘01’, or ‘10’) indicating that the first indicated TCI state/pair of TCI states could be applied/used for receiving the second PDSCH DM-RS(s) (or equivalently, the RS(s) in the RS set(s) provided in the first indicated TCI state/pair of TCI states could be QCL'ed with the second DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)). The value(s) ‘00’ or ‘01’ or ‘10’ or ‘11’ of the indicator could also be reserved or set to ‘reserved’. Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator/parameter, e.g., in PDSCH-Config.

Yet for another example, for N=2 or M=2, the indicator could be a 2-bit indicator with ‘00’ (‘01’, ‘10’, or ‘11’) indicating that the first indicated TCI state/pair of TCI states could be applied/used for receiving first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first (or second) DM-RS antenna port(s) in the first (or second) DM-RS CDM group indicated by the antenna ports field in the DCI for PDSCH reception(s), with ‘01’ (‘00’, ‘10’, or ‘11’) indicating that the second indicated TCI state/pair of TCI states could be applied/used for receiving second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with second (or first) DM-RS antenna port(s) in the second (or first) DM-RS CDM group indicated by the antenna ports field in the DCI for PDSCH reception(s), with ‘10’ (‘00’, ‘01’, or ‘11’) indicating that the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), with ‘11’ (‘00’, ‘01’ or ‘10’) indicating that the first indicated TCI state/pair of TCI states could be applied/used for receiving the second PDSCH DM-RS(s) (or equivalently, the RS(s) in the RS set(s) provided in the first indicated TCI state/pair of TCI states could be QCL'ed with the second DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)). The value(s) ‘00’ or ‘01’ or ‘10’ or ‘11’ of the indicator could also be reserved or set to ‘reserved’. Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator/parameter, e.g., in PDSCH-Config.

Yet for another example, the UE 116 could be provided/configured/indicated by the network 130, in a higher layer parameter, e.g., PDSCH-Config, more than one (e.g., 2) indicators/parameters—e.g., the first indicator/parameter, the second indicator/parameter and so on—to indicate the association between one or more of the indicated TCI states and the corresponding PDSCH reception(s).

Alternatively, the UE 116 could be provided/indicated/configured by the network 130, in a higher layer parameter, e.g., PDSCH-Config, one or more TCI states/TCI state IDs (e.g., a first TCI state/TCI state ID, a first pair of TCI states/TCI state IDs, a second TCI state/TCI state ID, and/or a second pair of TCI states/TCI state IDs for N=2 or M=2) for PDSCH reception(s). In the present disclosure, the UE 116 could be provided/indicated/configured/informed by the network 130, e.g., via higher layer RRC signaling and/or MAC CE command and/or dynamic DCI based signaling, that the indicators/parameters provided/indicated/configured in the higher layer parameter, e.g., PDSCH-Config, as specified herein, and/or the TCI state(s)/TCI state ID(s), provided/indicated/configured in the higher layer parameter, e.g., PDSCH-Config, as specified herein, could be used/applied for PDSCH reception(s). For instance, the UE 116 could be provided/indicated/configured/informed by the network 130, e.g., a higher layer parameter ‘beamAssociationPDSCH’, in a higher layer parameter, e.g., PDCCH-Config/PDSCH-Config/ControlResourceSet/etc. For this case, when/if the higher layer parameter ‘beamAssociationPDSCH’ is present/configured or set to ‘enabled’/‘on’, the indicators/parameters provided/indicated/configured in the higher layer parameter, e.g., PDSCH-Config, as specified herein, and/or the TCI state(s)/TCI state ID(s), provided/indicated/configured in the higher layer parameter, e.g., PDSCH-Config, as specified herein, could be used/applied for PDSCH reception(s). Otherwise, i.e., when/if the higher layer parameter ‘beamAssociationPDSCH’ is absent/not present/not configured or set to ‘disabled’/‘off’, the indicators/parameters provided/indicated/configured in the higher layer parameter, e.g., PDSCH-Config, as specified herein, and/or the TCI state(s)/TCI state ID(s), provided/indicated/configured in the higher layer parameter, e.g., PDSCH-Config, as specified herein, could be used/applied for receiving channels/signals (such as PDCCH, CSI-RS) other than PDSCH. For the first (or second) indicator/parameter or the first (or second) TCI state/pair of TCI states—in form of their respective/corresponding TCI state ID(s), when/if they are provided/indicated/configured in the higher layer parameter, e.g., PDSCH-Config, as specified herein.

For example, for N=2 or M=2, the first (or second) indicator/parameter could be a one-bit indicator and associated to first PDSCH(s) with ‘0’ (or ‘1’) indicating that the first indicated TCI state/pair of TCI states could be applied/used for receiving first PDSCH(s), and with ‘1’ (or ‘0’) indicating that the second indicated TCI state/pair of TCI states could be applied/used for receiving second PDSCH(s). Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator(s)/parameter(s), e.g., in PDSCH-Config.

For another example, for N=2 or M=2, the first (or second) indicator/parameter could be a one-bit indicator and associated to first PDSCH(s) with ‘0’ (or ‘1’) indicating that the first indicated TCI state/pair of TCI states could be applied/used for receiving first PDSCH(s) and the second indicated TCI state/pair of TCI states could be applied/used for receiving first PDSCH(s), and with ‘1’ (or ‘0’) indicating that the first indicated TCI state/pair of TCI states could be applied/used for receiving first PDSCH(s) and the second indicated TCI state/pair of TCI states could be applied/used for receiving first PDSCH(s). Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator(s)/parameter(s), e.g., in PDSCH-Config.

Yet for another example, for N=2 or M=2, the first (or second) indicator/parameter could be a one-bit indicator and associate to first PDSCH DM-RS(s) in the first DM-RS CDM group indicated by the antenna ports field in a DCI (e.g., the scheduling DCI or the beam indication DCI with or without DL assignment) with ‘0’ (or ‘1’) indicating that the first indicated TCI state/pair of TCI states could be applied/used for receiving first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first DM-RS antenna port(s) in the first DM-RS CDM group indicated by the antenna ports field in the DCI for PDSCH reception(s) and ‘1’ (or ‘0’) indicating that the second indicated TCI state/pair of TCI states could be applied/used for receiving first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with first DM-RS antenna port(s) in the first DM-RS CDM group indicated by the antenna ports field in the DCI for PDSCH reception(s). Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator(s)/parameter(s), e.g., in PDSCH-Config.

Yet for another example, for N=2 or M=2, the first (or second) indicator/parameter could be a one-bit indicator and associate to first PDSCH DM-RS(s) in the first DM-RS CDM group indicated by the antenna ports field in a DCI (e.g., the scheduling DCI or the beam indication DCI with or without DL assignment) with ‘0’ (or ‘1’) indicating that the first indicated TCI state/pair of TCI states could be applied/used for receiving first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first DM-RS antenna port(s) in the first DM-RS CDM group indicated by the antenna ports field in the DCI for PDSCH reception(s) and the second indicated TCI state/pair of TCI states could be applied/used for receiving first PDSCH DM-RS(s) in the first DM-RS CDM group indicated by the antenna ports field in the DCI. Equivalently, the RS(s) in the RS set(s) provided in the second indicated TCI state/pair of TCI states could be quasi-co-located (QCL'ed) with first DM-RS antenna port(s) in the first DM-RS CDM group indicated by the antenna ports field in the DCI for PDSCH reception(s) and with ‘1’ (or ‘0’) indicating that the first indicated TCI state/pair of TCI states could be applied/used for receiving first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first DM-RS antenna port(s) in the first DM-RS CDM group indicated by the antenna ports field in the DCI for PDSCH reception(s) and the second indicated TCI state/pair of TCI states could be applied/used for receiving first PDSCH DM-RS(s) in the first DM-RS CDM group indicated by the antenna ports field in the DCI. Equivalently, the RS(s) in the RS set(s) provided in the second indicated TCI state/pair of TCI states could be quasi-co-located (QCL'ed) with first DM-RS antenna port(s) in the first DM-RS CDM group indicated by the antenna ports field in the DCI for PDSCH reception(s). Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator(s)/parameter(s), e.g., in PDSCH-Config.

Yet for another example, for N=2 or M=2, the first (or second) indicator/parameter could be a one-bit indicator and associated to first PDSCH DM-RS(s) or first DM-RS antenna port(s) for PDSCH reception(s) with ‘0’ (or ‘1’) indicating that the first indicated TCI state/pair of TCI states could be applied/used for receiving first PDSCH DM-RS(s) (or equivalently, the RS(s) in the RS set(s) provided in the first indicated TCI state/pair of TCI states could be quasi-co-located (QCL'ed) with first DM-RS antenna port(s) for PDSCH reception(s)), the second indicated TCI state/pair of TCI states could be applied/used for receiving first PDSCH DM-RS(s) (or equivalently, the RS(s) in the RS set(s) provided in the second indicated TCI state/pair of TCI states could be QCL'ed with first DM-RS antenna port(s) for PDSCH reception(s)), with ‘1’ (or ‘0’) indicating that the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)). Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator(s)/parameter(s), e.g., in PDSCH-Config.

Yet for another example, for N=2 or M=2, the first (or second) indicator/parameter could be a 2-bit indicator associated to first PDSCH(s) with ‘00’ (‘01’, ‘10’, or ‘11’) indicating that the first indicated TCI state/pair of TCI states could be applied/used for receiving first PDSCH(s), with ‘01’ (‘00’, ‘10’, or ‘11’) indicating that the second indicated TCI state/pair of TCI states could be applied/used for receiving first PDSCH(s), with ‘10’ (‘00’, ‘01’, or ‘11’) indicating that the first indicated TCI state/pair of TCI states could be applied/used for receiving first PDSCH(s), the second indicated TCI state/pair of TCI states could be applied/used for receiving first PDSCH(s), with ‘11’ (‘00’, ‘01’, or ‘10’) indicating that the first indicated TCI state/pair of TCI states could be applied/used for receiving first PDSCH(s), and the second indicated TCI state/pair of TCI states could be applied/used for receiving first PDSCH(s). The value(s) ‘00’ or ‘01’ or ‘10’ or ‘11’ of the indicator could also be reserved or set to ‘reserved’. Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator(s)/parameter(s), e.g., in PDSCH-Config.

Yet for another example, for N=2 or M=2, the first (or second) indicator/parameter could be a 2-bit indicator associate to first PDSCH DM-RS(s) in the first DM-RS CDM group indicated by the antenna ports field in a DCI (e.g., the scheduling DCI or the beam indication DCI with or without DL assignment) with ‘00’ (‘01’, ‘10’, or ‘11’) indicating that the first indicated TCI state/pair of TCI states could be applied/used for receiving first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first DM-RS antenna port(s) in the first DM-RS CDM group indicated by the antenna ports field in the DCI for PDSCH reception(s), with ‘01’ (‘00’, ‘10’, or ‘11’) indicating that the second indicated TCI state/pair of TCI states could be applied/used for receiving first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with first DM-RS antenna port(s) in the first DM-RS CDM group indicated by the antenna ports field in the DCI for PDSCH reception(s), with ‘10’ (‘00’, ‘01’, or ‘11’) indicating that the first indicated TCI state/pair of TCI states could be applied/used for receiving first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first DM-RS antenna port(s) in the first DM-RS CDM group indicated by the antenna ports field in the DCI for PDSCH reception(s) and the second indicated TCI state/pair of TCI states could be applied/used for receiving first PDSCH DM-RS(s) in the first DM-RS CDM group indicated by the antenna ports field in the DCI. Equivalently, the RS(s) in the RS set(s) provided in the second indicated TCI state/pair of TCI states could be quasi-co-located (QCL'ed) with first DM-RS antenna port(s) in the first DM-RS CDM group indicated by the antenna ports field in the DCI for PDSCH reception(s) and with ‘11’ (‘00’, ‘01’ or ‘10’) indicating that the first indicated TCI state/pair of TCI states could be applied/used for receiving first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first DM-RS antenna port(s) in the first DM-RS CDM group indicated by the antenna ports field in the DCI for PDSCH reception(s) and the second indicated TCI state/pair of TCI states could be applied/used for receiving first PDSCH DM-RS(s) in the first DM-RS CDM group indicated by the antenna ports field in the DCI. Equivalently, the RS(s) in the RS set(s) provided in the second indicated TCI state/pair of TCI states could be quasi-co-located (QCL'ed) with first DM-RS antenna port(s) in the first DM-RS CDM group indicated by the antenna ports field in the DCI for PDSCH reception(s). The value(s) ‘00’ or ‘01’ or ‘10’ or ‘11’ of the indicator could also be reserved or set to ‘reserved’. Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator(s)/parameter(s), e.g., in PDSCH-Config.

Yet for another example, for N=2 or M=2, the first (or second) indicator/parameter could be a 2-bit indicator and associated to first PDSCH(s) and/or first PDSCH DM-RS(s) or first DM-RS antenna port(s) for PDSCH reception(s) with ‘00’ (‘01’, ‘10’, or ‘11’) indicating that the first indicated TCI state/pair of TCI states could be applied/used for receiving the first PDSCH(s), with ‘01’ (‘00’, ‘10’, or ‘11’) indicating that the second indicated TCI state/pair of TCI states could be applied/used for receiving the first PDSCH(s), with ‘10’ (‘00’, ‘01’, or ‘11’) indicating that the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)), with ‘11’ (‘00’, ‘01’ or ‘10’) indicating that the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)). The value(s) ‘00’ or ‘01’ or ‘10’ or ‘11’ of the indicator could also be reserved or set to ‘reserved’. Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator(s)/parameter(s), e.g., in PDSCH-Config.

Yet for another example, for N=2 or M=2, the first (or second) indicator could be a 2-bit indicator and associated to first PDSCH DM-RS(s) in the first DM-RS CDM group indicated by the antenna ports field in a DCI (e.g., the scheduling DCI or the beam indication DCI with or without DL assignment) and/or first PDSCH DM-RS(s) or first DM-RS antenna port(s) for PDSCH reception(s) with ‘00’ (‘01’, ‘10’, or ‘11’) indicating that the first indicated TCI state/pair of TCI states could be applied/used for receiving first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first DM-RS antenna port(s) in the first DM-RS CDM group indicated by the antenna ports field in the DCI for PDSCH reception(s) with ‘01’ (‘00’, ‘10’, or ‘11’) indicating that the second indicated TCI state/pair of TCI states could be applied/used for receiving first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with first DM-RS antenna port(s) in the first DM-RS CDM group indicated by the antenna ports field in the DCI for PDSCH reception(s) with ‘10’ (‘00’, ‘01’ or ‘11’) indicating that the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)), with ‘11’ (‘00’, ‘01’ or ‘10’) indicating that the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)). The value(s) ‘00’ or ‘01’ or ‘10’ or ‘11’ of the indicator could also be reserved or set to ‘reserved’. Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein with or without configuring/enabling/following the indicator(s)/parameter(s), e.g., in PDSCH-Config.

For the one or more examples described herein, the UE 116 may use/apply none of the indicated TCI states/pairs of TCI states for PDSCH reception(s) when/if the indicator/parameter provided in the higher layer parameter, e.g., PDSCH-Config, as specified herein—e.g., following one or more examples described herein—is set to (i) ‘none’ or ‘disabled’ or ‘off’ or ‘not present’/‘absent’ or ‘not configured’ and/or (ii) a predetermined value ‘0’, ‘1’, ‘00’, ‘01’, ‘10’ or ‘11’ that is designated for indicating that none of the indicated TCI states/pairs of TCI states could be used/applied for PDSCH reception(s).

Alternatively, the UE 116 may use/apply both of the indicated TCI states/pairs of TCI states for PDSCH reception(s) when/if the indicator/parameter provided in the higher layer parameter, e.g., PDSCH-Config, as specified herein—e.g., following one or more examples described herein—(i) is set to ‘both’ or ‘none’ or ‘disabled’ or ‘off’ or (ii) is absent/not present/not configured/not provided. the UE 116 could follow (e.g., according to network's configuration/indication via higher layer RRC signaling/parameter and/or MAC CE command and/or dynamic DCI based L1 signaling) one or more examples described herein to determine the association between one or more of the indicated TCI states/pairs of TCI states and first (or second) PDSCH(s) and/or first (or second) PDSCH DM-RS(s) in the first (or second) DM-RS CDM group indicated by the antenna ports field in a DCI (e.g., the scheduling DCI or the beam indication DCI with or without DL assignment) and/or first (or second) PDSCH DM-RS(s)/first (or second) DM-RS antenna port(s) for PDSCH reception(s). Additionally, the UE 116 could follow (e.g., according to network's configuration/indication via higher layer RRC signaling/parameter and/or MAC CE command and/or dynamic DCI based L1 signaling) one or more examples (e.g., one or more examples described herein) specified herein to determine the association between one or more of the indicated TCI states/pairs of TCI states and first PDSCH(s) and/or first PDSCH DM-RS(s) in the first DM-RS CDM group indicated by the antenna ports field in a DCI (e.g., the scheduling DCI or the beam indication DCI with or without DL assignment) and/or first PDSCH DM-RS(s)/first DM-RS antenna port(s) for PDSCH reception(s). Furthermore, the second (or first) indicator/parameter could be associated to second PDSCH(s) and/or second PDSCH DM-RS(s) in the second DM-RS CDM group indicated by the antenna ports field in a DCI (e.g., the scheduling DCI or the beam indication DCI with or without DL assignment) and/or second PDSCH DM-RS(s)/second DM-RS antenna port(s) for PDSCH reception(s) as specified herein, and so on. The UE 116 could follow (e.g., according to network's configuration/indication via higher layer RRC signaling/parameter and/or MAC CE command and/or dynamic DCI based L1 signaling) one or more examples described herein to determine the association between one or more of the indicated TCI states/pairs of TCI states and second PDSCH(s) and/or second PDSCH DM-RS(s) in the second DM-RS CDM group indicated by the antenna ports field in a DCI (e.g., the scheduling DCI or the beam indication DCI with or without DL assignment) and/or second PDSCH DM-RS(s)/second DM-RS antenna port(s) for PDSCH reception(s). The UE 116 could be provided/configured/indicated by the network 130, e.g., via higher layer RRC signaling/parameter and/or MAC CE command and/or dynamic DCI based L1 signaling, the association/mapping relationship(s) between (i) the first/second indicator/parameter specified herein and (ii) first/second PDSCH(s) and/or first/second PDSCH DM-RS(s) in the first/second DM-RS CDM group indicated by the antenna ports field in a DCI (e.g., the scheduling DCI or the beam indication DCI with or without DL assignment) and/or first/second PDSCH DM-RS(s) and/or first/second DM-RS antenna port(s) for PDSCH reception(s). Here, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein.

In one embodiment, the UE 116 could follow one or more fixed rules to determine which indicated TCI state(s) to use/apply for PDSCH reception(s), wherein the fixed rule(s) could be determined/defined/described as in one or more examples described herein.

For example, for N=2 or M=2, the UE 116 could use/apply the first indicated TCI state/pair of TCI states to receive first (or second) PDSCH(s).

For another example, for N=2 or M=2, the UE 116 could use/apply the second indicated TCI state/pair of TCI states to receive first (or second) PDSCH(s).

Yet for another example, for N=2 or M=2, the UE 116 could use/apply the first indicated TCI state/pair of TCI states to receive first PDSCH(s) and the second indicated TCI state/pair of TCI states to receive second PDSCH(s), e.g., at the same time or simultaneously or in one beam/TCI state indication/update instance or in one slot.

Yet for another example, for N=2 or M=2, the UE 116 could use/apply the first indicated TCI state/pair of TCI states to receive second PDSCH(s) and the second indicated TCI state/pair of TCI states to receive first PDSCH(s), e.g., at the same time or simultaneously or in one beam/TCI state indication/update instance or in one slot.

Yet for another example, for N=2 or M=2, the UE 116 could use/apply the first indicated TCI state/pair of TCI states to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first (or second) DM-RS antenna port(s) in the first (or second) DM-RS CDM group indicated by the antenna ports field in the DCI for PDSCH reception(s).

Yet for another example, for N=2 or M=2, the UE 116 could use/apply the second indicated TCI state/pair of TCI states to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with second (or first) DM-RS antenna port(s) in the second (or first) DM-RS CDM group indicated by the antenna ports field in the DCI for PDSCH reception(s).

Yet for another example, for N=2 or M=2, the UE 116 could use/apply the first indicated TCI state/pair of TCI states to receive first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first DM-RS antenna port(s) in the first DM-RS CDM group indicated by the antenna ports field in the DCI for PDSCH reception(s) and the second indicated TCI state/pair of TCI states to receive second PDSCH DM-RS(s) in the second DM-RS CDM group indicated by the antenna ports field in the DCI. Equivalently, the RS(s) in the RS set(s) provided in the second indicated TCI state/pair of TCI states could be quasi-co-located (QCL'ed) with second DM-RS antenna port(s) in the second DM-RS CDM group indicated by the antenna ports field in the DCI for PDSCH reception(s), e.g., at the same time or simultaneously or in one beam/TCI state indication/update instance or in one slot.

Yet for another example, for N=2 or M=2, the UE 116 could use/apply the first indicated TCI state/pair of TCI states to receive second PDSCH DM-RS(s) in the second DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with second DM-RS antenna port(s) in the second DM-RS CDM group indicated by the antenna ports field in the DCI for PDSCH reception(s) and the second indicated TCI state/pair of TCI states to receive first PDSCH DM-RS(s) in the first DM-RS CDM group indicated by the antenna ports field in the DCI. Equivalently, the RS(s) in the RS set(s) provided in the second indicated TCI state/pair of TCI states could be quasi-co-located (QCL'ed) with first DM-RS antenna port(s) in the first DM-RS CDM group indicated by the antenna ports field in the DCI for PDSCH reception(s), e.g., at the same time or simultaneously or in one beam/TCI state indication/update instance or in one slot.

Yet for another example, for N=2 or M=2, the UE 116 could use/apply the first indicated TCI state/pair of TCI states to receive first PDSCH DM-RS(s) (or equivalently, the RS(s) in the RS set(s) provided in the first indicated TCI state/pair of TCI states could be quasi-co-located (QCL'ed) with first DM-RS antenna port(s) for PDSCH reception(s)) and the second indicated TCI state/pair of TCI states to receive second PDSCH DM-RS(s) (or equivalently, the RS(s) in the RS set(s) provided in the second indicated TCI state/pair of TCI states could be QCL'ed with second DM-RS antenna port(s) for PDSCH reception(s)), e.g., at the same time or simultaneously or in one beam/TCI state indication/update instance or in one slot.

Yet for another example, for N=2 or M=2, the UE 116 could use/apply the first indicated TCI state/pair of TCI states to receive the second PDSCH DM-RS(s) (or equivalently, the RS(s) in the RS set(s) provided in the first indicated TCI state/pair of TCI states could be QCL'ed with the second DM-RS antenna port(s) for PDSCH reception(s)) and the second indicated TCI state/pair of TCI states to receive the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)), e.g., at the same time or simultaneously or in one beam/TCI state indication/update instance or in one slot.

Yet for another example, for N=2 or M=2, the UE 116 could use/apply the first indicated TCI state/pair of TCI states to receive first (or second) PDSCH(s), the second indicated TCI state/pair of TCI states to receive second (or first) PDSCH(s), and the first indicated TCI state/pair of TCI states to receive first PDSCH(s) and the second indicated TCI state/pair of TCI states to receive second PDSCH(s)—e.g., at the same time or simultaneously or in one beam/TCI state indication or update instance or in one slot.

Yet for another example, for N=2 or M=2, the UE 116 could use/apply the first indicated TCI state/pair of TCI states to receive first (or second) PDSCH(s), the second indicated TCI state/pair of TCI states to receive second (or first) PDSCH(s), the first indicated TCI state/pair of TCI states to receive second PDSCH(s), and the second indicated TCI state/pair of TCI states to receive first PDSCH(s)—e.g., at the same time or simultaneously or in one beam/TCI state indication or update instance or in one slot.

Yet for another example, for N=2 or M=2, the UE 116 could use/apply the first indicated TCI state/pair of TCI states to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first (or second) DM-RS antenna port(s) in the first (or second) DM-RS CDM group indicated by the antenna ports field in the DCI for PDSCH reception(s) and the second indicated TCI state/pair of TCI states to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with second (or first) DM-RS antenna port(s) in the second (or first) DM-RS CDM group indicated by the antenna ports field in the DCI for PDSCH reception(s) and the first indicated TCI state/pair of TCI states to receive first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first DM-RS antenna port(s) in the first DM-RS CDM group indicated by the antenna ports field in the DCI for PDSCH reception(s) and the second indicated TCI state/pair of TCI states to receive second PDSCH DM-RS(s) in the second DM-RS CDM group indicated by the antenna ports field in the DCI. Equivalently, the RS(s) in the RS set(s) provided in the second indicated TCI state/pair of TCI states could be quasi-co-located (QCL'ed) with second DM-RS antenna port(s) in the second DM-RS CDM group indicated by the antenna ports field in the DCI for PDSCH reception(s)—e.g., at the same time or simultaneously or in one beam/TCI state indication or update instance or in one slot.

Yet for another example, the UE 116 could use/apply the first indicated TCI state/pair of TCI states to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first (or second) DM-RS antenna port(s) in the first (or second) DM-RS CDM group indicated by the antenna ports field in the DCI for PDSCH reception(s) and the second indicated TCI state/pair of TCI states to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with second (or first) DM-RS antenna port(s) in the second (or first) DM-RS CDM group indicated by the antenna ports field in the DCI for PDSCH reception(s) and the first indicated TCI state/pair of TCI states to receive second PDSCH DM-RS(s) in the second DM-RS CDM group indicated by the antenna ports field in a DCI (e.g., the scheduling DCI or the beam indication DCI with or without DL assignment)—or equivalently, the RS(s) in the RS set(s) provided in the first indicated TCI state/pair of TCI states could be quasi-co-located (QCL'ed) with second DM-RS antenna port(s) in the second DM-RS CDM group indicated by the antenna ports field in the DCI for PDSCH reception(s) and the second indicated TCI state/pair of TCI states to receive first PDSCH DM-RS(s) in the first DM-RS CDM group indicated by the antenna ports field in the DCI. Equivalently, the RS(s) in the RS set(s) provided in the second indicated TCI state/pair of TCI states could be quasi-co-located (QCL'ed) with first DM-RS antenna port(s) in the first DM-RS CDM group indicated by the antenna ports field in the DCI for PDSCH reception(s)—e.g., at the same time or simultaneously or in one beam/TCI state indication or update instance or in one slot.

Yet for another example, for N=2 or M=2, the UE 116 could use/apply the first indicated TCI state/pair of TCI states to receive the first (or second) PDSCH(s), the second indicated TCI state/pair of TCI states to receive the second (or first) PDSCH(s), the first indicated TCI state/pair of TCI states to receive the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states to receive the second PDSCH DM-RS(s) (or equivalently, the RS(s) in the RS set(s) provided in the second indicated TCI state/pair of TCI states could be QCL'ed with the second DM-RS antenna port(s) for PDSCH reception(s))—e.g., at the same time or simultaneously or in one beam/TCI state indication or update instance or in one slot.

Yet for another example, for N=2 or M=2, the UE 116 could use/apply the first indicated TCI state/pair of TCI states to receive the first (or second) PDSCH(s), the second indicated TCI state/pair of TCI states to receive the second (or first) PDSCH(s), the first indicated TCI state/pair of TCI states to receive the second PDSCH DM-RS(s) (or equivalently, the RS(s) in the RS set(s) provided in the first indicated TCI state/pair of TCI states could be QCL'ed with the second DM-RS antenna port(s) for PDSCH reception(s)), and the second indicated TCI state/pair of TCI states to receive the first PDSCH DM-RS(s) (or equivalently, the RS(s) in the RS set(s) provided in the second indicated TCI state/pair of TCI states could be QCL'ed with the first DM-RS antenna port(s) for PDSCH reception(s))—e.g., at the same time or simultaneously or in one beam/TCI state indication or update instance or in one slot.

Yet for another example, for N=2 or M=2, the UE 116 could use/apply the first indicated TCI state/pair of TCI states to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first (or second) DM-RS antenna port(s) in the first (or second) DM-RS CDM group indicated by the antenna ports field in the DCI for PDSCH reception(s) and the second indicated TCI state/pair of TCI states to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with second (or first) DM-RS antenna port(s) in the second (or first) DM-RS CDM group indicated by the antenna ports field in the DCI for PDSCH reception(s), the first indicated TCI state/pair of TCI states to receive the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states to receive the second PDSCH DM-RS(s) (or equivalently, the RS(s) in the RS set(s) provided in the second indicated TCI state/pair of TCI states could be QCL'ed with the second DM-RS antenna port(s) for PDSCH reception(s))—e.g., at the same time or simultaneously or in one beam/TCI state indication or update instance or in one slot.

Yet for another example, for N=2 or M=2, the UE 116 could use/apply the first indicated TCI state/pair of TCI states to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first (or second) DM-RS antenna port(s) in the first (or second) DM-RS CDM group indicated by the antenna ports field in the DCI for PDSCH reception(s) and the second indicated TCI state/pair of TCI states to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with second (or first) DM-RS antenna port(s) in the second (or first) DM-RS CDM group indicated by the antenna ports field in the DCI for PDSCH reception(s), the first indicated TCI state/pair of TCI states to receive the second PDSCH DM-RS(s) (or equivalently, the RS(s) in the RS set(s) provided in the first indicated TCI state/pair of TCI states could be QCL'ed with the second DM-RS antenna port(s) for PDSCH reception(s)), and the second indicated TCI state/pair of TCI states to receive the first PDSCH DM-RS(s) (or equivalently, the RS(s) in the RS set(s) provided in the second indicated TCI state/pair of TCI states could be QCL'ed with the first DM-RS antenna port(s) for PDSCH reception(s))—e.g., at the same time or simultaneously or in one beam/TCI state indication or update instance or in one slot.

Yet for another example, the UE 116 could use/apply the TCI state(s)/pair(s) of TCI states with the respective/corresponding source reference signal(s) indicated/provided therein having the same value(s) as the reference signal(s), e.g., synchronization signal/physical broadcast channels (SSB(s))/SSB index(es) or CSI-RS(s)/CSI-RS resource index(es), associated to the last (or the latest in time) physical random access channel (PRACH) transmission to receive PDSCH(s)—e.g., the first and/or second PDSCHs as specified herein.

For the described examples (e.g., one or more examples described herein), the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein.

In one embodiment, the UE 116 could follow one or more predefined rules to determine which indicated TCI state(s) to use/apply for PDSCH reception(s), wherein the predefined rule(s) could be determined/defined/described as in one or more examples described herein.

In one example, the UE 116 could first determine a first TCI state/pair of TCI states as the first TCI state/pair of TCI states in/of a TCI codepoint corresponding to the lowest (or highest) TCI codepoint among all first TCI codepoints activated/provided by the MAC CE command for beam indication/activation (e.g., in a slot), e.g., the Unified TCI States Activation/Deactivation MAC CE or Enhanced Unified TCI States Activation/Deactivation MAC CE, and/or a second TCI state/pair of TCI states as the second TCI state/pair of TCI states in/of a TCI codepoint corresponding to the lowest (or highest) TCI codepoint among all the first TCI codepoints activated/provided by the MAC CE command for beam indication/activation (e.g., in a slot), e.g., the Unified TCI States Activation/Deactivation MAC CE or Enhanced Unified TCI States Activation/Deactivation MAC CE, wherein more than one (e.g., 2) joint/DL/UL TCI states or more than one (e.g., 2) pairs of joint/DL/UL TCI states could be mapped to each of the first TCI codepoints described/specified herein. Equivalently, the first TCI codepoints described/specified herein could contain more than one (e.g., 2) joint/DL/UL TCI states or more than one (e.g., 2) pairs of joint/DL/UL TCI states based on the activated TCI states in a slot.

Alternatively, the UE 116 could first determine a first TCI state/pair of TCI states as the first TCI state/pair of TCI states in/of a TCI codepoint corresponding to the lowest (or highest) TCI codepoint among all second TCI codepoints activated/provided by the MAC CE command for beam indication/activation (e.g., in a slot), e.g., the Unified TCI States Activation/Deactivation MAC CE or Enhanced Unified TCI States Activation/Deactivation MAC CE, and/or a second TCI state/pair of TCI states as the second TCI state/pair of TCI states in/of a TCI codepoint corresponding to the lowest (or highest) TCI codepoint among all the second TCI codepoints activated/provided by the MAC CE command for beam indication/activation (e.g., in a slot), e.g., the Unified TCI States Activation/Deactivation MAC CE or Enhanced Unified TCI States Activation/Deactivation MAC CE, wherein a single (i.e., 1) joint/DL/UL TCI state or a single (i.e., 1) pair of joint/DL/UL TCI states could be mapped to each of the second TCI codepoints described/specified herein. Equivalently, the second TCI codepoints described/specified herein could contain a single (i.e., 1) joint/DL/UL TCI state or a single (i.e., 1) pair of joint/DL/UL TCI states based on the activated TCI states in a slot. For this case, the first TCI state/pair of TCI states could be identical to the second TCI state/pair of TCI states. Optionally, the UE 116 could first determine a first TCI state/pair of TCI states as the first TCI state/pair of TCI states in/of a TCI codepoint corresponding to the lowest (or highest) TCI codepoint among all the TCI codepoints activated/provided by the MAC CE command for beam indication/activation (e.g., in a slot), e.g., the Unified TCI States Activation/Deactivation MAC CE or Enhanced Unified TCI States Activation/Deactivation MAC CE, and/or a second TCI state/pair of TCI states as the second TCI state/pair of TCI states in/of a TCI codepoint corresponding to the lowest (or highest) TCI codepoint among all the TCI codepoints activated/provided by the MAC CE command for beam indication/activation (e.g., in a slot), e.g., the Unified TCI States Activation/Deactivation MAC CE or Enhanced Unified TCI States Activation/Deactivation MAC CE, wherein all the TCI codepoints activated/provided by the MAC CE command for beam indication/activation could comprise/include/contain/provide one or more first TCI codepoints and/or one or more second TCI codepoints described/specified herein.

For example, for N=2 or M=2, the UE 116 could use/apply the first TCI state/pair of TCI states as described herein to receive first (or second) PDSCH(s).

For another example, for N=2 or M=2, the UE 116 could use/apply the second TCI state/pair of TCI states as described herein to receive first (or second) PDSCH(s).

Yet for another example, for N=2 or M=2, the UE 116 could use/apply the first TCI state/pair of TCI states as described herein to receive first PDSCH(s) and the second TCI state/pair of TCI states as described herein to receive second PDSCH(s), e.g., at the same time or simultaneously or in one beam/TCI state indication/update instance or in one slot.

Yet for another example, for N=2 or M=2, the UE 116 could use/apply the first TCI state/pair of TCI states as described herein to receive second PDSCH(s) and the second TCI state/pair of TCI states as described herein to receive first PDSCH(s), e.g., at the same time or simultaneously or in one beam/TCI state indication/update instance or in one slot.

Yet for another example, for N=2 or M=2, the UE 116 could use/apply the first TCI state/pair of TCI states as described herein to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first TCI state/pair of TCI states as described herein could be quasi-co-located (QCL'ed) with first (or second) DM-RS antenna port(s) in the first (or second) DM-RS CDM group indicated by the antenna ports field in the DCI for PDSCH reception(s).

Yet for another example, for N=2 or M=2, the UE 116 could use/apply the second TCI state/pair of TCI states as described herein to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second TCI state/pair of TCI states as described herein could be quasi-co-located (QCL'ed) with second (or first) DM-RS antenna port(s) in the second (or first) DM-RS CDM group indicated by the antenna ports field in the DCI for PDSCH reception(s).

Yet for another example, for N=2 or M=2, the UE 116 could use/apply the first TCI state/pair of TCI states as described herein to receive first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first TCI state/pair of TCI states as described herein could be quasi-co-located (QCL'ed) with first DM-RS antenna port(s) in the first DM-RS CDM group indicated by the antenna ports field in the DCI for PDSCH reception(s) and the second TCI state/pair of TCI states as described herein to receive second PDSCH DM-RS(s) in the second DM-RS CDM group indicated by the antenna ports field in the DCI. Equivalently, the RS(s) in the RS set(s) provided in the second TCI state/pair of TCI states could be quasi-co-located (QCL'ed) with second DM-RS antenna port(s) in the second DM-RS CDM group indicated by the antenna ports field in the DCI for PDSCH reception(s), e.g., at the same time or simultaneously or in one beam/TCI state indication/update instance or in one slot.

Yet for another example, for N=2 or M=2, the UE 116 could use/apply the first TCI state/pair of TCI states as described herein to receive second PDSCH DM-RS(s) in the second DM-RS CDM group indicated by the antenna ports field in a DCI (e.g., the scheduling DCI or the beam indication DCI with or without DL assignment). Equivalently, the RS(s) in the RS set(s) provided in the first TCI state/pair of TCI states as described herein could be quasi-co-located (QCL'ed) with second DM-RS antenna port(s) in the second DM-RS CDM group indicated by the antenna ports field in the DCI for PDSCH reception(s) and the second TCI state/pair of TCI states as described herein to receive first PDSCH DM-RS(s) in the first DM-RS CDM group indicated by the antenna ports field in the DCI. Equivalently, the RS(s) in the RS set(s) provided in the second TCI state/pair of TCI states as described herein could be quasi-co-located (QCL'ed) with first DM-RS antenna port(s) in the first DM-RS CDM group indicated by the antenna ports field in the DCI for PDSCH reception(s), e.g., at the same time or simultaneously or in one beam/TCI state indication/update instance or in one slot.

Yet for another example, for N=2 or M=2, the UE 116 could use/apply the first TCI state/pair of TCI states as described herein to receive first PDSCH DM-RS(s) (or equivalently, the RS(s) in the RS set(s) provided in the first TCI state/pair of TCI states as described herein could be quasi-co-located (QCL'ed) with first DM-RS antenna port(s) for PDSCH reception(s)) and the second TCI state/pair of TCI states as described herein to receive second PDSCH DM-RS(s) (or equivalently, the RS(s) in the RS set(s) provided in the second TCI state/pair of TCI states as described herein could be QCL'ed with second DM-RS antenna port(s) for PDSCH reception(s)), e.g., at the same time or simultaneously or in one beam/TCI state indication/update instance or in one slot.

Yet for another example, for N=2 or M=2, the UE 116 could use/apply the first TCI state/pair of TCI states as described herein to receive the second PDSCH DM-RS(s) (or equivalently, the RS(s) in the RS set(s) provided in the first TCI state/pair of TCI states as described herein could be QCL'ed with the second DM-RS antenna port(s) for PDSCH reception(s)) and the second TCI state/pair of TCI states as described herein to receive the first PDSCH DM-RS(s) (or equivalently, the RS(s) in the RS set(s) provided in the second TCI state/pair of TCI states as described herein could be QCL'ed with the first DM-RS antenna port(s) for PDSCH reception(s)), e.g., at the same time or simultaneously or in one beam/TCI state indication/update instance or in one slot.

Yet for another example, for N=2 or M=2, the UE 116 could use/apply the first TCI state/pair of TCI states as described herein to receive first (or second) PDSCH(s), the second TCI state/pair of TCI states as described herein to receive second (or first) PDSCH(s), and the first TCI state/pair of TCI states as described herein to receive first PDSCH(s) and the second TCI state/pair of TCI states as described herein to receive second PDSCH(s)—e.g., at the same time or simultaneously or in one beam/TCI state indication or update instance or in one slot.

Yet for another example, for N=2 or M=2, the UE 116 could use/apply the first TCI state/pair of TCI states as described herein to receive first (or second) PDSCH(s), the second TCI state/pair of TCI states as described herein to receive second (or first) PDSCH(s), and the first TCI state/pair of TCI states as described herein to receive second PDSCH(s) and the second TCI state/pair of TCI states as described herein to receive first PDSCH(s)—e.g., at the same time or simultaneously or in one beam/TCI state indication or update instance or in one slot.

Yet for another example, for N=2 or M=2, the UE 116 could use/apply the first TCI state/pair of TCI states as described herein to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first TCI state/pair of TCI states as described herein could be quasi-co-located (QCL'ed) with first (or second) DM-RS antenna port(s) in the first (or second) DM-RS CDM group indicated by the antenna ports field in the DCI for PDSCH reception(s) and the second TCI state/pair of TCI states as described herein to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second TCI state/pair of TCI states as described herein could be quasi-co-located (QCL'ed) with second (or first) DM-RS antenna port(s) in the second (or first) DM-RS CDM group indicated by the antenna ports field in the DCI for PDSCH reception(s) and the first TCI state/pair of TCI states as described herein to receive first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first TCI state/pair of TCI states as described herein could be quasi-co-located (QCL'ed) with first DM-RS antenna port(s) in the first DM-RS CDM group indicated by the antenna ports field in the DCI for PDSCH reception(s) and the second TCI state/pair of TCI states as described herein to receive second PDSCH DM-RS(s) in the second DM-RS CDM group indicated by the antenna ports field in the DCI. Equivalently, the RS(s) in the RS set(s) provided in the second TCI state/pair of TCI states as described herein could be quasi-co-located (QCL'ed) with second DM-RS antenna port(s) in the second DM-RS CDM group indicated by the antenna ports field in the DCI for PDSCH reception(s)—e.g., at the same time or simultaneously or in one beam/TCI state indication or update instance or in one slot.

Yet for another example, the UE 116 could use/apply the first TCI state/pair of TCI states as described herein to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first TCI state/pair of TCI states as described herein could be quasi-co-located (QCL'ed) with first (or second) DM-RS antenna port(s) in the first (or second) DM-RS CDM group indicated by the antenna ports field in the DCI for PDSCH reception(s) and the second TCI state/pair of TCI states as described herein to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second TCI state/pair of TCI states as described herein could be quasi-co-located (QCL'ed) with second (or first) DM-RS antenna port(s) in the second (or first) DM-RS CDM group indicated by the antenna ports field in the DCI for PDSCH reception(s) and the first TCI state/pair of TCI states as described herein to receive second PDSCH DM-RS(s) in the second DM-RS CDM group indicated by the antenna ports field in a DCI (e.g., the scheduling DCI or the beam indication DCI with or without DL assignment). Equivalently, the RS(s) in the RS set(s) provided in the first TCI state/pair of TCI states as described herein could be quasi-co-located (QCL'ed) with second DM-RS antenna port(s) in the second DM-RS CDM group indicated by the antenna ports field in the DCI for PDSCH reception(s) and the second TCI state/pair of TCI states as described herein to receive first PDSCH DM-RS(s) in the first DM-RS CDM group indicated by the antenna ports field in the DCI. Equivalently, the RS(s) in the RS set(s) provided in the second TCI state/pair of TCI states as described herein could be quasi-co-located (QCL'ed) with first DM-RS antenna port(s) in the first DM-RS CDM group indicated by the antenna ports field in the DCI for PDSCH reception(s)—e.g., at the same time or simultaneously or in one beam/TCI state indication or update instance or in one slot.

Yet for another example, for N=2 or M=2, the UE 116 could use/apply the first TCI state/pair of TCI states as described herein to receive the first (or second) PDSCH(s), the second TCI state/pair of TCI states as described herein to receive the second (or first) PDSCH(s), the first TCI state/pair of TCI states as described herein to receive the first PDSCH DM-RS(s) (or equivalently, the RS(s) in the RS set(s) provided in the first TCI state/pair of TCI states as described herein could be QCL'ed with the first DM-RS antenna port(s) for PDSCH reception(s)), and the second TCI state/pair of TCI states as described herein to receive the second PDSCH DM-RS(s) (or equivalently, the RS(s) in the RS set(s) provided in the second TCI state/pair of TCI states as described herein could be QCL'ed with the second DM-RS antenna port(s) for PDSCH reception(s))—e.g., at the same time or simultaneously or in one beam/TCI state indication or update instance or in one slot.

Yet for another example, for N=2 or M=2, the UE 116 could use/apply the first TCI state/pair of TCI states as described herein to receive the first (or second) PDSCH(s), the second TCI state/pair of TCI states as described herein to receive the second (or first) PDSCH(s), the first TCI state/pair of TCI states as described herein to receive the second PDSCH DM-RS(s) (or equivalently, the RS(s) in the RS set(s) provided in the first TCI state/pair of TCI states as described herein could be QCL'ed with the second DM-RS antenna port(s) for PDSCH reception(s)), and the second TCI state/pair of TCI states as described herein to receive the first PDSCH DM-RS(s) (or equivalently, the RS(s) in the RS set(s) provided in the second TCI state/pair of TCI states as described herein could be QCL'ed with the first DM-RS antenna port(s) for PDSCH reception(s))—e.g., at the same time or simultaneously or in one beam/TCI state indication or update instance or in one slot.

Yet for another example, for N=2 or M=2, the UE 116 could use/apply the first TCI state/pair of TCI states as described herein to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first TCI state/pair of TCI states as described herein could be quasi-co-located (QCL'ed) with first (or second) DM-RS antenna port(s) in the first (or second) DM-RS CDM group indicated by the antenna ports field in the DCI for PDSCH reception(s) and the second TCI state/pair of TCI states as described herein to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second TCI state/pair of TCI states as described herein could be quasi-co-located (QCL'ed) with second (or first) DM-RS antenna port(s) in the second (or first) DM-RS CDM group indicated by the antenna ports field in the DCI for PDSCH reception(s), the first TCI state/pair of TCI states as described herein to receive the first PDSCH DM-RS(s) (or equivalently, the RS(s) in the RS set(s) provided in the first TCI state/pair of TCI states as described herein could be QCL'ed with the first DM-RS antenna port(s) for PDSCH reception(s)) and the second TCI state/pair of TCI states as described herein to receive the second PDSCH DM-RS(s) (or equivalently, the RS(s) in the RS set(s) provided in the second TCI state/pair of TCI states as described herein could be QCL'ed with the second DM-RS antenna port(s) for PDSCH reception(s))—e.g., at the same time or simultaneously or in one beam/TCI state indication or update instance or in one slot.

Yet for another example, for N=2 or M=2, the UE 116 could use/apply the first TCI state/pair of TCI states as described herein to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first TCI state/pair of TCI states as described herein could be quasi-co-located (QCL'ed) with first (or second) DM-RS antenna port(s) in the first (or second) DM-RS CDM group indicated by the antenna ports field in the DCI for PDSCH reception(s), the second TCI state/pair of TCI states as described herein to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second TCI state/pair of TCI states as described herein could be quasi-co-located (QCL'ed) with second (or first) DM-RS antenna port(s) in the second (or first) DM-RS CDM group indicated by the antenna ports field in the DCI for PDSCH reception(s), the first TCI state/pair of TCI states as described herein to receive the second PDSCH DM-RS(s) (or equivalently, the RS(s) in the RS set(s) provided in the first TCI state/pair of TCI states as described herein could be QCL'ed with the second DM-RS antenna port(s) for PDSCH reception(s)), and the second TCI state/pair of TCI states as described herein to receive the first PDSCH DM-RS(s) (or equivalently, the RS(s) in the RS set(s) provided in the second TCI state/pair of TCI states as described herein could be QCL'ed with the first DM-RS antenna port(s) for PDSCH reception(s))—e.g., at the same time or simultaneously or in one beam/TCI state indication or update instance or in one slot.

In another example, the UE 116 could use/apply the same TCI state(s)/pair(s) of TCI states used/applied for receiving the scheduling PDCCH(s)/DCI(s)—e.g., following one or more examples described herein—to receive PDSCH(s) scheduled by the scheduling PDCCH(s)/DCI(s).

For example, for N=2 or M=2, the UE 116 could use/apply the first indicated TCI state/pair of TCI states to receive first (or second) PDSCH(s) when/if the UE 116 uses/applies the first indicated TCI state/pair of TCI states to receive (scheduling) PDCCH(s)/DCI(s)—following one or more examples described herein—that schedules the first (or second) PDSCH(s).

For another example, for N=2 or M=2, the UE 116 could use/apply the second indicated TCI state/pair of TCI states to receive first (or second) PDSCH(s) when/if the UE 116 uses/applies the second indicated TCI state/pair of TCI states to receive (scheduling) PDCCH(s)/DCI(s)—following one or more examples described herein—that schedules the first (or second) PDSCH(s).

Yet for another example, for N=2 or M=2, the UE 116 could use/apply the first indicated TCI state/pair of TCI states to receive first PDSCH(s) and the second indicated TCI state/pair of TCI states to receive second PDSCH(s), e.g., at the same time or simultaneously or in one beam/TCI state indication/update instance or in one slot, when/if the UE 116 uses/applies the first indicated TCI state/pair of TCI states and the second indicated TCI state/pair of TCI states to receive (scheduling) PDCCH(s)/DCI(s)—following one or more examples described herein—that (respectively) schedules the first and/or second PDSCH(s) at the same time, simultaneously, in one beam/TCI state indication/update instance, or in one slot.

Yet for another example, for N=2 or M=2, the UE 116 could use/apply the first indicated TCI state/pair of TCI states to receive second PDSCH(s) and the second indicated TCI state/pair of TCI states to receive first PDSCH(s), e.g., at the same time or simultaneously or in one beam/TCI state indication/update instance or in one slot, when/if the UE 116 uses/applies the first indicated TCI state/pair of TCI states and the second indicated TCI state/pair of TCI states to receive (scheduling) PDCCH(s)/DCI(s)—following one or more examples described herein—that (respectively) schedules the second and/or first PDSCH(s), e.g., at the same time or simultaneously or in one beam/TCI state indication/update instance or in one slot.

Yet for another example, for N=2 or M=2, the UE 116 could use/apply the first indicated TCI state/pair of TCI states to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first (or second) DM-RS antenna port(s) in the first (or second) DM-RS CDM group indicated by the antenna ports field in the DCI for PDSCH reception(s) when/if the UE 116 uses/applies the first indicated TCI state/pair of TCI states to receive (scheduling) PDCCH(s)/DCI(s)—following one or more examples described herein—that schedules the PDSCH(s) with the first (or second) DM-RS antenna port(s) in the first (or second) DM-RS CDM group indicated by the antenna ports field in the DCI.

Yet for another example, for N=2 or M=2, the UE 116 could use/apply the second indicated TCI state/pair of TCI states to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with second (or first) DM-RS antenna port(s) in the second (or first) DM-RS CDM group indicated by the antenna ports field in the DCI for PDSCH reception(s) when/if the UE 116 uses/applies the second indicated TCI state/pair of TCI states to receive (scheduling) PDCCH(s)/DCI(s)—following one or more examples described herein—that schedules the PDSCH(s) with the second (or first) DM-RS antenna port(s) in the second (or first) DM-RS CDM group indicated by the antenna ports field in the DCI.

Yet for another example, for N=2 or M=2, the UE 116 could use/apply the first indicated TCI state/pair of TCI states to receive first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first DM-RS antenna port(s) in the first DM-RS CDM group indicated by the antenna ports field in the DCI for PDSCH reception(s) and the second indicated TCI state/pair of TCI states to receive second PDSCH DM-RS(s) in the second DM-RS CDM group indicated by the antenna ports field in the DCI. Equivalently, the RS(s) in the RS set(s) provided in the second indicated TCI state/pair of TCI states could be quasi-co-located (QCL'ed) with second DM-RS antenna port(s) in the second DM-RS CDM group indicated by the antenna ports field in the DCI for PDSCH reception(s), e.g., at the same time or simultaneously or in one beam/TCI state indication/update instance or in one slot, when/if the UE 116 uses/applies the first indicated TCI state/pair of TCI states and the second indicated TCI state/pair of TCI states to receive (scheduling) PDCCH(s)/DCI(s)—following one or more examples described herein—that (respectively) schedules the PDSCH(s) with the first and/or second DM-RS antenna ports in the first and/or second DM-RS CDM groups indicated by the antenna ports field in the DCI, e.g., at the same time or simultaneously or in one beam/TCI state indication/update instance or in one slot.

Yet for another example, for N=2 or M=2, the UE 116 could use/apply the first indicated TCI state/pair of TCI states to receive second PDSCH DM-RS(s) in the second DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with second DM-RS antenna port(s) in the second DM-RS CDM group indicated by the antenna ports field in the DCI for PDSCH reception(s) and the second indicated TCI state/pair of TCI states to receive first PDSCH DM-RS(s) in the first DM-RS CDM group indicated by the antenna ports field in the DCI. Equivalently, the RS(s) in the RS set(s) provided in the second indicated TCI state/pair of TCI states could be quasi-co-located (QCL'ed) with first DM-RS antenna port(s) in the first DM-RS CDM group indicated by the antenna ports field in the DCI for PDSCH reception(s), e.g., at the same time or simultaneously or in one beam/TCI state indication/update instance or in one slot, when/if the UE 116 uses/applies the first indicated TCI state/pair of TCI states and the second indicated TCI state/pair of TCI states to receive (scheduling) PDCCH(s)/DCI(s)—following one or more examples described herein—that (respectively) schedules the PDSCH(s) with the second and/or first DM-RS antenna ports in the second and/or first DM-RS CDM groups indicated by the antenna ports field in the DCI, e.g., at the same time or simultaneously or in one beam/TCI state indication/update instance or in one slot.

Yet for another example, for N=2 or M=2, the UE 116 could use/apply the first indicated TCI state/pair of TCI states to receive first PDSCH DM-RS(s) (or equivalently, the RS(s) in the RS set(s) provided in the first indicated TCI state/pair of TCI states could be quasi-co-located (QCL'ed) with first DM-RS antenna port(s) for PDSCH reception(s)) and the second indicated TCI state/pair of TCI states to receive second PDSCH DM-RS(s) (or equivalently, the RS(s) in the RS set(s) provided in the second indicated TCI state/pair of TCI states could be QCL'ed with second DM-RS antenna port(s) for PDSCH reception(s)), e.g., at the same time or simultaneously or in one beam/TCI state indication/update instance or in one slot, when/if the UE 116 uses/applies the first indicated TCI state/pair of TCI states and the second indicated TCI state/pair of TCI states to receive (scheduling) PDCCH(s)/DCI(s)—following one or more examples described herein—that (respectively) schedules the PDSCH(s) with the first and/or second DM-RS antenna ports, e.g., at the same time or simultaneously or in one beam/TCI state indication/update instance or in one slot.

Yet for another example, for N=2 or M=2, the UE 116 could use/apply the first indicated TCI state/pair of TCI states to receive the second PDSCH DM-RS(s) (or equivalently, the RS(s) in the RS set(s) provided in the first indicated TCI state/pair of TCI states could be QCL'ed with the second DM-RS antenna port(s) for PDSCH reception(s)) and the second indicated TCI state/pair of TCI states to receive the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)), e.g., at the same time or simultaneously or in one beam/TCI state indication/update instance or in one slot, when/if the UE 116 uses/applies the first indicated TCI state/pair of TCI states and the second indicated TCI state/pair of TCI states to receive (scheduling) PDCCH(s)/DCI(s)—following one or more examples described herein—that (respectively) schedules the PDSCH(s) with the second and/or first DM-RS antenna ports, e.g., at the same time or simultaneously or in one beam/TCI state indication/update instance or in one slot.

Yet for another example, for N=2 or M=2, the UE 116 could use/apply the first indicated TCI state/pair of TCI states to receive first (or second) PDSCH(s) when/if the UE 116 uses/applies the first indicated TCI state/pair of TCI states to receive (scheduling) PDCCH(s)/DCI(s)—following one or more examples described herein—that schedules the first (or second) PDSCH(s), the second indicated TCI state/pair of TCI states to receive second (or first) PDSCH(s) when/if the UE 116 uses/applies the second indicated TCI state/pair of TCI states to receive (scheduling) PDCCH(s)/DCI(s)—following one or more examples described herein—that schedules the second (or first) PDSCH(s), and the first indicated TCI state/pair of TCI states to receive first PDSCH(s) and the second indicated TCI state/pair of TCI states to receive second PDSCH(s)—e.g., at the same time or simultaneously or in one beam/TCI state indication or update instance or in one slot, when/if the UE 116 uses/applies the first indicated TCI state/pair of TCI states and the second indicated TCI state/pair of TCI states to receive (scheduling) PDCCH(s)/DCI(s)—following one or more examples described herein—that (respectively) schedules the first and/or second PDSCH(s), e.g., at the same time or simultaneously or in one beam/TCI state indication/update instance or in one slot.

Yet for another example, for N=2 or M=2, the UE 116 could use/apply the first indicated TCI state/pair of TCI states to receive first (or second) PDSCH(s) when/if the UE 116 uses/applies the first indicated TCI state/pair of TCI states to receive (scheduling) PDCCH(s)/DCI(s)—following one or more examples described herein—that schedules the first (or second) PDSCH(s), the second indicated TCI state/pair of TCI states to receive second (or first) PDSCH(s) when/if the UE 116 uses/applies the second indicated TCI state/pair of TCI states to receive (scheduling) PDCCH(s)/DCI(s)—following one or more examples described herein—that schedules the second (or first) PDSCH(s), and the first indicated TCI state/pair of TCI states to receive second PDSCH(s) and the second indicated TCI state/pair of TCI states to receive first PDSCH(s)—e.g., at the same time or simultaneously or in one beam/TCI state indication or update instance or in one slot, when/if the UE 116 uses/applies the first indicated TCI state/pair of TCI states and the second indicated TCI state/pair of TCI states to receive (scheduling) PDCCH(s)/DCI(s)—following one or more examples described herein—that (respectively) schedules the second and/or first PDSCH(s), e.g., at the same time or simultaneously or in one beam/TCI state indication/update instance or in one slot.

Yet for another example, for N=2 or M=2, the UE 116 could use/apply the first indicated TCI state/pair of TCI states to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first (or second) DM-RS antenna port(s) in the first (or second) DM-RS CDM group indicated by the antenna ports field in the DCI for PDSCH reception(s) when/if the UE 116 uses/applies the first indicated TCI state/pair of TCI states to receive (scheduling) PDCCH(s)/DCI(s)—following one or more examples described herein—that schedules the PDSCH(s) with the first (or second) DM-RS antenna ports in the first (or second) DM-RS CDM groups indicated by the antenna ports field in the DCI and the second indicated TCI state/pair of TCI states to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with second (or first) DM-RS antenna port(s) in the second (or first) DM-RS CDM group indicated by the antenna ports field in the DCI for PDSCH reception(s) when/if the UE 116 uses/applies the second indicated TCI state/pair of TCI states to receive (scheduling) PDCCH(s)/DCI(s)—following one or more examples described herein—that schedules the PDSCH(s) with the second (or first) DM-RS antenna ports in the second (or first) DM-RS CDM groups indicated by the antenna ports field in the DCI, and the first indicated TCI state/pair of TCI states to receive first PDSCH DM-RS(s) in the first DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first DM-RS antenna port(s) in the first DM-RS CDM group indicated by the antenna ports field in the DCI for PDSCH reception(s) and the second indicated TCI state/pair of TCI states to receive second PDSCH DM-RS(s) in the second DM-RS CDM group indicated by the antenna ports field in the DCI. Equivalently, the RS(s) in the RS set(s) provided in the second indicated TCI state/pair of TCI states could be quasi-co-located (QCL'ed) with second DM-RS antenna port(s) in the second DM-RS CDM group indicated by the antenna ports field in the DCI for PDSCH reception(s)—e.g., at the same time or simultaneously or in one beam/TCI state indication or update instance or in one slot, when/if the UE 116 uses/applies the first indicated TCI state/pair of TCI states and the second indicated TCI state/pair of TCI states to receive (scheduling) PDCCH(s)/DCI(s)—following one or more examples described herein—that (respectively) schedules the PDSCH(s) with the first and/or second DM-RS antenna ports in the first and/or second DM-RS CDM groups indicated by the antenna ports field in the DCI, e.g., at the same time or simultaneously or in one beam/TCI state indication/update instance or in one slot.

Yet for another example, for N=2 or M=2, the UE 116 could use/apply the first indicated TCI state/pair of TCI states to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first (or second) DM-RS antenna port(s) in the first (or second) DM-RS CDM group indicated by the antenna ports field in the DCI for PDSCH reception(s) when/if the UE 116 uses/applies the first indicated TCI state/pair of TCI states to receive (scheduling) PDCCH(s)/DCI(s)—following one or more examples described herein—that schedules the PDSCH(s) with the first (or second) DM-RS antenna ports in the first (or second) DM-RS CDM groups indicated by the antenna ports field in the DCI and the second indicated TCI state/pair of TCI states to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with second (or first) DM-RS antenna port(s) in the second (or first) DM-RS CDM group indicated by the antenna ports field in the DCI for PDSCH reception(s) when/if the UE 116 uses/applies the second indicated TCI state/pair of TCI states to receive (scheduling) PDCCH(s)/DCI(s)—following one or more examples described herein—that schedules the PDSCH(s) with the second (or first) DM-RS antenna ports in the second (or first) DM-RS CDM groups indicated by the antenna ports field in the DCI and the first indicated TCI state/pair of TCI states to receive second PDSCH DM-RS(s) in the second DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with second DM-RS antenna port(s) in the second DM-RS CDM group indicated by the antenna ports field in the DCI for PDSCH reception(s) and the second indicated TCI state/pair of TCI states to receive first PDSCH DM-RS(s) in the first DM-RS CDM group indicated by the antenna ports field in the DC. Equivalently, the RS(s) in the RS set(s) provided in the second indicated TCI state/pair of TCI states could be quasi-co-located (QCL'ed) with first DM-RS antenna port(s) in the first DM-RS CDM group indicated by the antenna ports field in the DCI for PDSCH reception(s)—e.g., at the same time or simultaneously or in one beam/TCI state indication or update instance or in one slot, when/if the UE 116 uses/applies the first indicated TCI state/pair of TCI states and the second indicated TCI state/pair of TCI states to receive (scheduling) PDCCH(s)/DCI(s)—following one or more examples described herein—that (respectively) schedules the PDSCH(s) with the second and/or first DM-RS antenna ports in the second and/or first DM-RS CDM groups indicated by the antenna ports field in the DCI, e.g., at the same time or simultaneously or in one beam/TCI state indication/update instance or in one slot.

Yet for another example, for N=2 or M=2, the UE 116 could use/apply the first indicated TCI state/pair of TCI states to receive the first (or second) PDSCH(s) when/if the UE 116 uses/applies the first indicated TCI state/pair of TCI states to receive (scheduling) PDCCH(s)/DCI(s)—following one or more examples described herein—that schedules the first (or second) PDSCH(s), the second indicated TCI state/pair of TCI states to receive the second (or first) PDSCH(s) when/if the UE 116 uses/applies the second indicated TCI state/pair of TCI states to receive (scheduling) PDCCH(s)/DCI(s)—following one or more examples described herein—that schedules the second (or first) PDSCH(s), the first indicated TCI state/pair of TCI states to receive the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states to receive the second PDSCH DM-RS(s) (or equivalently, the RS(s) in the RS set(s) provided in the second indicated TCI state/pair of TCI states could be QCL'ed with the second DM-RS antenna port(s) for PDSCH reception(s))—e.g., at the same time or simultaneously or in one beam/TCI state indication or update instance or in one slot, when/if the UE 116 uses/applies the first indicated TCI state/pair of TCI states and the second indicated TCI state/pair of TCI states to receive (scheduling) PDCCH(s)/DCI(s)—following one or more examples described herein—that (respectively) schedules the PDSCH(s) with the first and/or second DM-RS antenna ports, e.g., at the same time or simultaneously or in one beam/TCI state indication/update instance or in one slot.

Yet for another example, for N=2 or M=2, the UE 116 could use/apply the first indicated TCI state/pair of TCI states to receive the first (or second) PDSCH(s) when/if the UE 116 uses/applies the first indicated TCI state/pair of TCI states to receive (scheduling) PDCCH(s)/DCI(s)—following one or more examples described herein—that schedules the first (or second) PDSCH(s), the second indicated TCI state/pair of TCI states to receive the second (or first) PDSCH(s) when/if the UE 116 uses/applies the second indicated TCI state/pair of TCI states to receive (scheduling) PDCCH(s)/DCI(s)—following one or more examples described herein—that schedules the second (or first) PDSCH(s), and the first indicated TCI state/pair of TCI states to receive the second PDSCH DM-RS(s) (or equivalently, the RS(s) in the RS set(s) provided in the first indicated TCI state/pair of TCI states could be QCL'ed with the second DM-RS antenna port(s) for PDSCH reception(s)), and the second indicated TCI state/pair of TCI states to receive the first PDSCH DM-RS(s) (or equivalently, the RS(s) in the RS set(s) provided in the second indicated TCI state/pair of TCI states could be QCL'ed with the first DM-RS antenna port(s) for PDSCH reception(s))—e.g., at the same time or simultaneously or in one beam/TCI state indication or update instance or in one slot, when/if the UE 116 uses/applies the first indicated TCI state/pair of TCI states and the second indicated TCI state/pair of TCI states to receive (scheduling) PDCCH(s)/DCI(s)—following one or more examples described herein—that (respectively) schedules the PDSCH(s) with the second and/or first DM-RS antenna ports, e.g., at the same time or simultaneously or in one beam/TCI state indication/update instance or in one slot.

Yet for another example, for N=2 or M=2, the UE 116 could use/apply the first indicated TCI state/pair of TCI states to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first (or second) DM-RS antenna port(s) in the first (or second) DM-RS CDM group indicated by the antenna ports field in the DCI for PDSCH reception(s) when/if the UE 116 uses/applies the first indicated TCI state/pair of TCI states to receive (scheduling) PDCCH(s)/DCI(s)—following one or more examples described herein—that schedules the PDSCH(s) with the first (or second) DM-RS antenna ports in the first (or second) DM-RS CDM groups indicated by the antenna ports field in the DCI and the second indicated TCI state/pair of TCI states to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with second (or first) DM-RS antenna port(s) in the second (or first) DM-RS CDM group indicated by the antenna ports field in the DCI for PDSCH reception(s) when/if the UE 116 uses/applies the second indicated TCI state/pair of TCI states to receive (scheduling) PDCCH(s)/DCI(s)—following one or more examples described herein—that schedules the PDSCH(s) with the second (or first) DM-RS antenna ports in the second (or first) DM-RS CDM groups indicated by the antenna ports field in the DCI, and the first indicated TCI state/pair of TCI states to receive the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)) and the second indicated TCI state/pair of TCI states to receive the second PDSCH DM-RS(s) (or equivalently, the RS(s) in the RS set(s) provided in the second indicated TCI state/pair of TCI states could be QCL'ed with the second DM-RS antenna port(s) for PDSCH reception(s))—e.g., at the same time or simultaneously or in one beam/TCI state indication or update instance or in one slot, when/if the UE 116 uses/applies the first indicated TCI state/pair of TCI states and the second indicated TCI state/pair of TCI states to receive (scheduling) PDCCH(s)/DCI(s)—following one or more examples described herein—that (respectively) schedules the PDSCH(s) with the first and/or second DM-RS antenna ports, e.g., at the same time or simultaneously or in one beam/TCI state indication/update instance or in one slot.

Yet for another example, for N=2 or M=2, the UE 116 could use/apply the first indicated TCI state/pair of TCI states to receive first (or second) PDSCH DM-RS(s) in the first (or second) DM-RS CDM group indicated by the antenna ports field in a DCI (e.g., the scheduling DCI or the beam indication DCI with or without DL assignment). Equivalently, the RS(s) in the RS set(s) provided in the first indicated TCI state/pair of TCI states could be quasi-co-located (QCL'ed) with first (or second) DM-RS antenna port(s) in the first (or second) DM-RS CDM group indicated by the antenna ports field in the DCI for PDSCH reception(s) when/if the UE 116 uses/applies the first indicated TCI state/pair of TCI states to receive (scheduling) PDCCH(s)/DCI(s)—following one or more examples described herein—that schedules the PDSCH(s) with the first (or second) DM-RS antenna ports in the first (or second) DM-RS CDM groups indicated by the antenna ports field in the DCI and the second indicated TCI state/pair of TCI states to receive second (or first) PDSCH DM-RS(s) in the second (or first) DM-RS CDM group indicated by the antenna ports field in a DCI (e.g., the scheduling DCI or the beam indication DCI with or without DL assignment). Equivalently, the RS(s) in the RS set(s) provided in the second indicated TCI state/pair of TCI states could be quasi-co-located (QCL'ed) with second (or first) DM-RS antenna port(s) in the second (or first) DM-RS CDM group indicated by the antenna ports field in the DCI for PDSCH reception(s) when/if the UE 116 uses/applies the second indicated TCI state/pair of TCI states to receive (scheduling) PDCCH(s)/DCI(s)—following one or more examples described herein—that schedules the PDSCH(s) with the second (or first) DM-RS antenna ports in the second (or first) DM-RS CDM groups indicated by the antenna ports field in the DCI, and the first indicated TCI state/pair of TCI states to receive the second PDSCH DM-RS(s) (or equivalently, the RS(s) in the RS set(s) provided in the first indicated TCI state/pair of TCI states could be QCL'ed with the second DM-RS antenna port(s) for PDSCH reception(s)) and the second indicated TCI state/pair of TCI states to receive the first PDSCH DM-RS(s) (or equivalently, the RS(s) in the RS set(s) provided in the second indicated TCI state/pair of TCI states could be QCL'ed with the first DM-RS antenna port(s) for PDSCH reception(s))—e.g., at the same time or simultaneously or in one beam/TCI state indication or update instance or in one slot, when/if the UE 116 uses/applies the first indicated TCI state/pair of TCI states and the second indicated TCI state/pair of TCI states to receive (scheduling) PDCCH(s)/DCI(s)—following one or more examples described herein—that (respectively) schedules the PDSCH(s) with the second and/or first DM-RS antenna ports, e.g., at the same time or simultaneously or in one beam/TCI state indication/update instance or in one slot.

In yet another example, at time t, the UE 116 could use/apply the same TCI state(s)/pair(s) of TCI states used/applied for receiving reference PDCCH(s)/DCI(s)—e.g., following one or more examples described herein—to receive PDSCH(s). Equivalently, the UE 116 may assume that the DM-RS ports of PDSCH(s) are quasi co-located with the RS(s) with respect to the QCL parameter(s) used for monitoring/receiving the reference PDCCH(s)/DCI(s)—e.g., following one or more examples described herein. The reference PDCCH(s)/DCI(s) can be of any DCI format, e.g., DCI format 1_1 or 1_2. Furthermore, the reference PDCCH(s)/DCI(s) could correspond to PDCCH(s)/DCI(s) with DL assignment (i.e., the scheduling PDCCH(s)/DCI(s)) that is associated with or schedules the PDSCH(s).

Alternatively, the reference PDCCH(s)/DCI(s) could correspond to PDCCH(s)/DCI(s) with (unified) TCI state(s) indication/update—i.e., the beam indication DCI (e.g., DCI format 1_1/1_2 with or without DL assignment), wherein one or more TCI states/pairs of TCI states could be indicated/provided by one or more TCI codepoints of one or more TCI fields for receiving DL channels/signals such as PDCCH and PDSCH and/or transmitting UL channels such as PUCCH and PUSCH. In addition, the reference PDCCH(s)/DCI(s) could correspond to one or more or combination(s) of one or more examples described herein.

For example, the reference PDCCH(s)/DCI(s) could correspond to the latest or the most recent PDCCH(s)/DCI(s) received in time.

For another example, the reference PDCCH(s)/DCI(s) could correspond to the PDCCH(s)/DCI(s) that is received later in time and/or in the latest slot in which one or more CORESETs within the active BWP of the serving cell are monitored by the UE 116.

Yet for another example, the reference PDCCH(s)/DCI(s) could correspond to the latest or the most recent (received in time) PDCCH(s)/DCI(s) that is received before a reference application time Tref, and/or the latest or the most recent (received in time) PDCCH(s)/DCI(s) whose reference application time Tref has been reached/passed (e.g., less than or equal to, or greater than or equal to the time t).

Yet for another example, the reference PDCCH(s)/DCI(s) could correspond to the PDCCH(s)/DCI(s) that is received later in time and/or in the latest slot in which one or more CORESETs within the active BWP of the serving cell are monitored by the UE 116 and/or before a reference application time Tref.

Yet for another example, the reference PDCCH(s)/DCI(s) could correspond to the PDCCH(s)/DCI(s) that is received later in time and/or in the latest slot in which one or more CORESETs within the active BWP of the serving cell are monitored by the UE 116 whose reference application time Tref has been reached/passed (e.g., less than or equal to, or greater than or equal to the time t).

Yet for another example, the reference PDCCH(s)/DCI(s) could correspond to the second latest or the previous/prior PDCCH(s)/DCI(s) received in time.

Yet for another example, the reference PDCCH(s)/DCI(s) could correspond to the PDCCH(s)/DCI(s) that is received earlier in time and/or in the latest slot in which one or more CORESETs within the active BWP of the serving cell are monitored by the UE 116.

Yet for another example, the reference PDCCH(s)/DCI(s) could correspond to the second latest or the previous/prior (received in time) PDCCH(s)/DCI(s) that is received before a reference application time Tref, and/or the second latest or the previous/prior (received in time) PDCCH(s)/DCI(s) whose reference application time Tref has been reached/passed (e.g., less than or equal to, or greater than or equal to the time t).

Yet for another example, the reference PDCCH(s)/DCI(s) could correspond to the PDCCH(s)/DCI(s) that is received earlier in time and/or in the latest slot in which one or more CORESETs within the active BWP of the serving cell are monitored by the UE 116 and/or before a reference application time Tref.

Yet for another example, the reference PDCCH(s)/DCI(s) could correspond to the PDCCH(s)/DCI(s) that is received earlier in time and/or in the latest slot in which one or more CORESETs within the active BWP of the serving cell are monitored by the UE 116 whose reference application time Tref has been reached/passed (e.g., less than or equal to, or greater than or equal to the time t).

Here, the reference application time Tref could be determined according to one or more of: (1) Tref=0, (2) fixed in the system specifications, e.g., Tref=7 symbols, Tref=3 ms, etc., (3) selected/determined from a set of candidate values for application time, (4) provided/configured/indicated by the network 130 (e.g., from a set of candidate values for application time), e.g., via higher layer RRC signaling/parameter and/or MAC CE command and/or dynamic DCI based L1 signaling, (5) Tref=timeDurationForQCL, (6) Tref=BeamAppTime_r17, (7) Tref corresponds to the first slot that is at least BeamAppTime_r17 symbols after the last symbol of the PUCCH, and the first slot and the BeamAppTime_r17 symbols are both determined on the carrier with the smallest SCS among the carrier(s) applying the beam indication, and/or (8) the maximum (max) or minimum (min) between Tref determined according to one or more examples described herein and a reference time Tref, where Tref could be similarly determined according to one or more examples described herein. the UE 116 could follow one or more examples described herein by replacing the scheduling PDCCH(s)/DCI(s) in one or more examples described herein with the reference PDCCH(s)/DCI(s) in the one or more examples described herein to determine the first and/or second TCI state(s)/pair(s) of TCI states for PDCCH receptions—e.g., the first and/or second PDSCH(s) as specified herein, wherein the UE 116 could use/apply the first and/or second TCI state(s)/pair(s) of TCI states to receive/monitor the reference PDCCH(s)/DCIs following one or more examples described herein.

In yet another example, the UE 116 could use/apply the same TCI state(s)/pair(s) of TCI states used/applied for receiving reference PDCCH(s)/DCI(s)—e.g., following one or more examples described herein—to receive PDSCH(s). Equivalent, the UE 116 may assume that the DM-RS ports of PDSCH(s) are quasi co-located with the RS(s) with respect to the QCL parameter(s) used for monitoring/receiving the reference PDCCH(s)/DCI(s)—e.g., following one or more examples described herein. The reference PDCCH(s)/DCI(s) can be of any DCI format, e.g., DCI format 1_1 or 1_2. Furthermore, the reference PDCCH(s)/DCI(s) could correspond to PDCCH(s)/DCI(s) with DL assignment (i.e., the scheduling PDCCH(s)/DCI(s)) that is associated with or schedules the PDSCH(s).

Alternatively, the reference PDCCH(s)/DCI(s) could correspond to PDCCH(s)/DCI(s) with (unified) TCI state(s) indication/update—i.e., the beam indication DCI (e.g., DCI format 1_1/1_2 with or without DL assignment), wherein one or more TCI states/pairs of TCI states could be indicated/provided by one or more TCI codepoints of one or more TCI fields for receiving DL channels/signals such as PDCCH and PDSCH and/or transmitting UL channels such as PUCCH and PUSCH. In addition, the reference PDCCH(s)/DCI(s) could correspond to one or more or combination(s) of one or more of the following.

For example, the reference PDCCH(s)/DCI(s) could correspond to the PDCCH(s)/DCI(s) received in the CORESET associated with a monitored search space with the lowest CORESET ID or controlResourceSetId in the latest slot in which one or more CORESETs within the active BWP of the serving cell are monitored by the UE 116.

For another example, when/if a UE is configured with enableDefaultTCI-StatePerCoresetPoolIndex and/or the UE 116 is configured by higher layer parameter PDCCH-Config that contains two different values of CORESETPoolIndex or coresetPoolIndex in different CORESETs provided by ControlResourceSets, the UE 116 could use/apply the same TCI state(s)/pair(s) of TCI states used/applied for receiving reference PDCCH(s)/DCI(s) in the CORESET associated with a monitored search space with the lowest CORESET ID or controlResourceSetId among CORESETs, which are configured with the same value of CORESETPoolIndex or coresetPoolIndex as that associated to the PDSCH(s) or the PDCCH scheduling the PDSCH(s)—e.g., following one or more examples described herein—to receive the PDSCH(s) associated with the value of CORESETPoolIndex or coresetPoolIndex described herein, in the latest slot in which one or more CORESETs associated with the same value of CORESETPoolIndex or coresetPoolIndex as that associated to the PDSCH(s) or the PDCCH scheduling the PDSCH(s). Equivalently, the UE 116 may assume that the DM-RS ports of PDSCH(s) associated with a value of CORESETPoolIndex or coresetPoolIndex are quasi co-located with the RS(s) with respect to the QCL parameter(s) used for monitoring/receiving the reference PDCCH(s)/DCI(s)—e.g., following one or more examples described herein—in the CORESET associated with a monitored search space with the lowest CORESET ID or controlResourceSetId among CORESETs, which are configured with the same value of CORESETPoolIndex or coresetPoolIndex as that associated to the PDSCH(s) or the PDCCH scheduling the PDSCH(s), in the latest slot in which one or more CORESETs associated with the same value of CORESETPoolIndex or coresetPoolIndex as that associated to the PDSCH(s) or the PDCCH scheduling the PDSCH(s).

Yet for another example, when/if a UE is configured with enableDefaultTCI-StatePerCoresetGroupIndex and/or the UE 116 is configured by higher layer parameter PDCCH-Config that contains two different values of CORESETGroupIndex or coresetGroupIndex in different CORESETs provided by ControlResourceSets, the UE 116 could use/apply the same TCI state(s)/pair(s) of TCI states used/applied for receiving reference PDCCH(s)/DCI(s) in the CORESET associated with a monitored search space with the lowest CORESET ID or controlResourceSetId among CORESETs which are configured with the same value of CORESETGroupIndex or coresetGroupIndex as that associated to the PDSCH(s) or the PDCCH scheduling the PDSCH(s)—e.g., following one or more examples described herein—to receive the PDSCH(s) associated with the value of CORESETGroupIndex or coresetGroupIndex described herein in the latest slot in which one or more CORESETs associated with the same value of CORESETGroupIndex or coresetGroupIndex as that associated to the PDSCH(s) or the PDCCH scheduling the PDSCH(s). Equivalently, the UE 116 may assume that the DM-RS ports of PDSCH(s) associated with a value of CORESETGroupIndex or coresetGroupIndex are quasi co-located with the RS(s) with respect to the QCL parameter(s) used for monitoring/receiving the reference PDCCH(s)/DCI(s)—e.g., following one or more examples described herein—in the CORESET associated with a monitored search space with the lowest CORESET ID or controlResourceSetId among CORESETs, which are configured with the same value of CORESETGroupIndex or coresetGroupIndex as that associated to the PDSCH(s) or the PDCCH scheduling the PDSCH(s), in the latest slot in which one or more CORESETs associated with the same value of CORESETGroupIndex or coresetGroupIndex as that associated to the PDSCH(s) or the PDCCH scheduling the PDSCH(s).

The UE 116 could follow one or more examples described herein, by replacing the scheduling PDCCH(s)/DCI(s) in one or more examples described herein with the reference PDCCH(s)/DCI(s) in one or more examples described herein, to determine the first and/or second TCI state(s)/pair(s) of TCI states for PDCCH receptions—e.g., the first and/or second PDSCH(s) as specified herein, wherein the UE 116 could use/apply the first and/or second TCI state(s)/pair(s) of TCI states to receive/monitor the reference PDCCH(s)/DCIs following one or more examples described herein.

For the examples described herein, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein.

Throughout the present disclosure, unless otherwise specified, the first PDSCH(s) could correspond to all PDSCH(s)/PDSCH reception(s)—e.g., configured by the higher layer parameter PDSCH-Config or the first PDSCH DM-RS(s) or the first DM-RS antenna port(s) for PDSCH reception(s) or the first PDSCH DM-RS CDM group indicated by the antenna ports field in a DCI (e.g., the scheduling DCI or the beam indication DCI with or without DL assignment) or the first DM-RS(s) for PDSCH reception(s) in the first DM-RS CDM group indicated by the antenna ports field in a DCI (e.g., the scheduling DCI or the beam indication DCI with or without DL assignment) and the second PDSCH(s) could correspond to all PDSCH(s)/PDSCH reception(s)—e.g., configured by the higher layer parameter PDSCH-Config or the second PDSCH DM-RS(s) or the second DM-RS antenna port(s) for PDSCH reception(s) or the second PDSCH DM-RS CDM group indicated by the antenna ports field in a DCI (e.g., the scheduling DCI or the beam indication DCI with or without DL assignment) or the second DM-RS(s) for PDSCH reception(s) in the second DM-RS CDM group indicated by the antenna ports field in a DCI (e.g., the scheduling DCI or the beam indication DCI with or without DL assignment).

In one embodiment, the UE 116 could be indicated/provided/configured by the network 130, e.g., in a beam indication/activation MAC CE or beam indication DCI (e.g., DCI format 1_1 or 1_2 with or without DL assignment), one or more, e.g., N≥1 or M≥1 (e.g., N=2 or M=2), TCI states/pairs of TCI states for UE-dedicated DL channels/signals receptions and/or UL channels/signals transmissions. The indicated TCI states/pairs of TCI states could be different from the previously indicated (first and/or second) TCI states/pairs of TCI states described/discussed herein and can therefore be referred to as newly indicated TCI states/pairs of TCI states. In a beam indication DCI, the TCI state(s)/pair(s) of TCI states could be indicated/provided by one or more TCI codepoints in one or more TCI fields (e.g., the existing TCI field).

In one example, for N=1 or M=1, the (newly) indicated TCI state/pair of TCI states could be applied/used for all PDSCH receptions before or after the corresponding beam application time Tapp. For N=2 or M=2, the (newly) indicated first TCI state/pair of TCI states could be applied/used for all PDSCH receptions before or after the corresponding beam application time Tapp.

Alternatively, for N=2 or M=2, the (newly) indicated second TCI state/pair of TCI states could be applied/used for all PDSCH receptions before or after the corresponding beam application time Tapp. Optionally, for N=2 or M=2, both of the (newly) indicated first and second TCI states/pairs of TCI states could be applied/used for PDSCH reception(s), e.g., at the same time or simultaneously or in one beam/TCI state indication/update instance or in one slot, before or after the corresponding beam application time Tapp. Here, the beam application time Tapp could start from the first slot that is at least BeamAppTime_r17 symbols after the last symbol of the PUCCH.

In another example, the UE 116 could be indicated/provided/configured by the network 130, e.g., in a beam indication/activation MAC CE or beam indication DCI (e.g., DCI format 1_1 or 1_2 with or without DL assignment), a single TCI state/pair of TCI states (i.e., N=1 or M=1) for UE-dedicated DL channels/signals receptions and/or UL channels/signals transmissions. When/if the newly indicated TCI state/pair of TCI states correspond to the previously indicated first TCI state/pair of TCI states, the UE 116 could still use/apply the previously indicated first TCI state/pair of TCI states to receive the PDSCH(s) before or after the corresponding beam application time Tapp. Here, the beam application time Tapp could start from the first slot that is at least BeamAppTime_r17 symbols after the last symbol of the PUCCH.

Alternatively, the UE 116 could be indicated/provided/configured by the network 130, e.g., in a beam indication/activation MAC CE or beam indication DCI (e.g., DCI format 1_1 or 1_2 with or without DL assignment), two TCI states/pairs of TCI states (i.e., N=2 or M=2) for UE-dedicated DL channels/signals receptions and/or UL channels/signals transmissions. Both of the newly indicated TCI states/pairs of TCI states could be the same/identical, and they could correspond to the previously indicated first TCI state/pair of TCI states. For this case, the UE 116 could still use/apply the previously indicated first TCI state/pair of TCI states to receive the PDSCH(s) before or after the corresponding beam application time Tapp. Here, the beam application time Tapp could start from the first slot that is at least BeamAppTime_r17 symbols after the last symbol of the PUCCH.

In another example, the UE 116 could be indicated/provided/configured by the network 130, e.g., in a beam indication/activation MAC CE or beam indication DCI (e.g., DCI format 1_1 or 1_2 with or without DL assignment), a single TCI state/pair of TCI states (i.e., N=1 or M=1) for UE-dedicated DL channels/signals receptions and/or UL channels/signals transmissions. When/if the newly indicated TCI state/pair of TCI states correspond to the previously indicated second TCI state/pair of TCI states, the UE 116 could use/apply the previously indicated second TCI state/pair of TCI states to receive the PDSCH(s) before or after the corresponding beam application time Tapp. Here, the beam application time Tapp could start from the first slot that is at least BeamAppTime_r17 symbols after the last symbol of the PUCCH. Optionally, the UE 116 could be indicated/provided/configured by the network 130, e.g., in a beam indication/activation MAC CE or beam indication DCI (e.g., DCI format 1_1 or 1_2 with or without DL assignment), a single TCI state/pair of TCI states (i.e., N=1 or M=1) for UE-dedicated DL channels/signals receptions and/or UL channels/signals transmissions. The newly indicated TCI state/pair of TCI states could be different from the previously indicated first and/or second TCI states/pairs of TCI states. For this case, the UE 116 could use/apply the newly indicated TCI state/pair of TCI states to receive the PDSCH(s) before or after the corresponding beam application time Tapp. Here, the beam application time Tapp could start from the first slot that is at least BeamAppTime_r17 symbols after the last symbol of the PUCCH.

Alternatively, the UE 116 could be indicated/provided/configured by the network 130, e.g., in a beam indication/activation MAC CE or beam indication DCI (e.g., DCI format 1_1 or 1_2 with or without DL assignment), two TCI states/pairs of TCI states (i.e., N=2 or M=2) for UE-dedicated DL channels/signals receptions and/or UL channels/signals transmissions. Both of the newly indicated TCI states/pairs of TCI states could be the same/identical. Furthermore, they could correspond to the previously indicated second TCI state/pair of TCI states or they could be different from the previously indicated first and/or second TCI states/pairs of TCI states (they both correspond to a newly indicated TCI state/pair of TCI states). For this case, the UE 116 could use/apply the previously indicated second TCI state/pair of TCI states or the newly indicated TCI state/pair of TCI states, to receive the PDSCH(s) before or after the corresponding beam application time Tapp. Here, the beam application time Tapp could start from the first slot that is at least BeamAppTime_r17 symbols after the last symbol of the PUCCH.

In yet another example, the UE 116 could be indicated/provided/configured by the network 130, e.g., in a beam indication/activation MAC CE or beam indication DCI (e.g., DCI format 1_1 or 1_2 with or without DL assignment), two TCI states/pairs of TCI states (i.e., N=2 or M=2) for UE-dedicated DL channels/signals receptions and/or UL channels/signals transmissions. The newly indicated first TCI state/pair of TCI states could be the same as or different from the previously indicated first (or second) TCI state/pair of TCI states, and/or the newly indicated second TCI state/pair of TCI states could be the same as or different from the previously indicated second (or first) TCI state/pair of TCI states. For this case, the UE 116 could use/apply the newly indicated first TCI state/pair of TCI states (e.g., corresponding to the previously indicated first or second TCI state/pair of TCI states) to receive the first (or second) PDSCH(s) before or after the corresponding beam application time Tapp, and the newly indicated second TCI state/pair of TCI states (e.g., corresponding to the previously indicated first or second TCI state/pair of TCI states) to receive the second (or first) PDSCH(s) before or after the corresponding beam application time Tapp. Here, the beam application time Tapp could start from the first slot that is at least BeamAppTime_r17 symbols after the last symbol of the PUCCH.

In yet another example, the UE 116 could be indicated/provided/configured by the network 130, e.g., in a beam indication/activation MAC CE or beam indication DCI (e.g., DCI format 1_1 or 1_2 with or without DL assignment), two TCI states/pairs of TCI states (i.e., N=2 or M=2) for UE-dedicated DL channels/signals receptions and/or UL channels/signals transmissions. The newly indicated first TCI state/pair of TCI states could be the same as or different from the previously indicated first (or second) TCI state/pair of TCI states and/or the newly indicated second TCI state/pair of TCI states could be the same as or different from the previously indicated second (or first) TCI state/pair of TCI states. For this case, the UE 116 could use/apply the newly indicated first TCI state/pair of TCI states (e.g., corresponding to the previously indicated first or second TCI state/pair of TCI states) to receive the first (or second) PDSCH DM-RS(s) (or equivalently, the RS(s) in the RS set(s) provided in the newly indicated first TCI state/pair of TCI states could be QCL'ed with the first (or second) DM-RS antenna port(s) for PDSCH reception(s)) before or after the corresponding beam application time Tapp, and the newly indicated second TCI state/pair of TCI states (e.g., corresponding to the previously indicated first or second TCI state/pair of TCI states) to receive the second (or first) PDSCH DM-RS(s) (or equivalently, the RS(s) in the RS set(s) provided in the newly indicated second TCI state/pair of TCI states could be QCL'ed with the second (or first) DM-RS antenna port(s) for PDSCH reception(s)) before or after the corresponding beam application time Tapp. Here, the beam application time Tapp could start from the first slot that is at least BeamAppTime_r17 symbols after the last symbol of the PUCCH.

In yet another example, the UE 116 could be indicated/provided/configured by the network 130, e.g., in a beam indication/activation MAC CE or beam indication DCI (e.g., DCI format 1_1 or 1_2 with or without DL assignment), two TCI states/pairs of TCI states (i.e., N=2 or M=2) for UE-dedicated DL channels/signals receptions and/or UL channels/signals transmissions. One or more of the TCI field bits—denoted by beam association TCI field bit(s)—of the TCI field(s) in the beam indication DCI (e.g., DCI format 1_1/1_2 with or without DL assignment) could be used/repurposed/applied to indicate which of the TCI states/pairs of TCI states indicated by/via one or more TCI codepoints of the TCI field(s)—using one or more of the TCI field bits denoted by beam indication TCI field bit(s)—could be used/applied for PDSCH reception(s).

For example, the beam association TCI field bit could be the most significant bits (MSB) or the least significant bits (LSB) (i.e., a one-bit indicator) of the total/maximum TCI field bits of the TCI field(s) in the beam indication DCI.

For another example, the beam association TCI field bits could be the first two bits (or the first two MSBs) or the last two bits (or the last two LSBs) (i.e., a two-bit indicator) of the total/maximum TCI field bits of the TCI field(s) in the beam indication DCI.

Yet for another example, the UE 116 could be provided/indicated/configured by the network 130, e.g., via higher layer RRC signaling/parameter and/or MAC CE command and/or dynamic DCI based L1 signaling, which of the total/maximum TCI field bits of the TCI field(s) could be used/applied as the beam association TCI field bit(s) or the beam indication TCI field bit(s).

For example, the beam association TCI field bit could be a one-bit indicator, e.g., corresponding to the MSB or the LSB (i.e., a one-bit indicator) of the total/maximum TCI field bits of the TCI field(s) in the beam indication DCI and/or configured/provided/indicated by the network 130. When/if the beam association TCI field bit is set to ‘0’, the first indicated TCI state/pair of TCI states could be applied/used for all PDSCH receptions before or after a beam association application time Tassoc and when/if the beam association TCI field bit is set to ‘1’, the second indicated TCI state/pair of TCI states could be applied/used for all PDSCH receptions before or after a beam association application time Tassoc.

For another example, the beam association TCI field bit could be a one-bit indicator, e.g., corresponding to the MSB or the LSB (i.e., a one-bit indicator) of the total/maximum TCI field bits of the TCI field(s) in the beam indication DCI and/or configured/provided/indicated by the network 130. When/if the beam association TCI field bit is set to ‘0’, the second indicated TCI state/pair of TCI states could be applied/used for all PDSCH receptions before or after a beam association application time Tassoc and when/if the beam association TCI field bit is set to ‘1’, the first indicated TCI state/pair of TCI states could be applied/used for all PDSCH receptions before or after a beam association application time Tassoc.

In yet another example, the beam association TCI field bit could be a one-bit indicator, e.g., corresponding to the MSB or the LSB (i.e., a one-bit indicator) of the total/maximum TCI field bits of the TCI field(s) in the beam indication DCI and/or configured/provided/indicated by the network 130. When/if the beam association TCI field bit is set to ‘0’ (or ‘1’), the first indicated TCI state/pair of TCI states could be applied/used for receiving the first PDSCH(s) and the second indicated TCI state/pair of TCI states could be applied/used for receiving the second PDSCH(s), before or after a beam association application time Tassoc. When/if the beam association TCI field bit is set to ‘1’ (or ‘0’), the first indicated TCI state/pair of TCI states could be applied/used for receiving the second PDSCH(s) and the second indicated TCI state/pair of TCI states could be applied/used for receiving the first PDSCH(s), before or after a beam association application time Tassoc. The UE 116 could be configured/indicated/provided by the network 130, e.g., via higher layer RRC signaling/parameter and/or MAC CE command and/or dynamic DCI based L1 signaling, the first and/or second PDSCHs and their corresponding/respective configuration information.

In yet another example, the beam association TCI field bit could be a one-bit indicator, e.g., corresponding to the MSB or the LSB (i.e., a one-bit indicator) of the total/maximum TCI field bits of the TCI field(s) in the beam indication DCI and/or configured/provided/indicated by the network 130. When/if the beam association TCI field bit is set to ‘0’ (or ‘1’), the first indicated TCI state/pair of TCI states could be applied/used for all PDSCH receptions before or after a beam association application time Tassoc. When/if the beam association TCI field bit is set to ‘1’ (or ‘0’) the first indicated TCI state/pair of TCI states could be applied/used for receiving the first (or second) PDSCH(s) and the second indicated TCI state/pair of TCI states could be applied/used for receiving the second (or first) PDSCH(s), before or after a beam association application time Tassoc. The UE 116 could be configured/indicated/provided by the network 130, e.g., via higher layer RRC signaling/parameter and/or MAC CE command and/or dynamic DCI based L1 signaling, the first and/or second PDSCHs and their corresponding/respective configuration information.

In yet another example, the beam association TCI field bit could be a one-bit indicator, e.g., corresponding to the MSB or the LSB (i.e., a one-bit indicator) of the total/maximum TCI field bits of the TCI field(s) in the beam indication DCI and/or configured/provided/indicated by the network 130. When/if the beam association TCI field bit is set to ‘0’ (or ‘1’), the second indicated TCI state/pair of TCI states could be applied/used for all PDSCH receptions before or after a beam association application time Tassoc. When/if the beam association TCI field bit is set to ‘1’ (or ‘0’), the first indicated TCI state/pair of TCI states could be applied/used for receiving the first (or second) PDSCH(s) and the second indicated TCI state/pair of TCI states could be applied/used for receiving the second (or first) PDSCH(s), before or after a beam association application time Tassoc. The UE 116 could be configured/indicated/provided by the network 130, e.g., via higher layer RRC signaling/parameter and/or MAC CE command and/or dynamic DCI based L1 signaling, the first and/or second PDSCHs and their corresponding/respective configuration information.

In yet another example, the beam association TCI field bit could be a one-bit indicator, e.g., corresponding to the MSB or the LSB (i.e., a one-bit indicator) of the total/maximum TCI field bits of the TCI field(s) in the beam indication DCI and/or configured/provided/indicated by the network 130. When/if the beam association TCI field bit is set to ‘0’ (or ‘1’), the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)) before or after a beam association application time Tassoc, the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)) before or after a beam association application time Tassoc. When/if the beam association TCI field bit is set to ‘1’ (or ‘0’), the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)) before or after a beam association application time Tassoc, and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)) before or after a beam association application time Tassoc.

In yet another example, the beam association TCI field bits could be a two-bit indicator, e.g., corresponding to the first two bits (or the first two MSBs) or the last two bits (or the last two LSBs) of the total/maximum TCI field bits of the TCI field(s) in the beam indication DCI and/or configured/provided/indicated by the network 130. When/if the beam association TCI field bits are set to ‘00’ (‘01’, ‘10’, or ‘11’), the first indicated TCI state/pair of TCI states could be applied/used for all PDSCH receptions before or after a beam association application time Tassoc. When/if the beam association TCI field bits are set to ‘01’ (‘00’, ‘10’, or ‘11’), the second indicated TCI state/pair of TCI states could be applied/used for all PDSCH receptions before or after a beam association application time Tassoc. When/if the beam association TCI field bits are set to ‘10’ (‘00’, ‘01’, or ‘11’), the first indicated TCI state/pair of TCI states could be applied/used for receiving the first PDSCH(s), and the second indicated TCI state/pair of TCI states could be applied/used for receiving the second PDSCH(s), before or after a beam association application time Tassoc, and when/if the beam association TCI field bits are set to ‘11’ (‘00’, ‘01’, or ‘10’), the first indicated TCI state/pair of TCI states could be applied/used for receiving the second PDSCH(s), and the second indicated TCI state/pair of TCI states could be applied/used for receiving the first PDSCH(s), before or after a beam association application time Tassoc.

In yet another example, the beam association TCI field bits could be a two-bit indicator, e.g., corresponding to the first two bits (or the first two MSBs) or the last two bits (or the last two LSBs) of the total/maximum TCI field bits of the TCI field(s) in the beam indication DCI and/or configured/provided/indicated by the network 130. When/if the beam association TCI field bits are set to ‘00’ (‘01’, ‘10’, or ‘11’), the first indicated TCI state/pair of TCI states could be applied/used for all PDSCH receptions before or after a beam association application time Tassoc. When/if the beam association TCI field bits are set to ‘01’ (‘00’, ‘10’, or ‘11’), the second indicated TCI state/pair of TCI states could be applied/used for all PDSCH receptions before or after a beam association application time Tassoc. When/if the beam association TCI field bits are set to ‘10’ (‘00’, ‘01’, or ‘11’), the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)) and the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), before or after a beam association application time Tassoc. When/if the beam association TCI field bits are set to ‘11’ (‘00’, ‘01’, or ‘10’), the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)) before or after a beam association application time Tassoc.

The UE 116 could be indicated/configured/provided/informed by the network 130, e.g., via higher layer RRC signaling/parameter and/or MAC CE command and/or dynamic DCI based L1 signaling, whether one or more of the TCI field bits of the TCI field(s) in the beam indication DCI could be used/repurposed as the beam association TCI field bit(s). Furthermore, the beam association application time Tassoc could be determined according to one or more of: (1) Tassoc=0, (2) fixed in the system specifications, e.g., Tassoc=7 symbols, Tassoc=3 ms, etc., (3) selected/determined from a set of candidate values for application time, (4) provided/configured/indicated by the network 130 (e.g., from a set of candidate values for application time), e.g., via higher layer RRC signaling/parameter and/or MAC CE command and/or dynamic DCI based L1 signaling, (5) Tassoc=timeDurationForQCL, (6) Tassoc=BeamAppTime_r17, (7) Tassoc corresponds to the first slot that is at least BeamAppTime_r17 symbols after the last symbol of the PUCCH, and the first slot and the BeamAppTime_r17 symbols are both determined on the carrier with the smallest SCS among the carrier(s) applying the beam association, and/or (8) the maximum (max) or minimum (min) between Tassoc determined according to one or more examples described herein and another beam association application time Tassoc', where Tassoc' could be similarly determined according to one or more examples described herein.

In yet another example, a TCI codepoint—among all the TCI codepoints activated/provided by the beam indication/activation MAC CE, e.g., the Unified TCI States Activation/Deactivation MAC CE or Enhanced Unified TCI States Activation/Deactivation MAC CE—indicated/provided in the TCI field(s) in the beam indication DCI could contain/comprise/include two parts, wherein the first part could indicate/provide the first (or second) indicated TCI state/pair of TCI states and the second part could indicate/provide the second (or first) indicated TCI state/pair. The first (or second) part could be absent/not present/not configured/not provided or set to ‘none’, ‘off’, ‘disabled’ or invalid value(s) such as invalid TCI state ID(s).

For example, when/if the second (or first) part is absent/not present/not configured/not provided or set to ‘none’, ‘off’, ‘disabled’ or invalid value(s) such as invalid TCI state ID(s), the first indicated TCI state/pair of TCI states could be applied/used for all PDSCH receptions before or after a beam association application time Tassoc. When/if the first (or second) part is absent/not present/not configured/not provided or set to ‘none’, ‘off’, ‘disabled’ or invalid value(s) such as invalid TCI state ID(s), the second indicated TCI state/pair of TCI states could be applied/used for all PDSCH receptions before or after a beam association application time Tassoc.

For another example, when/if both of the first and second parts are present/configured/provided or set to ‘on’, ‘enabled’ or valid values such as valid TCI state IDs for the first and second indicated TCI states/pairs of TCI states, the first indicated TCI state/pair of TCI states could be applied/used for receiving the first PDSCH(s), and the second indicated TCI state/pair of TCI states could be applied/used for receiving the second PDSCH(s), before or after a beam association application time Tassoc.

Alternatively, when/if both of the first and second parts are present/configured/provided or set to ‘on’, ‘enabled’ or valid values such as valid TCI state IDs for the first and second indicated TCI states/pairs of TCI states, the first indicated TCI state/pair of TCI states could be applied/used for receiving the second PDSCH(s) and the second indicated TCI state/pair of TCI states could be applied/used for receiving the first PDSCH(s), before or after a beam association application time Tassoc. The UE 116 could be configured/indicated/provided by the network 130, e.g., via higher layer RRC signaling/parameter and/or MAC CE command and/or dynamic DCI based L1 signaling, the first and/or second PDSCHs and their corresponding/respective configuration information.

In yet another example, when/if both of the first and second parts are present/configured/provided or set to ‘on’, ‘enabled’ or valid values such as valid TCI state IDs for the first and second indicated TCI states/pairs of TCI states, the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)) before or after a beam association application time Tassoc. The second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)) before or after a beam association application time Tassoc.

Alternatively, when/if both of the first and second parts are present/configured/provided or set to ‘on’, ‘enabled’ or valid values such as valid TCI state IDs for the first and second indicated TCI states/pairs of TCI states, the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)) before or after a beam association application time Tassoc and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)) before or after a beam association application time Tassoc.

The beam association application time Tassoc could be determined according to one or more of: (1) Tassoc=0, (2) fixed in the system specifications, e.g., Tassoc=7 symbols, Tassoc=3 ms, etc., (3) selected/determined from a set of candidate values for application time, (4) provided/configured/indicated by the network 130 (e.g., from a set of candidate values for application time), e.g., via higher layer RRC signaling/parameter and/or MAC CE command and/or dynamic DCI based L1 signaling, (5) Tassoc=timeDurationForQCL, (6) Tassoc=BeamAppTime_r17, (7) Tassoc corresponds to the first slot that is at least BeamAppTime_r17 symbols after the last symbol of the PUCCH, and the first slot and the BeamAppTime_r17 symbols are both determined on the carrier with the smallest SCS among the carrier(s) applying the beam association, and/or (8) the maximum (max) or minimum (min) between Tassoc determined according to one or more examples described herein and another beam association application time Tassoc', where Tassoc' could be similarly determined according to one or more examples described herein.

In yet another example, the UE could be indicated/provided/configured by the network 130, e.g., in a beam indication/activation MAC CE or beam indication DCI (e.g., DCI format 1_1 or 1_2 with or without DL assignment), two TCI states/pairs of TCI states (i.e., N=2 or M=2) for UE-dedicated DL channels/signals receptions and/or UL channels/signals transmissions. For this case, the UE could follow the indicator/parameter provided/indicated/configured in PDSCH-Config described herein (e.g., following one or more examples described herein), the fixed rule(s) described herein (e.g., following one or more examples described herein), the predefined rule(s) described herein (e.g., following one or more examples described herein), or the DCI field indicator in the DCI (e.g., the scheduling DCI or the beam indication DCI with or without DL assignment) as specified herein to determine the association between the indicated TCI state(s) and the PDSCH reception(s), or equivalently, which of the indicated TCI state(s) to use for PDSCH reception(s).

In yet another example, the UE could be indicated/provided/configured by the network 130, e.g., in a beam indication/activation MAC CE or beam indication DCI (e.g., DCI format 1_1 or 1_2 with or without DL assignment), a single TCI state/pair of TCI states (i.e., N=1 or M=1) for UE-dedicated DL channels/signals receptions and/or UL channels/signals transmissions. The UE 116 could be indicated/configured/provided/informed by the network 130, e.g., via higher layer RRC signaling/parameter and/or MAC CE command and/or dynamic DCI based L1 signaling, that the (newly) indicated TCI state/pair of TCI states could be a TCI state/pair of TCI states update for one of the (previously) indicated TCI states/pairs of TCI states—i.e., the UE 116 could assume that one of the (previously) indicated TCI states/pairs of TCI states is replaced/updated with/by the (newly) indicated TCI state/pair of TCI states—also referred to as the updated TCI state/pair of TCI states—and the other one of the (previously) indicated TCI states/pairs of TCI states are unchanged and the UE 116 could use/apply the updated TCI state/pair of TCI states and the other one of the (previously) indicated TCI states/pairs of TCI states for PDSCH reception(s).

For example, the UE 116 could assume that the (previously) indicated first TCI state/pair of TCI states is replaced/updated with/by the (newly) indicated TCI state/pair of TCI states—also referred to as the updated first TCI state/pair of TCI states. The UE 116 could then use/apply the updated first TCI state/pair of TCI states and/or the (previously) indicated second TCI state/pair of TCI states for PDSCH reception(s) before or after a beam application Tapp following one or more examples described herein.

Alternatively, the UE 116 could assume that the (previously) indicated second TCI state/pair of TCI states is replaced/updated with/by the (newly) indicated TCI state/pair of TCI states—also referred to as the updated second TCI state/pair of TCI states. The UE 116 could then use/apply the (previously) indicated first TCI state/pair of TCI states and/or the updated second TCI state/pair of TCI states for PDSCH reception(s) before or after a beam application time Tapp following one or more examples described herein.

For another example, the UE 116 could be indicated/configured/provided by the network 130 via higher layer RRC signaling/parameter, e.g., an indicator/parameter provided in PD SCH-Config/PDC CH-Config/ControlResourceSet, which one of the (previously) indicated TCI states/pairs of TCI states could be updated/replaced by/with the (newly) indicated TCI state/pair of TCI states. For instance, when/if the higher layer indicator/parameter is set to ‘0’ or (‘1’), the UE 116 could assume that the (previously) indicated first TCI state/pair of TCI states is replaced/updated with/by the (newly) indicated TCI state/pair of TCI states—also referred to as the updated first TCI state/pair of TCI states. The UE 116 could then use/apply the updated first TCI state/pair of TCI states and/or the (previously) indicated second TCI state/pair of TCI states for PDSCH reception(s) before or after a beam application Tapp following one or more examples described herein.

Alternatively, when/if the higher layer indicator/parameter is set to ‘1’ or (‘0’), the UE 116 could assume that the (previously) indicated second TCI state/pair of TCI states is replaced/updated with/by the (newly) indicated TCI state/pair of TCI states—also referred to as the updated second TCI state/pair of TCI states. The UE 116 could then use/apply the (previously) indicated first TCI state/pair of TCI states and/or the updated second TCI state/pair of TCI states for PDSCH reception(s) before or after a beam application time Tapp following one or more examples described herein.

Yet for another example, the UE 116 could be indicated/configured/provided by the network 130 via MAC CE command, e.g., the Unified TCI States Activation/Deactivation MAC CE or Enhanced Unified TCI States Activation/Deactivation MAC CE, which one of the (previously) indicated TCI states/pairs of TCI states could be updated/replaced by/with the (newly) indicated TCI state/pair of TCI states. For instance, a TCI codepoint that is activated/provided by the MAC CE command could be associated to an indicator/parameter, where the indicator/parameter could also be indicated/provided in the MAC CE command. When/if the indicator/parameter associated to the TCI codepoint that provides the (newly) indicated TCI state/pair of TCI states in the TCI field(s) in the beam indication DCI is set to ‘0’ (or ‘1’), the UE 116 could assume that the (previously) indicated first TCI state/pair of TCI states is replaced/updated with/by the (newly) indicated TCI state/pair of TCI states—also referred to as the updated first TCI state/pair of TCI states. The UE 116 could then use/apply the updated first TCI state/pair of TCI states and/or the (previously) indicated second TCI state/pair of TCI states for PDSCH reception(s) before or after a beam application time Tapp following one or more examples described herein. When/if the indicator/parameter associated to the TCI codepoint that provides the (newly) indicated TCI state/pair of TCI states in the TCI field(s) in the beam indication DCI is set to ‘1’ (or ‘0’), the UE 116 could assume that the (previously) indicated second TCI state/pair of TCI states is replaced/updated with/by the (newly) indicated TCI state/pair of TCI states—also referred to as the updated second TCI state/pair of TCI states. The UE 116 could then use/apply the updated second TCI state/pair of TCI states and/or the (previously) indicated first TCI state/pair of TCI states for PDSCH reception(s) before or after a beam application time Tapp following one or more examples described herein.

Yet for another example, the UE 116 could be indicated/configured/provided by the network 130 via dynamic DCI based L1 signaling, e.g., an indicator/parameter provided in a DCI—e.g., a beam indication DCI (e.g., DCI format 1_1/1_2 with or without DL assignment) that carries one or more unified TCI states/pairs of TCI states, which one of the (previously) indicated TCI states/pairs of TCI states could be updated/replaced by/with the (newly) indicated TCI state/pair of TCI states. For instance, when/if the DCI indicator/parameter is set to ‘0’ or (‘1’), the UE 116 could assume that the (previously) indicated first TCI state/pair of TCI states is replaced/updated with/by the (newly) indicated TCI state/pair of TCI states—also referred to as the updated first TCI state/pair of TCI states. The UE 116 could then use/apply the updated first TCI state/pair of TCI states and/or the (previously) indicated second TCI state/pair of TCI states for PDSCH reception(s) before or after a beam application Tapp following one or more examples described herein.

Alternatively, when/if the DCI indicator/parameter is set to ‘1’ or (‘0’), the UE 116 could assume that the (previously) indicated second TCI state/pair of TCI states is replaced/updated with/by the (newly) indicated TCI state/pair of TCI states—also referred to as the updated second TCI state/pair of TCI state. The UE 116 could then use/apply the (previously) indicated first TCI state/pair of TCI states and/or the updated second TCI state/pair of TCI states for PDSCH reception(s) before or after a beam application time Tapp following one or more examples described herein. Here, the DCI indicator/parameter discussed herein could be a new DCI field introduced in a DCI format dedicated for indicating which one of the (previously) indicated TCI states/pairs of TCI states could be updated/replaced by/with the (newly) indicated TCI state/pair of TCI states. Optionally, the DCI indicator/parameter discussed herein could correspond to one or more field bits of one or more existing DCI fields (e.g., the TCI field(s)) in a DCI format repurposed for indicating which one of the (previously) indicated TCI states/pairs of TCI states could be updated/replaced by/with the (newly) indicated TCI state/pair of TCI states.

The UE 116 could be provided/configured/indicated by the network 130, e.g., via higher layer RRC signaling/parameter and/or MAC CE command and/or dynamic DCI based L1 signaling, following one or more examples described herein to determine the association between the indicated TCI state(s) and the PDSCH reception(s). For instance, a higher layer parameter ‘dynamicBeamSelectionTCI’ can be provided/configured/indicated in, e.g., PDSCH-Config. When/if the higher layer parameter ‘dynamicBeamSelectionTCI’ is set to ‘enabled’, the UE 116 could follow one or more examples described herein to determine the association between the indicated TCI state(s) and the PDSCH reception(s). Furthermore, the beam application time Tapp could be determined according to one or more of: (1) Tapp=0, (2) fixed in the system specifications, e.g., Tapp=7 symbols, Tapp=3 ms, etc., (3) selected/determined from a set of candidate values for application time, (4) provided/configured/indicated by the network 130 (e.g., from a set of candidate values for application time), e.g., via higher layer RRC signaling/parameter and/or MAC CE command and/or dynamic DCI based L1 signaling, (5) Tapp=timeDurationForQCL, (6) Tapp=BeamAppTime_r17, (7) Tapp corresponds to the first slot that is at least BeamAppTime_r17 symbols after the last symbol of the PUCCH, and the first slot and the BeamAppTime_r17 symbols are both determined on the carrier with the smallest SCS among the carrier(s) applying the beam indication, and/or (8) the maximum (max) or minimum (min) between Tapp determined according to one or more examples described herein and another beam application time Tapp′, where Tapp′ could be similarly determined according to one or more examples described herein.

As specified herein, the UE 116 could be indicated/provided/configured by the network 130, e.g., via a first beam indication/activation MAC CE or a first beam indication DCI (e.g., by a TCI codepoint), or the UE 116 could use/apply, a set of a first TCI state/pair of TCI states and/or a second TCI state/pair of TCI states for at least UE-dedicated reception(s) on PDSCH(s)/PDCCH(s) or dynamic-grant/configured-grant based PUSCH(s) and all of dedicated PUCCH resources, wherein a TCI state could correspond to a joint DL and UL TCI state or a separate DL TCI state provided by DLorJoint-TCIState or a separate UL TCI state provided by ULTCI-State. Later in time, the UE 116 could be indicated/provided/configured by the network 130, e.g., via a second beam indication/activation MAC CE or a second beam indication DCI (e.g., by a TCI codepoint), a third TCI state/pair of TCI states, wherein a TCI state could correspond to a joint DL and UL TCI state or a separate DL TCI state provided by DLorJoint-TCIState or a separate UL TCI state provided by ULTCI-State. The UE 116 could use/apply the indicated third TCI state/pair of TCI states to replace/update one of the first and second TCI states/pairs of TCI states (e.g., the first) as specified herein and use/apply the indicated third TCI state/pair of TCI states and/or the other one of the first and second TCI states/pairs of TCI states (e.g., the second) that is not updated/replaced by the indicated third TCI state/pair of TCI states for at least UE-dedicated reception(s) on PDSCH(s)/PDCCH(s) or dynamic-grant/configured-grant based PUSCH(s) and all of dedicated PUCCH resources. The UE 116 could be indicated/provided/configured by the network 130, e.g., via higher layer RRC signaling and/or MAC CE command and/or dynamic DCI based L1 signaling, which one of the first and second TCI states/pairs of TCI states could be updated/replaced by the indicated third TCI state/pair of TCI states.

In one example, one or more first fields/indicators/parameters could be provided/configured/indicated in a beam indication/activation MAC CE, e.g., (Enhanced) Unified TCI States Activation/Deactivation MAC CE, to indicate whether the TCI state(s)/TCI state ID(s)—associated/corresponding to the first field(s)/indicator(s)/parameter(s) and mapped to a TCI codepoint—indicated therein corresponds to a single set of TCI state(s) or two sets of TCI states. For instance, if the first field(s)/indicator(s)/parameter(s) is set to ‘0’ (or ‘1’) or other equivalent value(s), the TCI state(s)/TCI state ID(s)—associated/corresponding to the first field(s)/indicator(s)/parameter(s) and mapped to a TCI codepoint—indicated in the beam indication/activation MAC CE could correspond to a single set of TCI state(s). Otherwise, if the first field(s)/indicator(s)/parameter(s) is set to ‘1’ (or ‘0’) or other equivalent value(s), the TCI state(s)/TCI state ID(s)—associated/corresponding to the first field(s)/indicator(s)/parameter(s) and mapped to a TCI codepoint—indicated in the beam indication/activation MAC CE could correspond to two sets of TCI states. Here, a set of TCI state(s) could correspond a joint DL and UL TCI state provided by DLorJointTCI-State, a separate DL TCI state provided by DLorJointTCI-State, a separate UL TCI state provided by ULTCI-State, and/or a pair of separate DL and UL TCI states. Furthermore, one or more second fields/indicators/parameters could be provided/configured/indicated in a beam indication/activation MAC CE, e.g., (Enhanced) Unified TCI States Activation/Deactivation MAC CE, and associated to TCI state(s)/TCI state ID(s)—indicated in the MAC CE and mapped to a TCI codepoint—that corresponds to a single set of TCI state(s) as specified herein.

For instance, when/if the second field(s)/indicator(s)/parameter(s) is set to ‘0’ (or ‘1’) or other equivalent value(s), the TCI state(s)/TCI state ID(s)—provided in the MAC CE and mapped to a TCI codepoint—associated/corresponding to the second field(s)/indicator(s)/parameter(s) could be used/applied, i.e., when indicated/applied/activated by the beam indication MAC CE/DCI (e.g., the third TCI state/pair of TCI states indicated via the second beam indication/activation MAC CE or the second beam indication DCI in a beam indication instance as specified herein) to update/replace the first TCI state/pair of TCI states as specified herein. For this case, the UE 116 could use/apply the indicated third TCI state/pair of TCI states and/or the second TCI state/pair of TCI states—e.g., in the order of {the 1st set of TCI state(s): the indicated third TCI state/pair of TCI states, the 2 nd set of TCI state(s): the second TCI state/pair of TCI states} or {the 1st set of TCI state(s): the second TCI state/pair of TCI states, the 2nd set of TCI state(s): the indicated third TCI state/pair of TCI states}—for at least UE-dedicated reception(s) on PDSCH(s)/PDCCH(s) or dynamic-grant/configured-grant based PUSCH(s) and all of dedicated PUCCH resources.

When/if the second field(s)/indicator(s)/parameter(s) is set to ‘1’ (or ‘0’) or other equivalent value(s), the TCI state(s)/TCI state ID(s)—provided in the MAC CE and mapped to a TCI codepoint—associated/corresponding to the second field(s)/indicator(s)/parameter(s) could be used/applied, i.e., when indicated/applied/activated by the beam indication MAC CE/DCI (e.g., the third TCI state/pair of TCI states indicated via the second beam indication/activation MAC CE or the second beam indication DCI in a beam indication instance as specified herein) to update/replace the second TCI state/pair of TCI states as specified herein. For this case, the UE 116 could use/apply the indicated third TCI state/pair of TCI states and/or the first TCI state/pair of TCI states—e.g., in the order of {the 1st set of TCI state(s): the indicated third TCI state/pair of TCI states, the 2nd set of TCI state(s): the first TCI state/pair of TCI states} or {the Pt set of TCI state(s): the first TCI state/pair of TCI states, the 2nd set of TCI state(s): the indicated third TCI state/pair of TCI states}—for at least UE-dedicated reception(s) on PDSCH(s)/PDCCH(s) or dynamic-grant/configured-grant based PUSCH(s) and all of dedicated PUCCH resources.

In another example, for mapping to a TCI codepoint, the beam indication/activation MAC CE, e.g., (Enhanced) Unified TCI States Activation/Deactivation MAC CE, could provide/indicate a first set of MAC CE entry(s)/field(s) and a second set of MAC CE entry(s)/field(s), wherein each set of MAC CE entry(s)/field(s) could indicate/provide one or more (e.g., two) TCI states/TCI state IDs. The UE 116 could be indicated/provided/configured by the network 130, e.g., via higher layer RRC signaling/parameter or MAC CE command (e.g., within the same beam indication/activation MAC CE) or dynamic DCI based L1 signaling, which one or more of the MAC CE entries/fields for mapping to a TCI codepoint belong to the first set of MAC CE entry(s)/field(s) and/or which one or more of the MAC CE entries/fields for mapping to the same TCI codepoint belong to the second set of MAC CE entry(s)/field(s) as specified herein.

For a TCI codepoint, when/if the corresponding/associated second set of MAC CE entry(s)/field(s) is absent, empty or set to other invalid values such as invalid TCI state ID(s) and etc., the TCI state(s)/TCI state ID(s)—provided in the first set of MAC CE entry(s)/field(s) associated/corresponding to the same TCI codepoint—could be used/applied, i.e., when indicated/applied/activated by the beam indication MAC CE/DCI (e.g., the third TCI state/pair of TCI states indicated via the second beam indication/activation MAC CE or the second beam indication DCI in a beam indication instance as specified herein) to update/replace the first TCI state/pair of TCI states as specified herein. For this case, the UE 116 could use/apply the indicated third TCI state/pair of TCI states and/or the second TCI state/pair of TCI states—e.g., in the order of {the 1st set of TCI state(s): the indicated third TCI state/pair of TCI states, the 2nd set of TCI state(s): the second TCI state/pair of TCI states} or {the 1^{st} set of TCI state(s): the second TCI state/pair of TCI states, the 2^{nd} set of TCI state(s): the indicated third TCI state/pair of TCI states} —for at least UE-dedicated reception(s) on PDSCH(s)/PDCCH(s) or dynamic-grant/configured-grant based PUSCH(s) and all of dedicated PUCCH resources.

For a TCI codepoint, when/if the corresponding/associated first set of MAC CE entry(s)/field(s) is absent, empty or set to other invalid values such as invalid TCI state ID(s) and etc., the TCI state(s)/TCI state ID(s)—provided in the second set of MAC CE entry(s)/field(s) associated/corresponding to the same TCI codepoint—could be used/applied, i.e., when indicated/applied/activated by the beam indication MAC CE/DCI (e.g., the third TCI state/pair of TCI states indicated via the second beam indication/activation MAC CE or the second beam indication DCI in a beam indication instance as specified herein) to update/replace the second TCI state/pair of TCI states as specified herein. For this case, the UE 116 could use/apply the indicated third TCI state/pair of TCI states and/or the first TCI state/pair of TCI states—e.g., in the order of {the 1^{st} set of TCI state(s): the indicated third TCI state/pair of TCI states, the 2^{nd} set of TCI state(s): the first TCI state/pair of TCI states} or {the 1^{st} set of TCI state(s): the first TCI state/pair of TCI states, the 2^{nd} set of TCI state(s): the indicated third TCI state/pair of TCI states}—for at least UE-dedicated reception(s) on PDSCH(s)/PDCCH(s) or dynamic-grant/configured-grant based PUSCH(s) and all of dedicated PUCCH resources.

The specified beam indication/activation MAC CE based parameter(s)/indicator(s)/field(s) and the corresponding methods/examples could be equally extended/applied to higher layer RRC signaling/parameter and dynamic DCI based L1 signaling design(s) to indicate/determine which one of the first and second TCI states/pairs of TCI states could be updated/replaced by the indicated third TCI state/pair of TCI states.

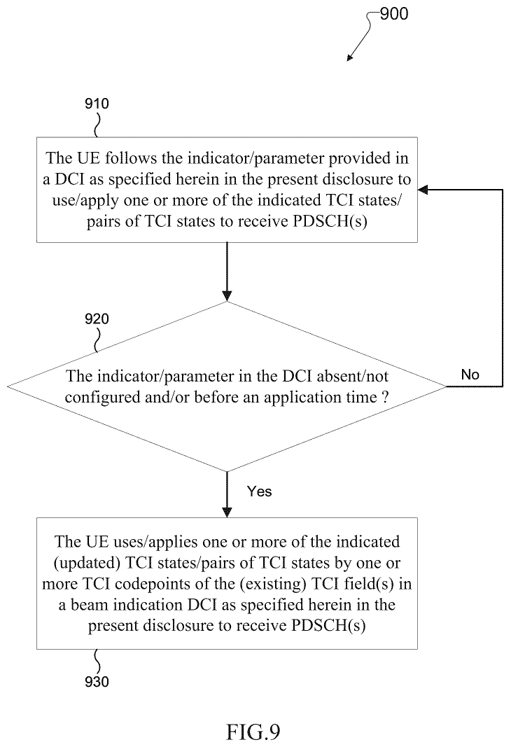

FIG. 9 illustrates a flowchart of an example procedure 900 for determining which of the indicated TCI state(s) to use for PDSCH reception(s) according to embodiments of the present disclosure. For example, procedure 900 could be performed by any of the UEs 111-116 and, more particularly, by the processor 340. This example is for illustration only and other embodiments can be used without departing from the scope of the present disclosure.

The procedure begins in 910, the UE 116 could follow the indicator/parameter provided in a DCI as specified herein in the present disclosure to use/apply one or more of the indicated TCI states/pairs of TCI states to receive PDSCH(s). In 920, the UE 116 can have the indicator/parameter in the DCI absent/not configured and/or before an application time. If so, in 930, the UE 116 could use/apply one or more of the indicated (updated) TCI states/pairs of TCI states by one or more TCI codepoints of the (existing) TCI field(s) in a beam indication DCI as specified herein in the present disclosure to receive PDSCH(s). Otherwise, the procedure returns to 910.

In one embodiment, the UE 116 could be provided/configured/indicated by the network 130, via an indicator field in a DCI (e.g., the scheduling DCI or the beam indication DCI with or without DL assignment), the association between one or more of the indicated TCI states and PDSCH reception(s).

For example, the indicator field could be an existing DCI field in the corresponding DCI and repurposed to indicate/provide/configure the association between the indicated TCI state(s) and the PDSCH reception(s).

For another example, the indicator field could be a new DCI field introduced in the corresponding DCI dedicated for indicating/configuring/providing the association between the indicated TCI state(s) and the PDSCH reception(s).

Yet for another example, the indicator field could be configured by the network 130, e.g., via higher layer RRC signaling and/or MAC CE command and/or dynamic DCI based signaling. For instance, the indicator field could be higher layer RRC configured and/or MAC CE indicated and/or DCI signaled to ‘on’, ‘off’, ‘enabled’, ‘disabled’, ‘present’, ‘absent’. That is, whether or not the indicator field is present in the corresponding DCI (e.g., DCI format 1_1 or 1_2) is configured/controlled by the network 130, e.g., via higher layer RRC signaling and/or MAC CE command and/or dynamic DCI based L1 signaling.

In one example, when/if the DCI indicator/indicator field discussed herein is absent or disabled or not provided/configured/indicated/specified/defined in the corresponding DCI (e.g., the scheduling DCI or the beam indication DCI with or without DL assignment), the UE 116 could follow the indicator/parameter provided/indicated/configured in PDSCH-Config described herein, the fixed rule(s) described herein, or the predefined rule(s) described herein to determine the association between the indicated TCI state(s) and the PDSCH reception(s).

In another example, if the indicator in the DCI (e.g., the scheduling DCI or the beam indication DCI with or without DL assignment) is set to ‘0’, the first indicated TCI state/pair of TCI states could be applied/used for all PDSCH receptions before or after a beam association application time Tapp. If the indicator in the DCI (e.g., the scheduling DCI or the beam indication DCI with or without DL assignment) is set to ‘1’, the second indicated TCI state/pair of TCI states could be applied/used for all PDSCH receptions before or after a beam association application time Tapp.

In yet another example, if the indicator in the DCI (e.g., the scheduling DCI or the beam indication DCI with or without DL assignment) is set to ‘0’, the second indicated TCI state/pair of TCI states could be applied/used for all PDSCH receptions before or after a beam association application time Tapp. If the indicator in the DCI (e.g., the scheduling DCI or the beam indication DCI with or without DL assignment) is set to ‘1’, the first indicated TCI state/pair of TCI states could be applied/used for all PDSCH receptions before or after a beam association application time Tapp.

In yet another example, if the indicator in the DCI (e.g., the scheduling DCI or the beam indication DCI with or without DL assignment) is set to ‘0’ (or ‘1’), the first indicated TCI state/pair of TCI states could be applied/used for receiving the first PDSCH(s), and the second indicated TCI state/pair of TCI states could be applied/used for receiving the second PDSCH(s), before or after a beam association application time Tapp. If the indicator in the DCI (e.g., the scheduling DCI or the beam indication DCI with or without DL assignment) is set to ‘1’ (or ‘0’), the first indicated TCI state/pair of TCI states could be applied/used for receiving the second PDSCH(s), and the second indicated TCI state/pair of TCI states could be applied/used for receiving the first PDSCH(s), before or after a beam association application time Tapp. The UE 116 could be configured/indicated/provided by the network 130, e.g., via higher layer RRC signaling/parameter and/or MAC CE command and/or dynamic DCI based L1 signaling, the first and/or second PDSCHs and their corresponding/respective configuration information.

In yet another example, if the indicator in the DCI (e.g., the scheduling DCI or the beam indication DCI with or without DL assignment) is set to ‘0’ (or ‘1’), the first indicated TCI state/pair of TCI states could be applied/used for all PDSCH receptions before or after a beam association application time Tapp. If the indicator in the DCI (e.g., the scheduling DCI or the beam indication DCI with or without DL assignment) is set to ‘1’ (or ‘0’), the first indicated TCI state/pair of TCI states could be applied/used for receiving the first (or second) PDSCH(s), and the second indicated TCI state/pair of TCI states could be applied/used for receiving the second (or first) PDSCH(s), before or after a beam association application time Tapp. The UE 116 could be configured/indicated/provided by the network 130, e.g., via higher layer RRC signaling/parameter and/or MAC CE command and/or dynamic DCI based L1 signaling, the first and/or second PDSCHs and their corresponding/respective configuration information.

In yet another example, if the indicator in the DCI (e.g., the scheduling DCI or the beam indication DCI with or without DL assignment) is set to ‘0’ (or ‘1’), the second indicated TCI state/pair of TCI states could be applied/used for all PDSCH receptions before or after a beam association application time Tapp. If the indicator in the DCI (e.g., the scheduling DCI or the beam indication DCI with or without DL assignment) is set to ‘1’ (or ‘0’), the first indicated TCI state/pair of TCI states could be applied/used for receiving the first (or second) PDSCH(s), and the second indicated TCI state/pair of TCI states could be applied/used for receiving the second (or first) PDSCH(s), before or after a beam association application time Tapp. The UE 116 could be configured/indicated/provided by the network 130, e.g., via higher layer RRC signaling/parameter and/or MAC CE command and/or dynamic DCI based L1 signaling, the first and/or second PDSCHs and their corresponding/respective configuration information.

In yet another example, if the indicator in the DCI (e.g., the scheduling DCI or the beam indication DCI with or without DL assignment) is set to ‘0’ (or ‘1’), the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)) before or after a beam association application time Tapp and the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)) before or after a beam association application time Tapp. If the indicator in the DCI (e.g., the scheduling DCI or the beam indication DCI with or without DL assignment) is set to ‘1’ (or ‘0’), the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)) before or after a beam association application time Tapp and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)) before or after a beam association application time Tapp.

In yet another example, if the indicator in the DCI (e.g., the scheduling DCI or the beam indication DCI with or without DL assignment) is set to ‘00’ (‘01’, ‘10’, or ‘11’), the first indicated TCI state/pair of TCI states could be applied/used for all PDSCH receptions before or after a beam association application time Tapp. If the indicator in the DCI (e.g., the scheduling DCI or the beam indication DCI with or without DL assignment) is set to ‘01’ (‘00’, ‘10’, or ‘11’), the second indicated TCI state/pair of TCI states could be applied/used for all PDSCH receptions before or after a beam association application time Tapp. If the indicator in the DCI (e.g., the scheduling DCI or the beam indication DCI with or without DL assignment) is set to ‘10’ (‘00’, ‘01’, or ‘11’), the first indicated TCI state/pair of TCI states could be applied/used for receiving the first PDSCH(s) and the second indicated TCI state/pair of TCI states could be applied/used for receiving the second PDSCH(s), before or after a beam association application time Tapp. If the indicator in the DCI (e.g., the scheduling DCI or the beam indication DCI with or without DL assignment) is set to ‘11’ (‘00’, ‘01’, or ‘10’), the first indicated TCI state/pair of TCI states could be applied/used for receiving the second PDSCH(s) and the second indicated TCI state/pair of TCI states could be applied/used for receiving the first PDSCH(s), before or after a beam association application time Tapp.

In yet another example, if the indicator in the DCI (e.g., the scheduling DCI or the beam indication DCI with or without DL assignment) is set to ‘00’ (‘01’, ‘10’, or ‘11’), the first indicated TCI state/pair of TCI states could be applied/used for all PDSCH receptions before or after a beam association application time Tapp. If the indicator in the DCI (e.g., the scheduling DCI or the beam indication DCI with or without DL assignment) is set to ‘01’ (‘00’, ‘10’, or ‘11’), the second indicated TCI state/pair of TCI states could be applied/used for all PDSCH receptions before or after a beam association application time Tapp. If the indicator in the DCI (e.g., the scheduling DCI or the beam indication DCI with or without DL assignment) is set to ‘10’ (‘00’, ‘01’, or ‘11’), the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), before or after a beam association application time Tapp. If the indicator in the DCI (e.g., the scheduling DCI or the beam indication DCI with or without DL assignment) is set to ‘11’ (‘00’, ‘01’, or ‘10’), the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)) and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)), before or after a beam association application time Tapp.

The UE 116 could be provided/configured/indicated by the network 130, e.g., via higher layer RRC signaling/parameter and/or MAC CE command and/or dynamic DCI based L1 signaling, following one or more examples described herein to determine the association between the indicated TCI state(s) and the PDSCH reception(s). For instance, a higher layer parameter ‘dynamicBeamSelectionDCI’ can be provided/configured/indicated in, e.g., PDSCH-Config. When/if the higher layer parameter ‘dynamicBeamSelectionDCI’ is set to ‘enabled’, the UE 116 could follow one or more examples described herein to determine the association between the indicated TCI state(s) and the PDSCH reception(s). Furthermore, the beam application time Tapp could be determined according to one or more of: (1) Tapp=0, (2) fixed in the system specifications, e.g., Tapp=7 symbols, Tapp=3 ms, etc., (3) selected/determined from a set of candidate values for application time, (4) provided/configured/indicated by the network 130 (e.g., from a set of candidate values for application time), e.g., via higher layer RRC signaling/parameter and/or MAC CE command and/or dynamic DCI based L1 signaling, (5) Tapp=timeDurationForQCL, (6) Tapp=BeamAppTime_r17, (7) Tapp corresponds to the first slot that is at least BeamAppTime_r17 symbols after the last symbol of the PUCCH, and the first slot and the BeamAppTime_r17 symbols are both determined on the carrier with the smallest SCS among the carrier(s) applying the beam indication, and/or (8) the maximum (max) or minimum (min) between Tapp determined according to one or more examples described herein and another beam application time Tapp′, where Tapp′ could be similarly determined according to one or more examples described herein.

In one embodiment, the UE 116 could be provided/indicated/configured by the network 130, in a higher layer parameter, e.g., ControlResourceSet for a CORESET, an indicator/parameter to inform/indicate/provide/configure the UE 116 the association between the indicated TCI state(s) and the PDSCH reception(s), wherein different CORESETs configured with the same indicator/parameter could be in a same CORESET group.

In one example, if the DCI (e.g., the scheduling DCI or the beam indication DCI with or without DL assignment) is received in a CORESET configured/associated with the indicator/parameter in the corresponding ControlResourceSet set to ‘0’, the first indicated TCI state/pair of TCI states could be applied/used for all PDSCH receptions. If the DCI (e.g., the scheduling DCI or the beam indication DCI with or without DL assignment) is received in a CORESET configured/associated with the indicator/parameter in the corresponding ControlResourceSet set to ‘1’, the second indicated TCI state/pair of TCI states could be applied/used for all PDSCH receptions.

In another example, if the DCI (e.g., the scheduling DCI or the beam indication DCI with or without DL assignment) is received in a CORESET configured/associated with the indicator/parameter in the corresponding ControlResourceSet set to ‘0’, the second indicated TCI state/pair of TCI states could be applied/used for all PDSCH receptions. If the DCI (e.g., the scheduling DCI or the beam indication DCI with or without DL assignment) is received in a CORESET configured/associated with the indicator/parameter in the corresponding ControlResourceSet set to ‘1’, the first indicated TCI state/pair of TCI states could be applied/used for all PDSCH receptions.

In yet another example, if the DCI (e.g., the scheduling DCI or the beam indication DCI with or without DL assignment) is received in a CORESET configured/associated with the indicator/parameter in the corresponding ControlResourceSet set to ‘0’ (or ‘1’), the first indicated TCI state/pair of TCI states could be applied/used for receiving the first PDSCH(s) and the second indicated TCI state/pair of TCI states could be applied/used for receiving the second PDSCH(s). If the DCI (e.g., the scheduling DCI or the beam indication DCI with or without DL assignment) is received in a CORESET configured/associated with the indicator/parameter in the corresponding ControlResourceSet set to ‘1’ (or ‘0’), the first indicated TCI state/pair of TCI states could be applied/used for receiving the second PDSCH(s) and the second indicated TCI state/pair of TCI states could be applied/used for receiving the first PDSCH(s). The UE 116 could be configured/indicated/provided by the network 130, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the indicator/parameter in the corresponding ControlResourceSet set to ‘0’ (or ‘1’), the first indicated TCI state/pair of TCI states could be applied/used for all PDSCH receptions. If the DCI (e.g., the scheduling DCI or the beam indication DCI with or without DL assignment) is received in a CORESET configured/associated with the indicator/parameter in the corresponding ControlResourceSet set to ‘1’ (or ‘0’), the first indicated TCI state/pair of TCI states could be applied/used for receiving the first (or second) PDSCH(s) and the second indicated TCI state/pair of TCI states could be applied/used for receiving the second (or first) PDSCH(s). The UE 116 could be configured/indicated/provided by the network 130, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the indicator/parameter in the corresponding ControlResourceSet set to ‘0’ (or ‘1’), the second indicated TCI state/pair of TCI states could be applied/used for all PDSCH receptions. If the DCI (e.g., the scheduling DCI or the beam indication DCI with or without DL assignment) is received in a CORESET configured/associated with the indicator/parameter in the corresponding ControlResourceSet set to ‘1’ (or ‘0’), the first indicated TCI state/pair of TCI states could be applied/used for receiving the first (or second) PDSCH(s) and the second indicated TCI state/pair of TCI states could be applied/used for receiving the second (or first) PDSCH(s). The UE 116 could be configured/indicated/provided by the network 130, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the indicator/parameter in the corresponding ControlResourceSet set to ‘0’ (or ‘1’), the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)) and the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)). If the DCI (e.g., the scheduling DCI or the beam indication DCI with or without DL assignment) is received in a CORESET configured/associated with the indicator/parameter in the corresponding ControlResourceSet set to ‘1’ (or ‘0’), the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)) and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)).

In yet another example, if the DCI (e.g., the scheduling DCI or the beam indication DCI with or without DL assignment) is received in a CORESET configured/associated with the indicator/parameter in the corresponding ControlResourceSet set to ‘00’ (‘01’, ‘10’, or ‘11’), the first indicated TCI state/pair of TCI states could be applied/used for all PDSCH receptions. If the DCI (e.g., the scheduling DCI or the beam indication DCI with or without DL assignment) is received in a CORESET configured/associated with the indicator/parameter in the corresponding ControlResourceSet set to ‘01’ (‘00’, ‘10’, or 11′), the second indicated TCI state/pair of TCI states could be applied/used for all PDSCH receptions. If the DCI (e.g., the scheduling DCI or the beam indication DCI with or without DL assignment) is received in a CORESET configured/associated with the indicator/parameter in the corresponding ControlResourceSet set to ‘10’ (‘00’, ‘01’, or ‘11’), the first indicated TCI state/pair of TCI states could be applied/used for receiving the first PDSCH(s) and the second indicated TCI state/pair of TCI states could be applied/used for receiving the second PDSCH(s). If the DCI (e.g., the scheduling DCI or the beam indication DCI with or without DL assignment) is received in a CORESET configured/associated with the indicator/parameter in the corresponding ControlResourceSet set to ‘11’ (‘00’, ‘01’, or ‘10’), the first indicated TCI state/pair of TCI states could be applied/used for receiving the second PDSCH(s) and the second indicated TCI state/pair of TCI states could be applied/used for receiving the first PDSCH(s).

In yet another example, if the DCI (e.g., the scheduling DCI or the beam indication DCI with or without DL assignment) is received in a CORESET configured/associated with the indicator/parameter in the corresponding ControlResourceSet set to ‘00’ (‘01’, ‘10’, or ‘11’), the first indicated TCI state/pair of TCI states could still be applied/used for all PDSCH receptions. If the DCI (e.g., the scheduling DCI or the beam indication DCI with or without DL assignment) is received in a CORESET configured/associated with the indicator/parameter in the corresponding ControlResourceSet set to ‘01’ (‘00’, ‘10’, or ‘11’), the second indicated TCI state/pair of TCI states could be applied/used for all PDSCH receptions. If the DCI (e.g., the scheduling DCI or the beam indication DCI with or without DL assignment) is received in a CORESET configured/associated with the indicator/parameter in the corresponding ControlResourceSet set to ‘10’ (‘00’, ‘01’, or ‘11’), the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)). If the DCI (e.g., the scheduling DCI or the beam indication DCI with or without DL assignment) is received in a CORESET configured/associated with the indicator/parameter in the corresponding ControlResourceSet set to ‘11’ (‘00’, ‘01’ or ‘10’), the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)) and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)).

The UE 116 could be provided/configured/indicated by the network 130, e.g., via higher layer RRC signaling/parameter and/or MAC CE command and/or dynamic DCI based L1 signaling, to follow one or more examples described herein to determine the association between the indicated TCI state(s) and the PDSCH reception(s). For instance, a higher layer parameter ‘dynamicBeamSelectionCoreset’ can be provided/configured/indicated in, e.g., PDSCH-Config. When/if the higher layer parameter ‘dynamicBeamSelectionCoreset’ is set to ‘enabled’, the UE 116 could follow one or more examples described herein to determine the association between the indicated TCI state(s) and the PDSCH reception(s).

In one embodiment, the UE 116 could first use the DCI field indicator in the DCI (e.g., the scheduling DCI or the beam indication DCI with or without DL assignment) as specified herein, to determine a first association between one or more of the indicated TCI states/pairs of TCI states and PDSCH reception(s)—or equivalently, to determine one or more of the indicated TCI states/pairs of TCI states—denoted by first TCI state(s)/pair(s) of TCI states—for PDSCH reception(s). The UE 116 could apply the first association or the first TCI state(s)/pair(s) of TCI states for PDSCH reception(s) after a first application time T1. Before the first application time or before the first application time becomes effective or before the UE 116 could apply the first association or the first TCI state(s)/pair(s) of TCI states for PDSCH reception(s)—e.g., at time t.

In one example, the UE 116 could follow the indicator/parameter provided/indicated/configured in PDSCH-Config described herein (e.g., following one or more examples described herein), the fixed rule(s) described herein (e.g., following one or more examples described herein), or the predefined rule(s) described herein (e.g., following one or more examples described herein), to determine and apply a second association between one or more of the indicated TCI states/pairs of TCI states and the PDSCH reception(s)—or equivalently, to determine and apply one or more of the indicated TCI states/pairs of TCI states—denoted by second (default) TCI state(s)/pair(s) of TCI states—for PDSCH reception(s).

In another example, the UE 116 could use which CORESET(s) the beam indication DCI is received, as specified herein—e.g., following one or more examples described herein, to determine and apply a second association between one or more of the indicated TCI states/pairs of TCI states and PDSCH reception(s)—or equivalently, to determine and apply one or more of the indicated TCI states/pairs of TCI states—denoted by second TCI state(s)/pair(s) of TCI states—for PDSCH reception(s).

In yet another example, the UE 116 could use the indicated TCI state(s)/pair(s) of TCI states by one or more TCI codepoints in one or more TCI fields in the beam indication DCI (e.g., DCI 1_1/1_2 with or without DL assignment), as specified herein—e.g., following one or more examples described herein, to determine and apply a second association between one or more of the indicated TCI states/pairs of TCI states and PDSCH reception(s)—or equivalently, to determine and apply one or more of the indicated TCI states/pairs of TCI states—denoted by second TCI state(s)/pair(s) of TCI states—for PDSCH reception(s).

Alternatively, the UE 116 could use/apply the same TCI state(s)/pair(s) of TCI states used/applied for receiving the beam indication DCI for PDSCH reception(s). Equivalently, the UE 116 may assume that the DM-RS ports of the PDSCH(s) are quasi co-located with the RS(s) with respect to the QCL parameter(s) used for monitoring/receiving the beam indication DCI.

In yet another example, the UE 116 could use the DCI field indicator in the DCI (e.g., the scheduling DCI or the beam indication DCI with or without DL assignment) as specified herein—e.g., following one or more examples described herein, to determine a second association between one or more of the indicated TCI states/pairs of TCI states and PDSCH reception(s)—or equivalently, to determine one or more of the indicated TCI states/pairs of TCI states—denoted by second TCI state(s)/pair(s) of TCI states—for PDSCH reception(s).

Alternatively, the UE 116 could use/apply the same TCI state(s)/pair(s) of TCI states used/applied for receiving the DCI with the DCI field indicator present/configured for PDSCH reception(s). Equivalently, the UE 116 may assume that the DM-RS ports of the PDSCH(s) are quasi co-located with the RS(s) with respect to the QCL parameter(s) used for monitoring/receiving the DCI with the DCI field indicator present/configured.

Even after the first application time, i.e., when the UE 116 is able to apply the first association or the first TCI state(s)/pair(s) of TCI states for PDSCH reception(s), the UE 116 could still determine and apply the second association or the second TCI state(s)/pair(s) of TCI states—e.g., follow one or more examples described herein—to receive PDSCH(s)—e.g., after a second application time T2—according to one or more of the following conditions.

In one example, the DCI field indicator in a DCI (e.g., the scheduling DCI or the beam indication DCI with or without DL assignment) specified herein is absent/not configured or is set to ‘disabled’ or ‘off’ or invalid value(s).

In another example, the DCI field indicator in a DCI (e.g., the scheduling DCI or the beam indication DCI with or without DL assignment) specified herein is set to a particular value such as ‘0’, ‘1’, ‘00’, ‘01’, ‘10’, ‘11’, or ‘reserved’.

In yet another example, a higher layer parameter, e.g., denoted by ‘dynamicBeamAssociationPDSCH-NewDCIField’, provided in a higher layer RRC parameter, e.g., PDSCH-Config/PDCCH-Config/ControlResourceSet, is set to ‘disabled’ or ‘off’, or is not configured/present.

In yet another example, a higher layer parameter, e.g., denoted by ‘dynamicBeamAssociationPDSCH-ExistTCIField’, provided in a higher layer RRC parameter, e.g., PDSCH-Config/PDCCH-Config/ControlResourceSet, is set to ‘enabled’ or ‘on’, or is configured/present.

In yet another example, the number of TCI states or configurations configured/provided in a first list of TCI states or configurations or a second list of TCI states or configurations is smaller/lower (or greater/higher) than a threshold, wherein the UE 116 can be configured with the first list of DLorJointTCIState configurations, within the higher layer parameter PDSCH-Config for providing a reference signal for the quasi co-location for DM-RS of PDSCH and DM-RS of PDCCH in a CC, for CSI-RS, and to provide a reference, if applicable, for determining UL TX spatial filter for dynamic-grant and configured-grant based PUSCH and PUCCH resource in a CC, and SRS. The second list of UL-TCIState configurations, to provide a reference, if applicable, for determining UL TX spatial filter for dynamic-grant and configured-grant based PUSCH and PUCCH resource in a CC, and SRS, wherein the UE 116 could be provided/configured/indicated by the network 130, e.g., via higher layer RRC signaling/parameter and/or MAC CE command and/or dynamic DCI based L1 signaling, the threshold.

In yet another example, the number of TCI codepoints activated by a beam indication/activation MAC CE, e.g., the Unified TCI States Activation/Deactivation MAC CE or Enhanced Unified TCI States Activation/Deactivation MAC CE, is smaller/lower (or greater/higher) than a threshold, wherein the UE 116 could be provided/configured/indicated by the network 130, e.g., via higher layer RRC signaling/parameter and/or MAC CE command and/or dynamic DCI based L1 signaling, the threshold.

In yet another example, the beam application time (BAT) provided by, e.g., BeamAppTime_r17, is smaller/lower (or greater/higher) than a threshold, wherein the UE 116 could be provided/configured/indicated by the network 130, e.g., via higher layer RRC signaling/parameter and/or MAC CE command and/or dynamic DCI based L1 signaling, the threshold. Furthermore, the beam application time is defined as follows: when the UE 116 would transmit the last symbol of a PUCCH with HARQ-ACK information corresponding to the DCI carrying the TCI State indication and without DL assignment or corresponding to the PDSCH scheduling by the DCI carrying the TCI State indication. If the indicated TCI State is different from the previously indicated one, the indicated DLorJointTCIState or UL-TCIstate should be applied starting from the first slot that is at least BeamAppTime_r17 symbols after the last symbol of the PUCCH. The first slot and the BeamAppTime_r17 symbols are both determined on the carrier with the smallest SCS among the carrier(s) applying the beam indication.

In yet another example, the first application time as specified herein is smaller/lower (or greater/higher) than a threshold, wherein the UE 116 could be provided/configured/indicated by the network 130, e.g., via higher layer RRC signaling/parameter and/or MAC CE command and/or dynamic DCI based L1 signaling, the threshold.

In yet another example, the second application time as specified herein is smaller/lower (or greater/higher) than a threshold, wherein the UE 116 could be provided/configured/indicated by the network 130, e.g., via higher layer RRC signaling/parameter and/or MAC CE command and/or dynamic DCI based L1 signaling, the threshold.

In yet another example, a capability signaling/value, e.g., dynamicBeamAssociationPDSCH-NewDCIField, to indicate to the network 130 that the UE 116 is capable of or able to use the DCI field indicator in the DCI (e.g., the scheduling DCI or the beam indication DCI with or without DL assignment) as specified herein, e.g., following one or more examples described herein, to determine the association between one or more of the indicated TCI states/pairs of TCI states and PDSCH reception(s), is not reported.

In yet another example, a capability signaling/value, e.g., dynamicBeamAssociationPDSCH-ExistTCIField, to indicate to the network 130 that the UE 116 is capable of or able to use the indicated TCI state(s)/pair(s) of TCI states by one or more TCI codepoints in one or more TCI fields in the beam indication DCI (e.g., DCI 1_1/1_2 with or without DL assignment), as specified herein, e.g., following one or more examples described herein, to determine the association between one or more of the indicated TCI states/pairs of TCI states and the PDSCH reception(s), is reported.

In yet another example, a DCI (e.g., the scheduling DCI or the beam indication DCI with or without DL assignment) is received in a first CORESET, wherein the UE 116 could be provided/configured/indicated by the network 130, e.g., via higher layer RRC signaling/parameter and/or MAC CE command and/or dynamic DCI based L1 signaling, configuration information of the first CORESET.

For example, the first CORESET could correspond to a CORESET with UE specific search space (USS) or common search space (CSS).

For another example, the first CORESET could be configured/associated with an indicator set to ‘0’ (or ‘1’) in the corresponding ControlResourceSet that configures the first CORESET.

Yet for another example, the first CORESET could be comprised/included/contained in a CORESET group/pool with the corresponding CORESET group/pool index value set to ‘0’ (or ‘1’).

Before the second application time or before the second application time becomes effective or before the UE 116 could apply the second association or the second TCI state(s)/pair(s) of TCI states for PDSCH reception(s)—e.g., at time t.

In one example, the UE 116 could follow the indicator/parameter provided/indicated/configured in PDSCH-Config described herein (e.g., following one or more examples described herein), the fixed rule(s) described herein (e.g., following one or more examples described herein), or the predefined rule(s) described herein (e.g., following one or more examples described herein), to determine and apply a third association between one or more of the indicated TCI states/pairs of TCI states and the PDSCH reception(s)—or equivalently, to determine and apply one or more of the indicated TCI states/pairs of TCI states—denoted by third (default) TCI state(s)/pair(s) of TCI states—for PDSCH reception(s).

In another example, the UE 116 could use which CORESET(s) the beam indication DCI is received, as specified herein—e.g., following one or more examples described herein, to determine and apply a third association between one or more of the indicated TCI states/pairs of TCI states and PDSCH reception(s)—or equivalently, to determine and apply one or more of the indicated TCI states/pairs of TCI states—denoted by third TCI state(s)/pair(s) of TCI states—for PDSCH reception(s).

In yet another example, the UE 116 could use the indicated TCI state(s)/pair(s) of TCI states by one or more TCI codepoints in one or more TCI fields in the beam indication DCI (e.g., DCI 1_1/1_2 with or without DL assignment), as specified herein—e.g., following one or more examples described herein, to determine and apply a third association between one or more of the indicated TCI states/pairs of TCI states and PDSCH reception(s)—or equivalently, to determine and apply one or more of the indicated TCI states/pairs of TCI states—denoted by third TCI state(s)/pair(s) of TCI states—for PDSCH reception(s).

Alternatively, the UE 116 could use/apply the same TCI state(s)/pair(s) of TCI states used/applied for receiving the beam indication DCI for PDSCH reception(s). Equivalently, the UE 116 may assume that the DM-RS ports of the PDSCH(s) are quasi co-located with the RS(s) with respect to the QCL parameter(s) used for monitoring/receiving the beam indication DCI.

In yet another example, the UE 116 could use the DCI field indicator in the DCI (e.g., the scheduling DCI or the beam indication DCI with or without DL assignment) as specified herein—e.g., following one or more examples described herein, to determine a third association between one or more of the indicated TCI states/pairs of TCI states and PDSCH reception(s)—or equivalently, to determine one or more of the indicated TCI states/pairs of TCI states—denoted by third TCI state(s)/pair(s) of TCI states—for PDSCH reception(s).

Alternatively, the UE 116 could use/apply the same TCI state(s)/pair(s) of TCI states used/applied for receiving the DCI with the DCI field indicator present/configured for PDSCH reception(s). Equivalently, the UE 116 may assume that the DM-RS ports of the PDSCH(s) are quasi co-located with the RS(s) with respect to the QCL parameter(s) used for monitoring/receiving the DCI with the DCI field indicator present/configured.

In one example, the indicated TCI state(s)/pair(s) of TCI states could correspond to the TCI state(s)/pair(s) of TCI states indicated/provided in the latest or the most recent beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) received in time.

In another example, the indicated TCI state(s)/pair(s) of TCI states could correspond to the TCI state(s)/pair(s) of TCI states indicated/provided in the beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) that is received later in time and/or in the latest slot in which one or more CORESETs within the active BWP of the serving cell are monitored by the UE 116.

In yet another example, the indicated TCI state(s)/pair(s) of TCI states could correspond to the TCI state(s)/pair(s) of TCI states indicated/provided in the latest or the most recent (received in time) beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) that is received before the first application time T1, the second application time T2, a third application time T3, or when/if the first application time T1 or the second application time T2 or a third application time T3 has been reached/passed (e.g., less than or equal to, or greater than or equal to the time t).

In yet another example, the indicated TCI state(s)/pair(s) of TCI states could correspond to the TCI state(s)/pair(s) of TCI states indicated/provided in the beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) that is received later in time and/or in the latest slot in which one or more CORESETs within the active BWP of the serving cell are monitored by the UE 116 and/or before the first application time T1, the second application time T2, a third application time T3, or when/if the first application time T1, the second application time T2, or a third application time T3 has been reached/passed (e.g., less than or equal to, or greater than or equal to the time t).

In yet another example, the indicated TCI state(s)/pair(s) of TCI states could correspond to the TCI state(s)/pair(s) of TCI states indicated/provided in the second latest or the previous/prior beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) received in time.

In yet another example, the indicated TCI state(s)/pair(s) of TCI states could correspond to the TCI state(s)/pair(s) of TCI states indicated/provided in the beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) that is received earlier in time and/or in the latest slot in which one or more CORESETs within the active BWP of the serving cell are monitored by the UE 116.

In yet another example, the indicated TCI state(s)/pair(s) of TCI states could correspond to the TCI state(s)/pair(s) of TCI states indicated/provided in the second latest or the previous/prior (received in time) beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) that is received before the first application time T1, the second application time T2, or a third application time T3, or when/if the first application time T1, the second application time T2, or a third application time T3 has been reached/passed (e.g., less than or equal to, or greater than or equal to the time t).

In yet another example, the indicated TCI state(s)/pair(s) of TCI states could correspond to the TCI state(s)/pair(s) of TCI states indicated/provided in the beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) that is received earlier in time and/or in the latest slot in which one or more CORESETs within the active BWP of the serving cell are monitored by the UE 116 and/or before the first application time T1, the second application time T2, a third application time T3, or when/if the first application time T1, the second application time T2, or a third application time T3 has been reached/passed (e.g., less than or equal to, or greater than or equal to the time t).

Here, the first association could be identical to/same as or different from the second association, and the first or second application time T1, T2, or T3 could be determined according to one or more of: (1) T1=0 or T2=0 or T3=0, (2) fixed in the system specifications, e.g., T1=7 symbols, T1=3 ms, T2=7 symbols, T2=3 ms, T3=7 symbols, T3=3 ms, etc., (3) selected/determined from a set of candidate values for application time, (4) provided/configured/indicated by the network 130 (e.g., from a set of candidate values for application time), e.g., via higher layer RRC signaling/parameter and/or MAC CE command and/or dynamic DCI based L1 signaling, (5) T1=timeDurationForQCL or T2=timeDurationForQCL or T3=timeDurationForQCL, (6) T1=BeamAppTime_r17 or T2=BeamAppTime_r17 or T3=BeamAppTime_r17, (7) T1 or T2 or T3 corresponds to the first slot that is at least BeamAppTime_r17 symbols after the last symbol of the PUCCH, and the first slot and the BeamAppTime_r17 symbols are both determined on the carrier with the smallest SCS among the carrier(s) applying the beam indication, and/or (8) the maximum (max) or minimum (min) between T1 or T2 or T3 determined according to one or more examples described herein and a fourth application time T4, where T4 could be similarly determined according to one or more examples described herein. In addition, the first TCI state(s)/pair(s) of TCI states could be identical to/same as or different from the second (default) TCI state(s)/pair(s) of TCI states.

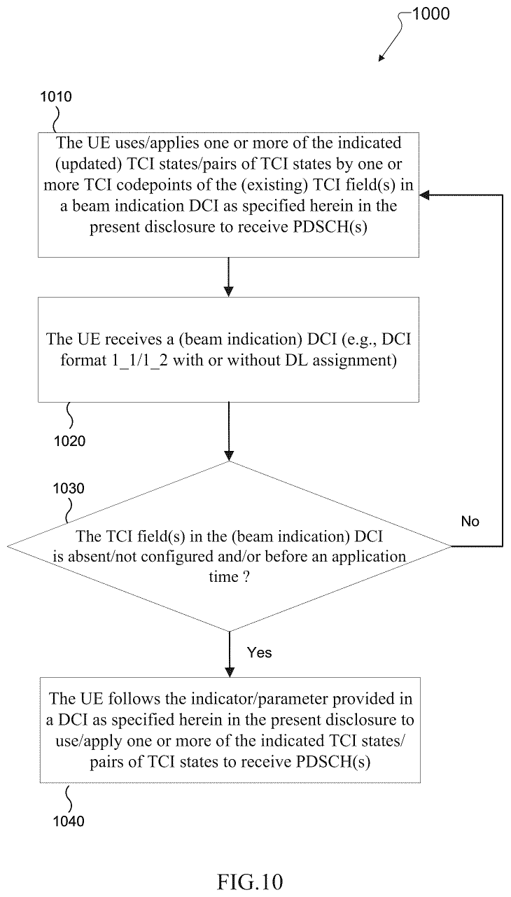

FIG. 10 illustrates a flowchart of another example procedure 1000 for determining which of the indicated TCI state(s) to use for PDSCH reception(s) according to embodiments of the present disclosure. For example, procedure 1000 could be performed the UE 116. This example is for illustration only and other embodiments can be used without departing from the scope of the present disclosure.

The procedure being in 1010, the UE 116 could use/apply one or more of the indicated (updated) TCI states/pairs of TCI states by one or more TCI codepoints of the (existing) TCI field(s) in a beam indication DCI as specified herein in the present disclosure to receive PDSCH(s). In 1020, the UE 116 could then receive a (beam indication) DCI. In 1030, the UE 116 can have the TCI field(s) in the (beam indication) DCI absent/not configured and/or before an application time. If so, in 1040, the UE 116 could follow the indicator/parameter provided in a DCI as specified herein in the present disclosure to use/apply one or more of the indicated TCI states/pairs of TCI states to receive PDSCH(s). Otherwise, the procedure returns to 1010.

In one embodiment, the UE 116 could first use the indicated TCI state(s)/pair(s) of TCI states by one or more TCI codepoints in one or more TCI fields in the beam indication DCI (e.g., DCI 1_1/1_2 with or without DL assignment), as specified herein—e.g., following one or more examples described herein, to determine a first association between one or more of the indicated TCI states/pairs of TCI states and PDSCH reception(s)—or equivalently, to determine one or more of the indicated TCI states/pairs of TCI states—denoted by first TCI state(s)/pair(s) of TCI states —for PDSCH reception(s). The UE 116 could apply the first association or the first TCI state(s)/pair(s) of TCI states for PDSCH reception(s) after a first application time T1. Before the first application time or before the first application time becomes effective or before the UE 116 could apply the first association or the first TCI state(s)/pair(s) of TCI states for PDSCH reception(s)—e.g., at time t.

In one example, the UE 116 could follow the indicator/parameter provided/indicated/configured in PDSCH-Config described herein (e.g., one or more examples described herein), the fixed rule(s) described herein (e.g., following one or more examples described herein), or the predefined rule(s) described herein (e.g., following one or more examples described herein), to determine and apply a second association between one or more of the indicated TCI states/pairs of TCI states and the PDSCH reception(s)—or equivalently, to determine and apply one or more of the indicated TCI states/pairs of TCI states—denoted by second (default) TCI state(s)/pair(s) of TCI states—for PDSCH reception(s).

In another example, the UE 116 could use which CORESET(s) the beam indication DCI is received, as specified herein—e.g., following one or more examples described herein, to determine and apply a second association between one or more of the indicated TCI states/pairs of TCI states and PDSCH reception(s)—or equivalently, to determine and apply one or more of the indicated TCI states/pairs of TCI states—denoted by second TCI state(s)/pair(s) of TCI states—for PDSCH reception(s).

In yet another example, the UE 116 could use the indicated TCI state(s)/pair(s) of TCI states by one or more TCI codepoints in one or more TCI fields in the beam indication DCI (e.g., DCI 1_1/1_2 with or without DL assignment), as specified herein—e.g., following one or more examples described herein, to determine and apply a second association between one or more of the indicated TCI states/pairs of TCI states and PDSCH reception(s)—or equivalently, to determine and apply one or more of the indicated TCI states/pairs of TCI states—denoted by second TCI state(s)/pair(s) of TCI states—for PDSCH reception(s).

Alternatively, the UE 116 could use/apply the same TCI state(s)/pair(s) of TCI states used/applied for receiving the beam indication DCI for PDSCH reception(s). Equivalently, the UE 116 may assume that the DM-RS ports of the PDSCH(s) are quasi co-located with the RS(s) with respect to the QCL parameter(s) used for monitoring/receiving the beam indication DCI.

In yet another example, the UE 116 could use the DCI field indicator in the DCI (e.g., the scheduling DCI or the beam indication DCI with or without DL assignment) as specified herein—e.g., following one or more examples described herein, to determine a second association between one or more of the indicated TCI states/pairs of TCI states and PDSCH reception(s)—or equivalently, to determine one or more of the indicated TCI states/pairs of TCI states—denoted by second TCI state(s)/pair(s) of TCI states—for PDSCH reception(s).

Alternatively, the UE 116 could use/apply the same TCI state(s)/pair(s) of TCI states used/applied for receiving the DCI with the DCI field indicator present/configured for PDSCH reception(s). Equivalently, the UE 116 may assume that the DM-RS ports of the PDSCH(s) are quasi co-located with the RS(s) with respect to the QCL parameter(s) used for monitoring/receiving the DCI with the DCI field indicator present/configured.

Even after the first application time, i.e., when the UE 116 is able to apply the first association or the first TCI state(s)/pair(s) of TCI states for PDSCH reception(s), the UE 116 could still determine and apply the second association or the second TCI state(s)/pair(s) of TCI states—e.g., following one or more examples described herein—to receive PDSCH(s)—e.g., after a second application time T2—according to one or more of the following conditions.

In one example, the indicated TCI state(s)/pair(s) of TCI states by one or more TCI codepoints in one or more TCI fields in the beam indication DCI (e.g., DCI 1_1/1_2 with or without DL assignment) is the same as/identical to the previously indicated one(s).

In another example, the indicated TCI states/pairs of TCI states by one or more TCI codepoints in one or more TCI fields in the beam indication DCI (e.g., DCI 1_1/1_2 with or without DL assignment) are the same or identical to each other.

In yet another example, the TCI field(s) in the beam indication DCI (e.g., DCI 1_1/1_2 with or without DL assignment) is not configured/present or is set to ‘disabled’ or ‘off’.

In yet another example, specific TCI state(s)/pair(s) of TCI states or TCI codepoint(s) is indicated in the beam indication DCI (e.g., DCI 1_1/1_2 with or without DL assignment).

In yet another example, a higher layer parameter, e.g., denoted by ‘dynamicBeamAssociationPDSCH-ExistTCIField’, provided in a higher layer RRC parameter, e.g., PDSCH-Config/PDCCH-Config/ControlResourceSet, is set to ‘disabled’ or ‘off’, or is not configured/present.

In yet another example, a higher layer parameter, e.g., denoted by ‘dynamicBeamAssociationPDSCH-NewDCIField’, provided in a higher layer RRC parameter, e.g., PDSCH-Config/PDCCH-Config/ControlResourceSet, is set to ‘enabled’ or ‘on’, or is configured/present.

In yet another example, the number of TCI states or configurations configured/provided in a first list of TCI states or configurations or a second list of TCI states or configurations is smaller/lower (or greater/higher) than a threshold, wherein the UE 116 can be configured with the first list of DLorJointTCIState configurations, within the higher layer parameter PDSCH-Config for providing a reference signal for the quasi co-location for DM-RS of PDSCH and DM-RS of PDCCH in a CC, for CSI-RS, and to provide a reference, if applicable, for determining UL TX spatial filter for dynamic-grant and configured-grant based PUSCH and PUCCH resource in a CC, and SRS. The second list of UL-TCIState configurations, to provide a reference, if applicable, for determining UL TX spatial filter for dynamic-grant and configured-grant based PUSCH and PUCCH resource in a CC, and SRS, wherein the UE 116 could be provided/configured/indicated by the network 130, e.g., via higher layer RRC signaling/parameter and/or MAC CE command and/or dynamic DCI based L1 signaling, the threshold.

In yet another example, the number of TCI codepoints activated by a beam indication/activation MAC CE, e.g., the Unified TCI States Activation/Deactivation MAC CE or Enhanced Unified TCI States Activation/Deactivation MAC CE, is smaller/lower (or greater/higher) than a threshold, wherein the UE 116 could be provided/configured/indicated by the network 130, e.g., via higher layer RRC signaling/parameter and/or MAC CE command and/or dynamic DCI based L1 signaling, the threshold.

In yet another example, the beam application time (BAT) provided by, e.g., BeamAppTime_r17, is smaller/lower (or greater/higher) than a threshold, wherein the UE 116 could be provided/configured/indicated by the network 130, e.g., via higher layer RRC signaling/parameter and/or MAC CE command and/or dynamic DCI based L1 signaling, the threshold. Furthermore, the beam application time is defined herein. When the UE 116 would transmit the last symbol of a PUCCH with HARQ-ACK information corresponding to the DCI carrying the TCI State indication and without DL assignment, or corresponding to the PDSCH scheduling by the DCI carrying the TCI State indication, and if the indicated TCI State is different from the previously indicated one, the indicated DLorJointTCIState or UL-TCIstate should be applied starting from the first slot that is at least BeamAppTime_r17 symbols after the last symbol of the PUCCH. The first slot and the BeamAppTime_r17 symbols are both determined on the carrier with the smallest SCS among the carrier(s) applying the beam indication.

In yet another example, the first application time as specified herein is smaller/lower (or greater/higher) than a threshold, wherein the UE 116 could be provided/configured/indicated by the network 130, e.g., via higher layer RRC signaling/parameter and/or MAC CE command and/or dynamic DCI based L1 signaling, the threshold.

In yet another example, the second application time as specified herein is smaller/lower (or greater/higher) than a threshold, wherein the UE 116 could be provided/configured/indicated by the network 130, e.g., via higher layer RRC signaling/parameter and/or MAC CE command and/or dynamic DCI based L1 signaling, the threshold.

In yet another example, a capability signaling/value, e.g., dynamicBeamAssociationPDSCH-ExistTCIField, to indicate to the network 130 that the UE 116 is capable of or able to use the indicated TCI state(s)/pair(s) of TCI states by one or more TCI codepoints in one or more TCI fields in the beam indication DCI (e.g., DCI 1_1/1_2 with or without DL assignment), as specified herein—e.g., following one or more examples described herein, to determine the association between one or more of the indicated TCI states/pairs of TCI states and PDSCH reception(s), is not reported.

In yet another example, a capability signaling/value, e.g., dynamicBeamAssociationPDSCH-NewDCIField, to indicate to the network 130 that the UE 116 is capable of or able to use the DCI field indicator in the DCI (e.g., the scheduling DCI or the beam indication DCI with or without DL assignment) as specified herein—e.g., following one or more examples described herein, to determine the association between one or more of the indicated TCI states/pairs of TCI states and PDSCH reception(s), is reported.

In yet another example, a DCI (e.g., the scheduling DCI or the beam indication DCI with or without DL assignment) is received in a first CORESET, wherein the UE 116 could be provided/configured/indicated by the network 130, e.g., via higher layer RRC signaling/parameter and/or MAC CE command and/or dynamic DCI based L1 signaling, configuration information of the first CORESET.

For example, the first CORESET could correspond to a CORESET with UE specific search space (USS) or common search space (CSS).

For another example, the first CORESET could be configured/associated with an indicator set to ‘0’ (or ‘1’) in the corresponding ControlResourceSet that configures the first CORESET.

Yet for another example, the first CORESET could be comprised/included/contained in a CORESET group/pool with the corresponding CORESET group/pool index value set to ‘0’ (or ‘1’).

Before the second application time or before the second application time becomes effective or before the UE 116 could apply the second association or the second TCI state(s)/pair(s) of TCI states for PDSCH reception(s)—e.g., at time t.

In one example, the UE 116 could follow the indicator/parameter provided/indicated/configured in PDSCH-Config described herein (e.g., following one or more examples described herein), the fixed rule(s) described herein (e.g., following one or more examples described herein), or the predefined rule(s) described herein (e.g., following one or more examples described herein), to determine and apply a third association between one or more of the indicated TCI states/pairs of TCI states and the PDSCH reception(s)—or equivalently, to determine and apply one or more of the indicated TCI states/pairs of TCI states—denoted by third (default) TCI state(s)/pair(s) of TCI states—for PDSCH reception(s).

In another example, the UE 116 could use which CORESET(s) the beam indication DCI is received, as specified herein—e.g., following one or more examples described herein, to determine and apply a third association between one or more of the indicated TCI states/pairs of TCI states and PDSCH reception(s)—or equivalently, to determine and apply one or more of the indicated TCI states/pairs of TCI states—denoted by third TCI state(s)/pair(s) of TCI states—for PDSCH reception(s).

In yet another example, the UE 116 could use the indicated TCI state(s)/pair(s) of TCI states by one or more TCI codepoints in one or more TCI fields in the beam indication DCI (e.g., DCI 1_1/1_2 with or without DL assignment), as specified herein—e.g., following one or more examples described herein, to determine and apply a third association between one or more of the indicated TCI states/pairs of TCI states and PDSCH reception(s)—or equivalently, to determine and apply one or more of the indicated TCI states/pairs of TCI states—denoted by third TCI state(s)/pair(s) of TCI states—for PDSCH reception(s).

Alternatively, the UE 116 could use/apply the same TCI state(s)/pair(s) of TCI states used/applied for receiving the beam indication DCI for PDSCH reception(s). Equivalently, the UE 116 may assume that the DM-RS ports of the PDSCH(s) are quasi co-located with the RS(s) with respect to the QCL parameter(s) used for monitoring/receiving the beam indication DCI.

In yet another example, the UE 116 could use the DCI field indicator in the DCI (e.g., the scheduling DCI or the beam indication DCI with or without DL assignment) as specified herein—e.g., following one or more examples described herein, to determine a third association between one or more of the indicated TCI states/pairs of TCI states and PDSCH reception(s)—or equivalently, to determine one or more of the indicated TCI states/pairs of TCI states—denoted by third TCI state(s)/pair(s) of TCI states—for PDSCH reception(s).

Alternatively, the UE 116 could use/apply the same TCI state(s)/pair(s) of TCI states used/applied for receiving the DCI with the DCI field indicator present/configured for PDSCH reception(s). Equivalently, the UE 116 may assume that the DM-RS ports of the PDSCH(s) are quasi co-located with the RS(s) with respect to the QCL parameter(s) used for monitoring/receiving the DCI with the DCI field indicator present/configured.

In one example, the indicated TCI state(s)/pair(s) of TCI states could correspond to the TCI state(s)/pair(s) of TCI states indicated/provided in the latest or the most recent beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) received in time.

In another example, the indicated TCI state(s)/pair(s) of TCI states could correspond to the TCI state(s)/pair(s) of TCI states indicated/provided in the beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) that is received later in time and/or in the latest slot in which one or more CORESETs within the active BWP of the serving cell are monitored by the UE 116.

In yet another example, the indicated TCI state(s)/pair(s) of TCI states could correspond to the TCI state(s)/pair(s) of TCI states indicated/provided in the latest or the most recent (received in time) beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) that is received before the first application time T1, the second application time T2, or a third application time T3, or when/if the first application time T1, the second application time T2, or a third application time T3 has been reached/passed (e.g., less than or equal to, or greater than or equal to the time t).

In yet another example, the indicated TCI state(s)/pair(s) of TCI states could correspond to the TCI state(s)/pair(s) of TCI states indicated/provided in the beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) that is received later in time and/or in the latest slot in which one or more CORESETs within the active BWP of the serving cell are monitored by the UE 116 and/or before the first application time T1, the second application time T2, or a third application time T3, or when/if the first application time T1, the second application time T2, or a third application time T3 has been reached/passed (e.g., less than or equal to, or greater than or equal to the time t).

In yet another example, the indicated TCI state(s)/pair(s) of TCI states could correspond to the TCI state(s)/pair(s) of TCI states indicated/provided in the second latest or the previous/prior beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) received in time.

In yet another example, the indicated TCI state(s)/pair(s) of TCI states could correspond to the TCI state(s)/pair(s) of TCI states indicated/provided in the beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) that is received earlier in time and/or in the latest slot in which one or more CORESETs within the active BWP of the serving cell are monitored by the UE 116.

In yet another example, the indicated TCI state(s)/pair(s) of TCI states could correspond to the TCI state(s)/pair(s) of TCI states indicated/provided in the second latest or the previous/prior (received in time) beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) that is received before the first application time T1, the second application time T2, or a third application time T3, or when/if the first application time T1, the second application time T2, or a third application time T3 has been reached/passed (e.g., less than or equal to, or greater than or equal to the time t).

In yet another example, the indicated TCI state(s)/pair(s) of TCI states could correspond to the TCI state(s)/pair(s) of TCI states indicated/provided in the beam indication/activation MAC CE, e.g., the Unified TCI States Activation/Deactivation MAC CE or Enhanced Unified TCI States Activation/Deactivation MAC CE, or the beam indication DCI (e.g., DCI format 1_1/1_2 with or without DL assignment) that is received earlier in time and/or in the latest slot in which one or more CORESETs within the active BWP of the serving cell are monitored by the UE 116 and/or before the first application time T1, the second application time T2, or a third application time T3, or when/if the first application time T1, the second application time T2, or a third application time T3 has been reached/passed (e.g., less than or equal to, or greater than or equal to the time t).

Here, the first association could be identical to/same as or different from the second association, and the first or second application time T1 or T2 or T3 could be determined according to one or more of: (1) T1=0 or T2=0 or T3=0, (2) fixed in the system specifications, e.g., T1=7 symbols, T1=3 ms, T2=7 symbols, T2=3 ms, T3=7 symbols, T3=3 ms, etc., (3) selected/determined from a set of candidate values for application time, (4) provided/configured/indicated by the network 130 (e.g., from a set of candidate values for application time), e.g., via higher layer RRC signaling/parameter and/or MAC CE command and/or dynamic DCI based L1 signaling, (5) T1=timeDurationForQCL or T2=timeDurationForQCL or T3=timeDurationForQCL, (6) T1=BeamAppTime_r17 or T2=BeamAppTime_r17 or T3=BeamAppTime_r17, (7) T1 or T2 or T3 corresponds to the first slot that is at least BeamAppTime_r17 symbols after the last symbol of the PUCCH, and the first slot and the BeamAppTime_r17 symbols are both determined on the carrier with the smallest SCS among the carrier(s) applying the beam indication, and/or (8) the maximum (max) or minimum (min) between T1 or T2 or T3 determined according to one or more examples described herein and a fourth application time T4, where T4 could be similarly determined according to one or more examples described herein. In addition, the first TCI state(s)/pair(s) of TCI states could be identical to/same as or different from the second (default) TCI state(s)/pair(s) of TCI states.

In the present disclosure, the first PDSCH(s) and/or the second PDSCH(s) could correspond to or could be determined according to one or more examples described herein.

In one example, when a UE is configured/provided/indicated by the network 130 the higher layer parameter repetitionScheme set to ‘fdmSchemeA’, the UE 116 shall receive a single PDSCH transmission occasion of the transport block (TB) and may assume that precoding granularity is P_{BWP} resource blocks in the frequency domain, where P_{BWP} can be equal to one of the values among {2, 4, wideband}. For N=2 or M=2, if P_{BWP} is configured/determined as ‘wideband’, the first (or second) PDCCH(s) could correspond to the first ┌n_{PRB}/2┐ physical resource blocks (PRBs), and the second (or first) PDSCH(s) could correspond to the remaining └n_{PRB}/2┘ PRBs, where np RB is the total number of allocated PRBs for the UE 116. If P_{BWP} is configured/determined as one of the values among {2, 4}, the first (or second) PDSCH(s) could correspond to even precoding resource block groups (PRGs) within the allocated frequency domain resources and the second (or first) PDSCH(s) could correspond to odd PRGs within the allocated frequency domain resources, wherein the PRGs are numbered continuously in increasing order with the first PRG index equal to 0.

In another example, when a UE is configured/provided/indicated by the network 130 the higher layer parameter repetitionScheme set to ‘fdmSchemeB’, the UE 116 shall receive two PDSCH transmission occasions of the same TB and may assume that precoding granularity is P_{BWP} resource blocks in the frequency domain, where P_{BWP} can be equal to one of the values among {2, 4, wideband}. For N=2 or M=2, if P_{BWP} is configured/determined as ‘wideband’, the first (or second) PDCCH(s) could correspond to the first ┌n_{PRB}/2┐ PRBs and the second (or first) PDSCH(s) could correspond to the remaining └n_{PRB}/2┘ PRBs, where np RB is the total number of allocated PRBs for the UE 116. If P_{BWP} is configured/determined as one of the values among {2, 4}, the first (or second) PDSCH(s) could correspond to even precoding resource block groups (PRGs) within the allocated frequency domain resources and the second (or first) PDSCH(s) could correspond to odd PRGs within the allocated frequency domain resources, wherein the PRGs are numbered continuously in increasing order with the first PRG index equal to 0.

In yet another example, when a UE is configured/provided/indicated by the network 130 the higher layer parameter repetitionScheme set to ‘tdmSchemeA’, the UE 116 shall receive two PDSCH transmission occasions of the transport block (TB) within a given slot. For this case, the first (or second) PDSCH(s) could correspond to the first PDSCH transmission occasion and resource allocation in time domain for the first PDSCH transmission occasion follows those described in document and standard [4]. The second (or first) PDSCH(s) could correspond to the second PDSCH transmission occasion, and the second PDSCH transmission occasion shall have the same number of symbols as the first PDSCH transmission occasion.

In yet another example, when a UE is configured/provided by the network 130 the higher layer parameter repetitionNumber in PDSCH-TimeDomainResourceAllocation, the UE 116 may expect to receive multiple slot level PDSCH transmission occasions of the same TB in the repetitionNumber consecutive slots. When the value indicated by repetitionNumber in PDSCH-TimeDomainResourceAllocation equals to two, the first (or second) PDSCH(s) could correspond to the first PDSCH transmission occasion and resource allocation in time domain for the first PDSCH transmission occasion follows those described in document and standard [4], and the second (or first) PDSCH(s) could correspond to the second PDSCH transmission occasion. When the value of repetitionNumber in PDSCH-TimeDomainResourceAllocation is larger than two, the UE 116 may be further configured to enable cyclicMapping or sequentialMapping. When cyclicMapping is enabled, the first (or second) PDSCH(s) and the second (or first) PDSCH(s) could correspond to the first PDSCH transmission occasion and the second PDSCH transmission occasion, respectively, and the same mapping pattern continues to the remaining PDSCH transmission occasions. When sequentialMapping is enabled, the first (or second) PDSCH(s) could correspond to the first and second PDSCH transmission occasions, the second (or first) PDSCH(s) could correspond to the third and fourth PDSCH transmission occasions, and the same mapping pattern continues to the remaining PDSCH transmission occasions.

Throughout the one or more examples described herein, the higher layer parameter, e.g., PDSCH-Config that sets the indicator(s)/parameter(s) to ‘0’, ‘1’, ‘00’, ‘01’, ‘10’, or ‘11’ could also correspond to (or could be replaced by) the higher layer parameter, e.g., PDSCH-Config, providing/indicating/configuring a first TCI state/TCI state ID, a first pair of TCI states/TCI state IDs, a second TCI state/TCI state ID, a second pair of TCI states/TCI state IDs, both of the first TCI state/TCI state ID and the second TCI state/TCI state ID, both of the first pair of TCI states/TCI state IDs and the second pair of TCI states/TCI state IDs, or both of the first (or second) TCI state/TCI state ID and the first (or second) pair of TCI states/TCI state IDs. Equivalently, the indicator(s)/parameter(s) that is provided in the higher layer parameter, e.g., PDSCH-Config, and set to ‘0’, ‘1’, ‘00’, ‘01’, ‘10’, or ‘11’ as specified herein could also correspond to (or could be replaced by) a first TCI state/TCI state ID, a first pair of TCI states/TCI state IDs, a second TCI state/TCI state ID, a second pair of TCI states/TCI state IDs, both of the first TCI state/TCI state ID and the second TCI state/TCI state ID, both of the first pair of TCI states/TCI state IDs and the second pair of TCI states/TCI state IDs, or both of the first (or second) TCI state/TCI state ID and the first (or second) pair of TCI states/TCI state IDs that is provided in the higher layer parameter, e.g., PDSCH-Config, as specified herein. Throughout the one or more examples described herein, the higher layer parameter, e.g., PDSCH-Config, not associated/configured with the indicator(s)/parameter(s) as specified herein or associated/configured with the indicator(s)/parameter(s) as specified herein absent/not present/not configured or set to ‘disabled’ or ‘off’ or ‘none’ could also correspond to (or could be replaced by) the higher layer parameter, e.g., PDSCH-Config, not providing/indicating/configuring any TCI state(s)/TCI state ID(s). Or equivalently, the indicator(s)/parameter(s) that is absent/not present/not configured or set to ‘disabled’ or ‘off’ or ‘none’ in the higher layer parameter, e.g., PDSCH-Config, as specified herein could also correspond to (or could be replaced by) the higher layer parameter, e.g., PDSCH-Config, not providing/indicating/configuring any TCI state(s)/TCI state ID(s). Throughout the one or more examples described herein, the first (or second) TCI state/pair of TCI states—when/if they are provided/indicated/configured, e.g., in form of their respective/corresponding TCI state ID(s), in the higher layer parameter, e.g., PDSCH-Config, as specified herein—could also be applied/used for PDSCH reception(s) by replacing the first (or second) indicated TCI state/pair of TCI states in the descriptions herein.

As specified herein, in a (single-DCI based) multi-TRP system, a UE could be indicated/provided/configured by the network 130, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

A UE could be provided/indicated/configured by the network 130, e.g., via higher layer RRC signaling/parameter and/or MAC CE command and/or dynamic DCI based L1 signaling, ‘joint’ or ‘separate’ unified TCI state type(s) for the SDCI based MTRP operation. For instance, the UE 116 could receive from the network 130 a higher layer parameter unifiedtci-StateType-mtrp set to ‘joint’ indicating that a TCI codepoint could correspond to a set of one or more joint DL and UL TCI states each provided by DLorJointTCI-State and set to ‘separate’ indicating that a TCI codepoint could correspond to a set of one or more separate DL and/or UL TCI states wherein a separate DL TCI state could be provided by DLorJointTCI-State and a separate UL TCI state could be provided by UL-TCIState.

In one example, when/if the UE 116 is configured with ‘joint’ TCI state type, a TCI codepoint (e.g., in the beam indication MAC CE or in a TCI field of the beam indication DCI) could correspond to one or more of the following examples:
For example (joint-mode-1), TCI codepoint={joint TCI state 1, joint TCI state 2}.
For another example (joint-mode-2), TCI codepoint={joint TCI state}.
Yet for another example (joint-mode-3), TCI codepoint={joint TCI state 1, none}.
Yet for another example (joint-mode-4), TCI codepoint={none, joint TCI state 2}.

Furthermore, for the configured ‘joint’ TCI state type (e.g., when the higher layer parameter unifiedtci-StateType-mtrp is set to ‘joint’), the UE 116 could be further configured/indicated/provided by the network 130, e.g., via higher layer RRC signaling/parameter and/or MAC CE command and/or dynamic DCI based L1 signaling, one or more of (or a subset of) the ‘joint’ operation modes (e.g., joint-mode-1, joint-mode-2, joint-mode-3 and joint-mode-4 as specified herein) for the configured/indicated/activated TCI codepoint(s).

For example, the UE 116 could receive from the network 130 a higher layer parameter unifiedjointtci-StateMode set to one or more of (or a subset of) the ‘joint’ operation modes including joint-mode-1, joint-mode-2, joint-mode-3, and joint-mode-4 as specified herein.

In one example, the higher layer parameter unifiedjointtci-StateMode could be set to ‘joint-mode-1’. For this case, a TCI codepoint could correspond to two joint DL and UL TCI states.

In another example, the higher layer parameter unifiedjointtci-StateMode could be set to ‘joint-mode-2’. For this case, a TCI codepoint could correspond to a single joint DL and UL TCI state. In yet another example, the higher layer parameter unifiedjointtci-StateMode could be set to ‘joint-mode-3/joint-mode-4’. For this case, a TCI codepoint could correspond to two MAC CE entries, wherein one of the two MAC CE entries corresponds to a joint DL and UL TCI state, and the other MAC CE entry corresponds to none (meaning that it does not correspond to any TCI state/TCI state ID). The higher layer parameter unifiedjointtci-StateMode could be set to other value(s) than the one or more examples described herein or set to any combination(s) of the ‘joint’ operation modes including joint-mode-1, joint-mode-2, joint-mode-3, and joint-mode-4 as specified herein.

For another example, the UE 116 could be provided/indicated/configured by the network 130, e.g., via higher layer RRC signaling/parameter and/or MAC CE command and/or dynamic DCI based L1 signaling, a multi-bit (e.g., 2-bit) indicator with each state of the indicator corresponding to one or more of (or a subset of) the ‘joint’ operation modes including joint-mode-1, joint-mode-2, joint-mode-3 and joint-mode-4 as specified herein. For instance, the indicator could be a 2-bit indicator with state ‘00’ indicating joint-mode-1, state ‘01’ indicating joint-mode-2, state ‘10’ indicating joint-mode-3 and state ‘11’ indicating joint-mode-4.

In one example, one or more such (2-bit) indicators could be indicated/provided in the beam indication/activation MAC CE, wherein each TCI codepoint indicated/provided therein could be associated with/indicated by an (2-bit) indicator indicated/provided therein, which indicates a ‘joint’ operation mode (e.g., joint-mode-1, joint-mode-2, joint-mode-3 or joint-mode-4) as specified herein for the corresponding TCI codepoint.

In another example, one or more (new or repurposed) DCI indicator fields in the beam indication DCI could indicate/provide one or more such (2-bit) indicators. For this case, each of the one or more (2-bit) indicators could indicate a ‘joint’ operation mode (e.g., joint-mode-1, joint-mode-2, joint-mode-3, or joint-mode-4) as specified herein for a TCI codepoint of a TCI field in the beam indication DCI. The DCI indicator field(s) could be implemented/realized by repurposing one or more DCI field bits of one or more (existing) DCI fields in the corresponding DCI format.

Alternatively, the DCI indicator field(s) could be new DCI indicator field(s) in the corresponding DCI format dedicated for indicating the (2-bit) indicator(s).

In one example, when/if the UE 116 is configured with ‘separate’ TCI state type, a TCI codepoint (e.g., in the beam indication MAC CE or in a TCI field of the beam indication DCI) could correspond to one or more of the following examples:
For example (separate-mode-1), TCI codepoint={separate DL TCI state}.
For another example (separate-mode-2), TCI codepoint={separate DL TCI state, separate DL TCI state}.
Yet for another example (separate-mode-3), TCI codepoint={separate DL TCI state, separate UL TCI state}.
Yet for another example (separate-mode-4), TCI codepoint={separate DL TCI state, a pair of separate DL and UL TCI states}.
Yet for another example (separate-mode-5), TCI codepoint={separate DL TCI state, none}.
Yet for another example (separate-mode-6), TCI codepoint={none, separate DL TCI state}.
Yet for another example (separate-mode-7), TCI codepoint={separate UL TCI state}.
Yet for another example (separate-mode-8), TCI codepoint={separate UL TCI state, separate UL TCI state}.
Yet for another example (separate-mode-9), TCI codepoint={separate UL TCI state, separate DL TCI state}.
Yet for another example (separate-mode-10), TCI codepoint={separate UL TCI state, a pair of separate DL and UL TCI states}.
Yet for another example (separate-mode-11), TCI codepoint={separate UL TCI state, none}.
Yet for another example (separate-mode-12), TCI codepoint={none, separate UL TCI state}.
Yet for another example (separate-mode-13), TCI codepoint={a pair of separate DL and UL TCI states}.

Yet for another example (separate-mode-14), TCI codepoint={a pair of separate DL and UL TCI states, a pair of separate DL and UL TCI states}.

Yet for another example (separate-mode-15), TCI codepoint={a pair of separate DL and UL TCI states, separate DL TCI state}.

Yet for another example (separate-mode-16), TCI codepoint={a pair of separate DL and UL TCI states, separate UL TCI state}.

Yet for another example (separate-mode-17), TCI codepoint={a pair of separate DL and UL TCI states, none}.

Yet for another example (separate-mode-18), TCI codepoint={none, a pair of separate DL and UL TCI states}.

Furthermore, for the configured ‘separate’ TCI state type (e.g., when the higher layer parameter unifiedtci-StateType-mtrp is set to ‘separate’), the UE 116 could be further configured/indicated/provided by the network 130, e.g., via higher layer RRC signaling/parameter and/or MAC CE command and/or dynamic DCI based L1 signaling, one or more of (or a subset of) the ‘separate’ operation modes (e.g., separate-mode-1, separate-mode-2, . . . , separate-mode-18 as specified herein) for the configured/indicated/activated TCI codepoint(s).

For example, the UE 116 could receive from the network 130 a higher layer parameter unifiedseparatetci-StateMode set to one or more of (or a subset of) the ‘separate’ operation modes including separate-mode-1, separate-mode-2, . . . , separate-mode-18 as specified herein.

In one example, the higher layer parameter unifiedseparatetci-StateMode could be set to ‘ separate-mode-1/separate-mode-2/separate-mode-3/separate-mode-4/separate-mode-5’. For this case, a TCI codepoint could correspond to one or two MAC CE entries, wherein the first MAC CE entry corresponds to a separate DL TCI state.

In another example, the higher layer parameter unifiedseparatetci-StateMode could be set to ‘ separate-mode-7/separate-mode-8/separate-mode-9/separate-mode-10/separate-mode-11’. For this case, a TCI codepoint could correspond to one or two MAC CE entries, wherein the first MAC CE entry corresponds to a separate UL TCI state.

In yet another example, the higher layer parameter unifiedseparatetci-StateMode could be set to ‘separate-mode-13/separate-mode-14/separate-mode-15/separate-mode-16/separate-mode-17’. For this case, a TCI codepoint could correspond to one (two) or more MAC CE entries, wherein the first (two) MAC CE entry(s) corresponds to a pair of separate DL and UL TCI states.

In yet another example, the higher layer parameter unifiedseparatetci-StateMode could be set to ‘separate-mode-6/separate-mode-12/separate-mode-18’. For this case, a TCI codepoint could correspond to one or more (two) MAC CE entries, wherein the first MAC CE entry corresponds to none (meaning that it does not correspond to any TCI state/TCI state ID). The higher layer parameter unifiedseparatetci-StateMode could be set to other value(s) than the one or more examples described herein or set to any combination(s) of the ‘separate’ operation modes including separate-mode-1, separate-mode-2, . . . , separate-mode-18 as specified herein.

For another example, the UE 116 could be provided/indicated/configured by the network 130, e.g., via higher layer RRC signaling/parameter and/or MAC CE command and/or dynamic DCI based L1 signaling, a multi-bit (e.g., 2-bit, 3-bit, 4-bit or 5-bit) indicator with each state of the indicator corresponding to one or more of (or a subset of) the ‘separate’ operation modes including separate-mode-1, separate-mode-2, . . . , separate-mode-18 as specified herein. For instance, the indicator could be a 2-bit indicator with state ‘00’ indicating a first subset of ‘separate’ operation modes including separate-mode-1, separate-mode-2, separate-mode-3, separate-mode-4 and separate-mode-5, state ‘01’ indicating a second subset of ‘separate’ operation modes including separate-mode-7, separate-mode-8, separate-mode-9, separate-mode-10 and separate-mode-11, state ‘10’ indicating a third subset of ‘separate’ operation modes including separate-mode-13, separate-mode-14, separate-mode-15, separate-mode-16 and separate-mode-17 and state ‘11’ indicating a fourth subset of ‘separate’ operation modes including separate-mode-6, separate-mode-12 and separate-mode-18. Optionally, the indicator could be a 5-bit indicator with state ‘00000’ indicating separate-mode-1, state ‘00001’ indicating separate-mode-2, state ‘00010’ indicating separate-mode-3, state ‘00011’ indicating separate-mode-4, . . . , and state ‘10001’ indicating separate-mode-18.

In one example, one or more such multi-bit indicators could be indicated/provided in the beam indication/activation MAC CE, wherein each TCI codepoint indicated/provided therein could be associated with/indicated by an indicator indicated/provided therein, which indicates one or more ‘separate’ operation modes as specified herein for the corresponding TCI codepoint.

In another example, one or more (new or repurposed) DCI indicator fields in the beam indication DCI could indicate/provide one or more such multi-bit indicators. For this case, each of the one or more multi-bit indicators could indicate one or more ‘separate’ operation modes as specified herein for a TCI codepoint of a TCI field in the beam indication DCI. The DCI indicator field(s) could be implemented/realized by repurposing one or more DCI field bits of one or more (existing) DCI fields in the corresponding DCI format.

Alternatively, the DCI indicator field(s) could be new DCI indicator field(s) in the corresponding DCI format dedicated for indicating the multi-bit indicator(s).

As discussed herein, a UE could receive a MAC CE activation command, e.g., Unified TCI states activation/deactivation MAC CE command, used to map up to Ncp≥1 (e.g., Ncp=8 or Ncp=16) TCI codepoints of a TCI field in a beam indication DCI (e.g., DCI format 1_1/1_2 with or without DL assignment), wherein a TCI codepoint could contain/comprise/include one or more, e.g., N≥1 or M≥1 (e.g., N=2 or M=2), TCI states or pairs of TCI states. A TCI state could correspond to a joint TCI state provided by DLorJointTCIState, a separate DL TCI state provided by DLorJointTCIState, or a separate UL TCI state provided by UL-TCIState. Furthermore, when/if the UE 116 is not provided CORESETPooIndex or is provided CORESETPoolIndex with value of 0 for first CORESETs on active DL BWPs of serving cells and is provided CORESETPoolIndex with a value of 1 for second CORESETs on active DL BWPs of the serving cells, the MAC CE activation command (e.g., the Unified TCI states activation/deactivation MAC CE command) could also be associated with a value of CORESETPoolIndex (e.g., 0 or 1). For this case, when/if the TCI codepoint(s) of a TCI field in a beam indication DCI is selected/indicated/determined/activated from a MAC CE activation command (e.g., the Unified TCI states activation/deactivation MAC CE command) associated with a value of CORESETPoolIndex (e.g., 0 or 1), the TCI codepoint(s) and, therefore, the corresponding TCI state(s)/pair(s) of TCI state(s) provided/indicated therein, is associated with the same value of CORESETPoolIndex (e.g., 0 or 1) and could be used for receiving DL channels/signals such as PDCCH, PDSCH and CSI-RS and/or transmitting UL channels/signals such as PUCCH, PUSCH and SRS associated with the same value of CORESETPoolIndex (e.g., 0 or 1).

Alternatively, when/if the UE 116 is not provided CORESETPooIndex or is provided CORESETPoolIndex with value of 0 for first CORESETs on active DL BWPs of serving cells, and is provided CORESETPoolIndex with a value of 1 for second CORESETs on active DL BWPs of the serving cells the UE 116 could use the TCI state(s)/pair(s) of TCI states indicated/provided by one or more TCI codepoints of one or more TCI fields in a beam indication DCI (e.g., DCI format 1_1/1_2 with or without DL assignment) received in the first (or second) CORESETs for receiving DL channels/signals such as PDCCH, PDSCH and CSI-RS and/or transmitting UL channels/signals such as PUCCH, PUSCH and SRS associated with value 0 (or 1) of CORESETPoolIndex.

In one example, when/if the UE 116 is not provided CORESETPooIndex or is provided CORESETPoolIndex with value of 0 for first CORESETs on active DL BWPs of serving cells and is provided CORESETPoolIndex with a value of 1 for second CORESETs on active DL BWPs of the serving cells, the UE 116 could receive a MAC CE activation command, e.g., Unified TCI states activation/deactivation MAC CE command, associated with a value of CORESETPoolIndex (e.g., 0 or 1) and used to map up to Ncp≥1 (e.g., Ncp=8 or Ncp=16) TCI codepoints of a TCI field in a beam indication DCI (e.g., DCI format 1_1/1_2 with or without DL assignment), wherein a TCI codepoint could contain/comprise/include one or more, e.g., N≥1 or M≥1 (e.g., N=2 or M=2), TCI states or pairs of TCI states associated with the same value of CORESETPoolIndex (e.g., 0 or 1). A TCI state could correspond to a joint TCI state provided by DLorJointTCIState, a separate DL TCI state provided by DLorJointTCIState, or a separate UL TCI state provided by UL-TCIState. For this case, the UE 116 could assume the DM-RS antenna port(s) of the PDCCH(s) received in the first CORESET(s) is quasi co-located with the RS(s) in the RS set(s) provided/indicated/configured in the unified TCI state(s) associated with value 0 of CORESETPoolIndex—e.g., the unified TCI state(s) could be indicated/provided by TCI codepoint(s) activated/provided/indicated by a MAC CE activation command, e.g., the Unified TCI states activation/deactivation MAC CE command, associated with value 0 of CORESETPoolIndex according to one or more examples described herein. The UE 116 could assume the DM-RS antenna port(s) of the PDCCH(s) received in the second CORESET(s) is quasi co-located with the RS(s) in the RS set(s) provided/indicated/configured in the unified TCI state(s) associated with value 1 of CORESETPoolIndex—e.g., the unified TCI state(s) could be indicated/provided by TCI codepoint(s) activated/provided/indicated by a MAC CE activation command, e.g., the Unified TCI states activation/deactivation MAC CE command, associated with value 1 of CORESETPoolIndex according to one or more examples described herein.

In another example, when/if the UE 116 is not provided CORESETPooIndex or is provided CORESETPoolIndex with value of 0 for first CORESETs on active DL BWPs of serving cells and is provided CORESETPoolIndex with a value of 1 for second CORESETs on active DL BWPs of the serving cells, the UE 116 could receive a MAC CE activation command, e.g., Unified TCI states activation/deactivation MAC CE command, used to map up to Ncp≥1 (e.g., Ncp=8 or Ncp=16) TCI codepoints of a TCI field in a beam indication DCI (e.g., DCI format 1_1/1_2 with or without DL assignment) received in the first (or second) CORESETs associated/configured with value 0 (or 1) of CORESETPoolIndex, wherein a TCI codepoint could contain/comprise/include one or more, e.g., N≥1 or M≥1 (e.g., N=2 or M=2), TCI states or pairs of TCI states. A TCI state could correspond to a joint TCI state provided by DLorJointTCIState, a separate DL TCI state provided by DLorJointTCIState, or a separate UL TCI state provided by UL-TCIState. For this case, the UE 116 could assume the DM-RS antenna port(s) of the PDCCH(s) received in the first CORESET(s) is quasi co-located with the RS(s) in the RS set(s) provided/indicated/configured in the unified TCI state(s) associated with value 0 of CORESETPoolIndex—e.g., the unified TCI state(s) could be indicated/provided by TCI codepoint(s) in TCI field(s) of the beam indication DCI received in the first CORESET(s) associated/configured with value 0 of CORESETPoolIndex according to one or more examples described herein. The UE 116 could assume the DM-RS antenna port(s) of the PDCCH(s) received in the second CORESET(s) is quasi co-located with the RS(s) in the RS set(s) provided/indicated/configured in the unified TCI state(s) associated with value 1 of CORESETPoolIndex—e.g., the unified TCI state(s) could be indicated/provided by TCI codepoint(s) in TCI field(s) of the beam indication DCI received in the second CORESET(s) associated/configured with value 1 of CORESETPoolIndex according to one or more examples described herein.

In one embodiment, if a UE:
is not provided CORESETPoolIndex or is provided CORESETPoolIndex with a value of 0 for first CORESETs on active DL BWPs of serving cells;
is provided CORESETPoolIndex with a value of 1 for second CORESETs on active DL BWPs of the serving cells;
is provided DLorJointTCIState or UL-TCIState; and
is provided ackNackFeedbackMode=separate
   the UE 116 could separately report first HARQ-ACK information associated with the first CORESETs on active DL BWP of the serving cells and report second HARQ-ACK information associated with the second CORESETs on active DL BWP of the serving cells. The UE 116 could transmit the first HARQ-ACK information—corresponding to first PDSCH(s)—on first PUCCH(s) and transmit the second HARQ-ACK information—corresponding to second PDSCH(s)—on second PUCCH(s), wherein the first PDSCH(s) could be scheduled/activated by first DCI(s)/PDCCH(s) received in the first CORESET(s) and the second PDSCH(s) could be scheduled/activated by second DCI(s)/PDCCH(s) received in the second CORESET(s). For this case, the UE 116 could use a spatial domain transmit filter that is the same as the spatial domain receive filter the UE 116 may use to receive the DL reference signal associated with or indicated/provided in the indicated unified TCI state(s) for receiving/monitoring the first DCI(s)/PDCCH(s) received in the first CORESET(s) associated/configured with value 0 of CORESETPoolIndex according to one or more examples described herein to transmit the first PUCCH(s) that carries the first HARQ-ACK information.

Equivalently, the indicated unified TCI state(s) for receiving/monitoring the first DCI(s)/PDCCH(s) received in the first CORESET(s) associated/configured with value 0 of CORESETPoolIndex according to one or more examples described herein could provide a reference for determining UL TX spatial filter to transmit the first PUCCH(s) that carries the first HARQ-ACK information. Furthermore, the UE 116 could use a spatial domain transmit filter that is the same as the spatial domain receive filter the UE 116 may use to receive the DL reference signal associated with or indicated/provided in the indicated unified TCI state(s) for receiving/monitoring the second DCI(s)/PDCCH(s) received in the second CORESET(s) associated/configured with value 1 of CORESETPoolIndex according to one or more examples described herein to transmit the second PUCCH(s) that carries the second HARQ-ACK information.

Equivalently, the indicated unified TCI state(s) for receiving/monitoring the second DCI(s)/PDCCH(s) received in the second CORESET(s) associated/configured with value 1 of CORESETPoolIndex according to one or more examples described herein could provide a reference for determining UL TX spatial filter to transmit the second PUCCH(s) that carries the second HARQ-ACK information.

In one embodiment, if a UE
is not provided CORESETPoolIndex or is provided CORESETPoolIndex with a value of 0 for first CORESETs on active DL BWPs of serving cells;
is provided CORESETPoolIndex with a value of 1 for second CORESETs on active DL BWPs of the serving cells;
is provided DLorJointTCIState or UL-TCIState; and
is provided ackNackFeedbackMode=joint,
   where
a serving cell is placed in a first set S₀ of N_{cells}^{DL,0} serving cells if the serving cell includes a first CORESET;
a serving cell is placed in a second set S₁ of N_{cells}^{DL,1} serving cells if the serving cell includes a second CORESET; and
serving cells are placed in a set according to an ascending order of a serving cell index, the UE 116 could first generate a (e.g., Type-1) HARQ-ACK codebook for the set S₀ and the set S₁ of serving cells separately by setting N_{cells}^{DL}=N_{cells}^{DL,0} and N_{cells}^{DL}=N_{cells}^{DL,1} in the corresponding HARQ-ACK codebook generation procedures specified herein or in document and standard [3]. The UE 116 could concatenate the HARQ-ACK codebook generated for the set S₀ followed by the HARQ-ACK codebook generated for the set S₁ to obtain a total number of O_{ACK} HARQ-ACK information bits for a joint HARQ-ACK codebook. According to one or more examples described herein, the joint HARQ-ACK codebook could be associated with or correspond to both first and second PDSCHs, wherein the first PDSCH(s) could be scheduled/activated by first DCI(s)/PDCCH(s) received in the first CORESET(s) associated/configured with value 0 of CORESETPoolIndex, and the second PDSCH(s) could be scheduled/activated by second DCI(s)/PDCCH(s) received in the second CORESET(s) associated/configured with value 1 of CORESETPoolIndex. The UE 116 could transmit/send the joint HARQ-ACK codebook on one or more primary PUCCHs. The UE 116 could determine the UL TX spatial filter(s) for transmitting the primary PUCCH(s) based on one or more examples described herein.

In one example, the one or more primary PUCCHs or PUCCH resources could be associated with a value of CORESETPoolIndex (e.g., 0 or 1) or both values of CORESETPoolIndex (e.g., 0 and 1). For instance, an indicator could be configured/provided/indicated in a MAC CE command or in the higher layer RRC parameter, e.g., PUCCH-Resource or PUCCH-Config or PUCCH-ResourceSet or PUCCH-ResourceGroup, that configures a PUCCH resource or a PUCCH resource setting/set/group, and used to associate the corresponding PUCCH resource or PUCCH resource setting/set/group to one or more values of CORESETPoolIndex (e.g., 0 and/or 1).

For example, the indicator could be a one-bit higher layer RRC parameter/indicator and correspond to CORESETPoolIndex. When/if the higher layer RRC parameter/indicator configured/provided in the higher layer RRC parameter, e.g., PUCCH-Resource or PUCCH-Config or PUCCH-ResourceSet or PUCCH-ResourceGroup, that configures the primary PUCCH(s) or PUCCH setting(s)/set(s)/group(s) in which the primary PUCCH(s) is configured is set to ‘0’ (or ‘1’) or value 0 (or 1) of CORESETPoolIndex, the UE 116 could use a spatial domain transmit filter that is the same as the spatial domain receive filter the UE 116 may use to receive the DL reference signal associated with or indicated/provided in the indicated unified TCI state(s) for receiving/monitoring the first (or second) DCI(s)/PDCCH(s) received in the first (or second) CORESET(s) associated/configured with value 0 (or 1) of CORESETPoolIndex according to one or more examples described herein to transmit the primary PUCCH(s) that carries the joint HARQ-ACK codebook.

Equivalently, when/if the higher layer RRC parameter/indicator configured/provided in the higher layer RRC parameter, e.g., PUCCH-Resource or PUCCH-Config or PUCCH-ResourceSet or PUCCH-ResourceGroup that configures the primary PUCCH(s) or PUCCH setting(s)/set(s)/group(s) in which the primary PUCCH(s) is configured is set to ‘0’ (or ‘1’) or value 0 (or 1) of CORESETPoolIndex, the indicated unified TCI state(s) for receiving/monitoring the first (or second) DCI(s)/PDCCH(s) received in the first (or second) CORESET(s) associated/configured with value 0 (or 1) of CORESETPoolIndex according to one or more examples described herein could provide a reference for determining UL TX spatial filter to transmit the primary PUCCH(s) that carries the joint HARQ-ACK codebook. When/if the higher layer RRC parameter/indicator configured/provided in the higher layer RRC parameter, e.g., PUCCH-Resource or PUCCH-Config or PUCCH-Resource Set or PUCCH-ResourceGroup, that configures the primary PUCCH(s) or PUCCH setting(s)/set(s)/group(s) in which the primary PUCCH(s) is configured is set to ‘1’ (or ‘0’) or value 1 (or 0) of CORESETPoolIndex, the UE 116 could use a spatial domain transmit filter that is the same as the spatial domain receive filter the UE 116 may use to receive the DL reference signal associated with or indicated/provided in the indicated unified TCI state(s) for receiving/monitoring the second (or first) DCI(s)/PDCCH(s) received in the second (or first) CORESET(s) associated/configured with value 1 (or 0) of CORESETPoolIndex according to one or more examples described herein to transmit the primary PUCCH(s) that carries the joint HARQ-ACK codebook.

Equivalently, when/if the higher layer RRC parameter/indicator configured/provided in the higher layer RRC parameter, e.g., PUCCH-Resource or PUCCH-Config or PUCCH-ResourceSet or PUCCH-ResourceGroup, that configures the primary PUCCH(s) or PUCCH setting(s)/set(s)/group(s) in which the primary PUCCH(s) is configured is set to ‘1’ (or ‘0’) or value 1(or 0) of CORESETPoolIndex, the indicated unified TCI state(s) for receiving/monitoring the second (or first) DCI(s)/PDCCH(s) received in the second (or first) CORESET(s) associated/configured with value 1 (or 0) of CORESETPoolIndex according to one or more examples described herein could provide a reference for determining UL TX spatial filter to transmit the primary PUCCH(s) that carries the joint HARQ-ACK codebook.

In another example, the one or more primary PUCCHs or PUCCH resources could be associated with a value of CORESETPoolIndex (e.g., 0 or 1) or both values of CORESETPoolIndex (e.g., 0 and 1). For instance, an indicator could be configured/provided/indicated in a MAC CE command or in the higher layer RRC parameter, e.g., PUCCH-Resource or PUCCH-Config or PUCCH-Resource Set or PUCCH-ResourceGroup, that configures a PUCCH resource or a PUCCH resource setting/set/group, and used to associate the corresponding PUCCH resource or PUCCH resource setting/set/group to one or more values of CORESETPoolIndex (e.g., 0 and/or 1).

For example, the indicator could be a two-bit higher layer RRC parameter/indicator. When/if the higher layer RRC parameter/indicator configured/provided in the higher layer RRC parameter, e.g., PUCCH-Resource or PUCCH-Config or PUCCH-ResourceSet or PUCCH-ResourceGroup, that configures the primary PUCCH(s) or PUCCH setting(s)/set(s)/group(s) in which the primary PUCCH(s) is configured is set to ‘00’ (or ‘01’ or ‘10’ or ‘11’), the UE 116 could use a spatial domain transmit filter that is the same as the spatial domain receive filter the UE 116 may use to receive the DL reference signal associated with or indicated/provided in the indicated unified TCI state(s) for receiving/monitoring the first (or second) DCI(s)/PDCCH(s) received in the first (or second) CORESET(s) associated/configured with value 0 (or 1) of CORESETPoolIndex according to one or more examples described herein to transmit the primary PUCCH(s) that carries the joint HARQ-ACK codebook.

Equivalently, when/if the higher layer RRC parameter/indicator configured/provided in the higher layer RRC parameter, e.g., PUCCH-Resource or PUCCH-Config or PUCCH-ResourceSet or PUCCH-ResourceGroup, that configures the primary PUCCH(s) or PUCCH setting(s)/set(s)/group(s) in which the primary PUCCH(s) is configured is set to ‘00’ (or ‘01’ or ‘10’ or ‘11’), the indicated unified TCI state(s) for receiving/monitoring the first (or second) DCI(s)/PDCCH(s) received in the first (or second) CORESET(s) associated/configured with value 0 (or 1) of CORESETPoolIndex according to one or more examples described herein could provide a reference for determining UL TX spatial filter to transmit the primary PUCCH(s) that carries the joint HARQ-ACK codebook. When/if the higher layer RRC parameter/indicator configured/provided in the higher layer RRC parameter, e.g., PUCCH-Resource or PUCCH-Config or PUCCH-ResourceSet or PUCCH-ResourceGroup, that configures the primary PUCCH(s) or PUCCH setting(s)/set(s)/group(s) in which the primary PUCCH(s) is configured is set to ‘01’ (or ‘00’ or ‘10’ or ‘11’), the UE 116 could use a spatial domain transmit filter that is the same as the spatial domain receive filter the UE 116 may use to receive the DL reference signal associated with or indicated/provided in the indicated unified TCI state(s) for receiving/monitoring the second (or first) DCI(s)/PDCCH(s) received in the second (or first) CORESET(s) associated/configured with value 1 (or 0) of CORESETPoolIndex according to one or more examples described herein to transmit the primary PUCCH(s) that carries the joint HARQ-ACK codebook.

Equivalently, when/if the higher layer RRC parameter/indicator configured/provided in the higher layer RRC parameter, e.g., PUCCH-Resource or PUCCH-Config or PUCCH-ResourceSet or PUCCH-ResourceGroup, that configures the primary PUCCH(s) or PUCCH setting(s)/set(s)/group(s) in which the primary PUCCH(s) is configured is set to ‘01’ (or ‘00’ or ‘10’ or ‘11’), the indicated unified TCI state(s) for receiving/monitoring the second (or first) DCI(s)/PDCCH(s) received in the second (or first) CORESET(s) associated/configured with value 1 (or 0) of CORESETPoolIndex according to one or more examples described herein could provide a reference for determining UL TX spatial filter to transmit the primary PUCCH(s) that carries the joint HARQ-ACK codebook. When/if the higher layer RRC parameter/indicator configured/provided in the higher layer RRC parameter, e.g., PUCCH-Resource or PUCCH-Config or PUCCH-ResourceSet or PUCCH-ResourceGroup, that configures the primary PUCCH(s) or PUCCH setting(s)/set(s)/group(s) in which the primary PUCCH(s) is configured is set to ‘10’ (or ‘00’ or ‘01’ or ‘11’), the UE 116 could use one or more (e.g., 2) spatial domain transmit filters that are the same as the spatial domain receive filters the UE 116 may use to simultaneously receive the DL reference signals associated with or indicated/provided in both of the indicated unified TCI states for receiving/monitoring the first and second DCIs/PDCCHs received in the first and second CORESETs associated/configured with values of 0 and 1 of CORESETPoolIndex according to one or more examples described herein to simultaneously transmit the primary PUCCH(s) that carries the joint HARQ-ACK codebook.

Equivalently, when/if the higher layer RRC parameter/indicator configured/provided in the higher layer RRC parameter, e.g., PUCCH-Resource or PUCCH-Config or PUCCH-ResourceSet or PUCCH-ResourceGroup, that configures the primary PUCCH(s) or PUCCH setting(s)/set(s)/group(s) in which the primary PUCCH(s) is configured is set to ‘10’ (or ‘00’ or ‘01’ or ‘11’), the indicated unified TCI states for receiving/monitoring both of the first and second DCIs/PDCCHs received in the first and second CORESETs associated/configured with values 0 and 1 of CORESETPoolIndex according to one or more examples described herein could provide references for determining one or more (e.g., 2) UL TX spatial filters to simultaneously transmit the primary PUCCH(s) that carries the joint HARQ-ACK codebook.

In yet another example, the UE 116 could use a spatial domain transmit filter that is the same as the spatial domain receive filter the UE 116 may use to receive the DL reference signal associated with or indicated/provided in the indicated unified TCI state(s) for receiving/monitoring the first DCI(s)/PDCCH(s) received in the first CORESET(s) associated/configured with value 0 of CORESETPoolIndex according one or more examples described herein to transmit the primary PUCCH(s) that carries the joint HARQ-ACK codebook.

Equivalently, the indicated unified TCI state(s) for receiving/monitoring the first DCI(s)/PDCCH(s) received in the first CORESET(s) associated/configured with value 0 of CORESETPoolIndex according to one or more examples described herein could provide a reference for determining UL TX spatial filter to transmit the primary PUCCH(s) that carries the joint HARQ-ACK codebook.

In yet another example, the UE 116 could use a spatial domain transmit filter that is the same as the spatial domain receive filter the UE 116 may use to receive the DL reference signal associated with or indicated/provided in the indicated unified TCI state(s) for receiving/monitoring the second DCI(s)/PDCCH(s) received in the second CORESET(s) associated/configured with value 1 of CORESETPoolIndex according to one or more examples described herein to transmit the primary PUCCH(s) that carries the joint HARQ-ACK codebook.

Equivalently, the indicated unified TCI state(s) for receiving/monitoring the second DCI(s)/PDCCH(s) received in the second CORESET(s) associated/configured with value 1 of CORESETPoolIndex according to one or more examples described herein could provide a reference for determining UL TX spatial filter to transmit the primary PUCCH(s) that carries the joint HARQ-ACK codebook.

In yet another example, the UE 116 could use one or more (e.g., 2) spatial domain transmit filters that are the same as the spatial domain receive filters the UE 116 may use to simultaneously receive the DL reference signals associated with or indicated/provided in both of the indicated unified TCI states for receiving/monitoring the first and second DCIs/PDCCHs received in the first and second CORESETs associated/configured with values of 0 and 1 of CORESETPoolIndex according to one or more examples described herein to simultaneously transmit the primary PUCCH(s) that carries the joint HARQ-ACK codebook.

Equivalently, the indicated unified TCI states for receiving/monitoring both of the first and second DCIs/PDCCHs received in the first and second CORESETs associated/configured with values 0 and 1 of CORESETPoolIndex according to one or more examples described herein could provide references for determining one or more (e.g., 2) UL TX spatial filters to simultaneously transmit the primary PUCCH(s) that carries the joint HARQ-ACK codebook.

In yet another example, the UE 116 could use a spatial domain transmit filter that is the same as the spatial domain receive filter the UE 116 may use to receive the DL reference signal associated with or indicated/provided in the indicated unified TCI state(s) for receiving/monitoring reference DCI(s)/PDCCH(s) according to one or more examples described herein to transmit the primary PUCCH(s) that carries the joint HARQ-ACK codebook.

Equivalently, the indicated unified TCI state(s) for receiving/monitoring reference DCI(s)/PDCCH(s) according to one or more examples described herein could provide a reference for determining UL TX spatial filter to transmit the primary PUCCH(s) that carries the joint HARQ-ACK codebook. Here, the reference DCI(s)/PDCCH(s) could correspond to the first DCI(s)/PDCCH(s) or the second DCI(s)/PDCCH(s) that is received the latest or later in time—among the first and second DCI(s)/PDCCH(s).

Alternatively, the reference DCI(s)/PDCCH(s) could correspond to the first DCI(s)/PDCCH(s) or the second DCI(s)/PDCCH(s) that is received the earliest or earlier in time—among the first and second DCI(s)/PDCCH(s).

In yet another example, the UE 116 could use a spatial domain transmit filter that is the same as the spatial domain receive filter the UE 116 may use to receive the DL reference signal associated with or indicated/provided in the indicated unified TCI state(s) for receiving/monitoring reference DCI(s)/PDCCH(s) according to one or more examples described herein to transmit the primary PUCCH(s) that carries the joint HARQ-ACK codebook.

Equivalently, the indicated unified TCI state(s) for receiving/monitoring reference DCI(s)/PDCCH(s) according to one or more examples described herein could provide a reference for determining UL TX spatial filter to transmit the primary PUCCH(s) that carries the joint HARQ-ACK codebook. Here, the reference DCI(s)/PDCCH(s) could correspond to the first DCI(s)/PDCCH(s) or the second DCI(s)/PDCCH(s) that is received in the first or second CORESET(s) associated/configured with the lowest value of CORESETPoolIndex (e.g., 0) or the lowest value of an entity ID such as PCI, PCI index, CORESETGroupIndex, etc.

Alternatively, the reference DCI(s)/PDCCH(s) could correspond to the first DCI(s)/PDCCH(s) or the second DCI(s)/PDCCH(s) that is received in the first or second CORESET(s) associated/configured with the highest value of CORESETPoolIndex (e.g., 1) or the highest value of an entity ID such as PCI, PCI index, CORESETGroupIndex, etc.

In yet another example, the UE 116 could use a spatial domain transmit filter that is the same as the spatial domain receive filter the UE 116 may use to receive the DL reference signal associated with or indicated/provided in the indicated unified TCI state(s) for receiving/monitoring reference DCI(s)/PDCCH(s) according to one or more examples described herein to transmit the primary PUCCH(s) that carries the joint HARQ-ACK codebook.

Equivalently, the indicated unified TCI state(s) for receiving/monitoring reference DCI(s)/PDCCH(s) according to one or more examples described herein could provide a reference for determining UL TX spatial filter to transmit the primary PUCCH(s) that carries the joint HARQ-ACK codebook. Here, the reference DCI(s)/PDCCH(s) could correspond to the first DCI(s)/PDCCH(s) or the second DCI(s)/PDCCH(s) that is received in the first or second CORESET(s) associated/configured with the serving cell or serving cell PCI.

In yet another example, the UE 116 could use a spatial domain transmit filter that is the same as the spatial domain receive filter the UE 116 may use to receive the DL reference signal associated with or indicated/provided in the indicated unified TCI state(s) for receiving/monitoring reference DCI(s)/PDCCH(s) according to one or more examples described herein to transmit the primary PUCCH(s) that carries the joint HARQ-ACK codebook.

Equivalently, the indicated unified TCI state(s) for receiving/monitoring reference DCI(s)/PDCCH(s) according to one or more examples described herein could provide a reference for determining UL TX spatial filter to transmit the primary PUCCH(s) that carries the joint HARQ-ACK codebook. Here, the reference DCI(s)/PDCCH(s) could correspond to the first DCI(s)/PDCCH(s) or the second DCI(s)/PDCCH(s) that schedules/activates the first or second PDSCH(s) that is received the earliest or earlier in time—among the first and second PDSCHs.

Alternatively, the reference DCI(s)/PDCCH(s) could correspond to the first DCI(s)/PDCCH(s) or the second DCI(s)/PDCCH(s) that schedules/activates the first or second PDSCH(s) that is received the latest or later in time—among the first and second PDSCHs.

In yet another example, the UE 116 could use a spatial domain transmit filter that is the same as the spatial domain receive filter the UE 116 may use to receive the DL reference signal associated with or indicated/provided in the indicated unified TCI state(s) for receiving/monitoring reference DCI(s)/PDCCH(s) according to one or more examples described herein to transmit the primary PUCCH(s) that carries the joint HARQ-ACK codebook.

Equivalently, the indicated unified TCI state(s) for receiving/monitoring reference DCI(s)/PDCCH(s) according to one or more examples described herein could provide a reference for determining UL TX spatial filter to transmit the primary PUCCH(s) that carries the joint HARQ-ACK codebook. Here, the reference DCI(s)/PDCCH(s) could correspond to the first DCI(s)/PDCCH(s) or the second DCI(s)/PDCCH(s) that is received in the first or second CORESET(s) associated/configured with the lowest CORESET ID(s)—among the first and second CORESETs.

Alternatively, the reference DCI(s)/PDCCH(s) could correspond to the first DCI(s)/PDCCH(s) or the second DCI(s)/PDCCH(s) that is received in the first or second CORESET(s) associated/configured with the highest CORESET ID(s)—among the first and second CORESETs.

In yet another example, the UE 116 could use a spatial domain transmit filter that is the same as the spatial domain receive filter the UE 116 may use to receive the DL reference signal associated with or indicated/provided in the indicated unified TCI state(s) for receiving/monitoring reference DCI(s)/PDCCH(s) according to one or more examples described herein to transmit the primary PUCCH(s) that carries the joint HARQ-ACK codebook.

Equivalently, the indicated unified TCI state(s) for receiving/monitoring reference DCI(s)/PDCCH(s) according to one or more examples described herein could provide a reference for determining UL TX spatial filter to transmit the primary PUCCH(s) that carries the joint HARQ-ACK codebook. Here, the reference DCI(s)/PDCCH(s) could correspond to the first DCI(s)/PDCCH(s) or the second DCI(s)/PDCCH(s) that carry/provide DL PDSCH assignment(s).

Alternatively, the reference DCI(s)/PDCCH(s) could correspond to the first DCI(s)/PDCCH(s) or the second DCI(s)/PDCCH(s) that does not carry/provide DL PDSCH assignment(s).

In yet another example, the UE 116 could use a spatial domain transmit filter that is the same as the spatial domain receive filter the UE 116 may use to receive the DL reference signal associated with or indicated/provided in the indicated unified TCI state(s) for receiving/monitoring reference DCI(s)/PDCCH(s) according to one or more examples described herein to transmit the primary PUCCH(s) that carries the joint HARQ-ACK codebook.

Equivalently, the indicated unified TCI state(s) for receiving/monitoring reference DCI(s)/PDCCH(s) according to one or more examples described herein could provide a reference for determining UL TX spatial filter to transmit the primary PUCCH(s) that carries the joint HARQ-ACK codebook. Here, the reference DCI(s)/PDCCH(s) could correspond to the first DCI(s)/PDCCH(s) or the second DCI(s)/PDCCH(s) that carry/provide unified TCI state(s) indication/update.

Alternatively, the reference DCI(s)/PDCCH(s) could correspond to the first DCI(s)/PDCCH(s) or the second DCI(s)/PDCCH(s) that does not carry/provide unified TCI state(s) indication/update.

In one embodiment, if a UE
is not provided CORESETPoolIndex or is provided CORESETPoolIndex with a value of 0 for first CORESETs on active DL BWPs of serving cells;
is provided CORESETPoolIndex with a value of 1 for second CORESETs on active DL BWPs of the serving cells;
is provided DLorJointTCIState or UL-TCIState; and
is provided ackNackFeedbackMode=joint,
   where
a serving cell is placed in a first set S₀ of N_{cells}^{DL,0} serving cells if the serving cell includes a first CORESET;
a serving cell is placed in a second set S₁ of N_{cells}^{DL,1} serving cells if the serving cell includes a second CORESET; and
serving cells are placed in a set according to an ascending order of a serving cell index,
   the UE 116 could first generate a (e.g., Type-1) HARQ-ACK codebook for the set S₀ and the set S₁ of serving cells separately by setting N_{cells}^{DL}=N_{cells}^{DL,0} and N_{cells}^{DL}=N_{cells}^{DL,1} in the corresponding HARQ-ACK codebook generation procedures specified herein or in document and standard [3]. The UE 116 could concatenate the HARQ-ACK codebook generated for the set S₀ followed by the HARQ-ACK codebook generated for the set S₁ to obtain a total number of O_{ACK} HARQ-ACK information bits for a joint HARQ-ACK codebook. According to one or more examples described herein, the joint HARQ-ACK codebook could be associated with or correspond to both first and second PDSCHs, wherein the first PDSCH(s) could be scheduled/activated by first DCI(s)/PDCCH(s) received in the first CORESET(s) associated/configured with value 0 of CORESETPoolIndex and the second PDSCH(s) could be scheduled/activated by second DCI(s)/PDCCH(s) received in the second CORESET(s) associated/configured with value 1 of CORESETPoolIndex. The UE 116 could transmit/send the joint HARQ-ACK codebook on one or more primary PUCCHs. Here, when the UE 116 would transmit the last symbol of a primary PUCCH with the joint HARQ-ACK codebook corresponding to the first and/or second DCIs/PDCCHs carrying the TCI State indication and without DL assignment, or corresponding to the first and/or second PDSCHs scheduled by the first and/or second DCIs/PDCCHs carrying the TCI State indication, and if the indicated TCI State(s) is different from the previously indicated one(s), the indicated DLorJointTCIState or UL-TCIstate should be applied starting from the first slot that is at least BeamAppTime_r17 symbols after the last symbol of the primary PUCCH. The first slot and the BeamAppTime_r17 symbols are both determined on the carrier with the smallest SCS among the carrier(s) applying the beam indication and associated with CORESETPoolIndex value(s) 0 and/or 1.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a first radio resource control (RRC) configuration related to one or more transmission configuration indication (TCI) states for reception of a physical downlink control channel (PDCCH);
receive a second RRC configuration related to one or more TCI states for reception of a physical downlink shared channel (PDSCH);
receive, in downlink control information (DCI), an indicator related to the one or more TCI states for reception of the PDSCH; and
receive a timing threshold for reception of the PDSCH; and
a processor operably coupled to the transceiver, the processor configured to:
identify, based on the first RRC configuration, one or more TCI states to use for reception of the PDCCH; and
identify, based on (i) the timing threshold and (ii) the second RRC configuration or the indicator in the DCI, one or more TCI states to use for reception of the PDSCH.

2. The UE of claim 1, wherein:
the DCI indicates a first TCI state or a second TCI state;
when the first RRC configuration is set to ‘first’, the processor is further configured to identify to use the first TCI state for reception of the PDCCH;
when the first RRC configuration is set to ‘second’, the processor is further configured to identity to use the second TCI state for reception of the PDCCH; and
when the first RRC configuration is set to ‘both’, the processor is further configured to identify to use both the first and second TCI states for reception of the PDCCH.

3. The UE of claim 1, wherein:
the transceiver is further configured to receive, in a medium access control (MAC) control element (CE), a TCI state; and
when the first RRC configuration is set to ‘none’, the processor is further configured to identify to use the TCI state for reception of the PDCCH.

4. The UE of claim 1, wherein:
the DCI indicates a first TCI state or a second TCI state;
when a time offset between a first symbol of the PDSCH and a last symbol of the PDCCH is less than the timing threshold, the processor is further configured to identify to use the first TCI state for reception of the PDSCH; and
when the time offset is greater than or equal to the timing threshold and:
when the second RRC configuration is set to ‘first’, the processor is further configured to identity to use the first TCI state for reception of the PDSCH;
when the second RRC configuration is set to ‘second’, the processor is further configured to identity to use the second TCI state for reception of the PDSCH; and
when the second RRC configuration is set to ‘both’, the processor is further configured to identify to use both the first and second TCI states for reception of the PDSCH.

5. The UE of claim 4, wherein:
when the time offset is greater than or equal to the timing threshold, when the second RRC configuration is set to ‘none’ or when the indicator is present in the DCI, and:
when the indicator is set to ‘first’, the processor is further configured to identity to use the first TCI state for reception of the PDSCH;
when the indicator is set to ‘second’, the processor is further configured to identity to use the second TCI state for reception of the PDSCH; and
when the indicator is set to ‘both’, the processor is further configured to identify to use both the first and second TCI states for reception of the PDSCH.

6. The UE of claim 1, wherein:
the DCI indicates a first TCI state or a second TCI state; and
when both the first and second TCI states are used for reception of the PDSCH, the processor is further configured to identify to use:
the first TCI state for receiving a PDSCH demodulation reference signal (DM-RS) in a first DM-RS code-division multiplexing (CDM) group indicated by an antenna ports field in the DCI; and
the second TCI state for receiving a PDSCH DM-RS in a second DM-RS CDM group indicated by the antenna ports field in the DCI.

7. The UE of claim 1, wherein:
the first RRC configuration is provided in higher layer parameter ControlResourceSet that configures a control resource set (CORESET), in which the PDCCH is received or monitored,
the PDSCH is scheduled or activated by the PDCCH with the first RRC configuration provided to the CORESET, and
the first RRC configuration is set to ‘first’, ‘second’ or ‘both’.

8. A base station (BS), comprising:
a transceiver configured to:
transmit a first radio resource control (RRC) configuration related to one or more transmission configuration indication (TCI) states for reception of a physical downlink control channel (PDCCH);
transmit a second RRC configuration related to one or more TCI states for reception of a physical downlink shared channel (PDSCH);
transmit, in downlink control information (DCI), an indicator related to the one or more TCI states for reception of the PDSCH; and
transmit a timing threshold for reception of the PDSCH,
wherein the first RRC configuration indicates one or more TCI states to use for reception of the PDCCH, and
wherein (i) the timing threshold and (ii) the second RRC configuration or the indicator in the DCI indicate one or more TCI states to use for reception of the PDSCH.

9. The BS of claim 8, wherein:
the DCI indicates a first TCI state or a second TCI state;
when the first RRC configuration is set to ‘first’, the first TCI state is used for reception of the PDCCH;
when the first RRC configuration is set to ‘second’, the second TCI state is used for reception of the PDCCH; and
when the first RRC configuration is set to ‘both’, both the first and second TCI states are used for reception of the PDCCH.

10. The BS of claim 8, wherein:
the transceiver is further configured to transmit, in a medium access control (MAC) control element (CE), a TCI state; and
when the first RRC configuration is set to ‘none’, the TCI state is used for reception of the PDCCH.

11. The BS of claim 8, wherein:
the DCI indicates a first TCI state or a second TCI state;
when a time offset between a first symbol of the PDSCH and a last symbol of the PDCCH is less than the timing threshold, the first TCI state is used for reception of the PDSCH; and
when the time offset is greater than or equal to the timing threshold and:
when the second RRC configuration is set to ‘first’, the first TCI state is used for reception of the PDSCH;
when the second RRC configuration is set to ‘second’, the second TCI state is used for reception of the PDSCH; and
when the second RRC configuration is set to ‘both’, both the first and second TCI states are used for reception of the PDSCH.

12. The BS of claim 11, wherein:
when the time offset is greater than or equal to the timing threshold, when the second RRC configuration is set to ‘none’ or when the indicator is present in the DCI, and:
when the indicator is set to ‘first’, the first TCI state is used for reception of the PDSCH;
when the indicator is set to ‘second’, the second TCI state is used for reception of the PDSCH; and
when the indicator is set to ‘both’, both the first and second TCI states are used for reception of the PDSCH.

13. The BS of claim 8, wherein:
the DCI indicates a first TCI state or a second TCI state; and
when both the first and second TCI states are used for reception of the PDSCH:
the first TCI state is used for reception of a PDSCH demodulation reference signal (DM-RS) in a first DM-RS code-division multiplexing (CDM) group indicated by an antenna ports field in the DCI; and
the second TCI state is used for reception of a PDSCH DM-RS in a second DM-RS CDM group indicated by the antenna ports field in the DCI.

14. The BS of claim 8, wherein:
the first RRC configuration is provided in higher layer parameter ControlResourceSet that configures a control resource set (CORESET), in which the PDCCH is received or monitored,
the PDSCH is scheduled or activated by the PDCCH with the first RRC configuration provided to the CORESET, and
the first RRC configuration is set to ‘first’, ‘second’ or ‘both’.

15. A method performed by a user equipment (UE), the method comprising:
receiving a first radio resource control (RRC) configuration related to one or more transmission configuration indication (TCI) states for reception of a physical downlink control channel (PDCCH);
receiving a second RRC configuration related to one or more TCI states for reception of a physical downlink shared channel (PDSCH);
receiving, in downlink control information (DCI), an indicator related to the one or more TCI states for reception of the PDSCH;
receiving a timing threshold for reception of the PDSCH;
identifying, based on the first RRC configuration, one or more TCI states to use for reception of the PDCCH; and
identifying, based on (i) the timing threshold and (ii) the second RRC configuration or the indicator in the DCI, one or more TCI states to use for reception of the PDSCH.

16. The method of claim 15, wherein:
the DCI indicates a first TCI state or a second TCI state;
when the first RRC configuration is set to ‘first’, identifying one or more TCI states to use for reception of the PDCCH further comprises identifying to use the first TCI state for reception of the PDCCH;
when the first RRC configuration is set to ‘second’, identifying one or more TCI states to use for reception of the PDCCH further comprises identifying to use the second TCI state for reception of the PDCCH; and
when the first RRC configuration is set to ‘both’, identifying one or more TCI states to use for reception of the PDCCH further comprises identifying to use both the first and second TCI states for reception of the PDCCH.

17. The method of claim 15, further comprising:
receiving, in a medium access control (MAC) control element (CE), a TCI state,
wherein, when the first RRC configuration is set to ‘none’, identifying one or more TCI states to use for reception of the PDCCH further comprises identifying to use the TCI state for reception of the PDCCH.

18. The method of claim 15, wherein:
the DCI indicates a first TCI state or a second TCI state;
when a time offset between a first symbol of the PDSCH and a last symbol of the PDCCH is less than the timing threshold, identifying one or more TCI states to use for reception of the PDSCH further comprises identifying to use the first TCI state for reception of the PDSCH; and
when the time offset is greater than or equal to the timing threshold and:
when the second RRC configuration is set to ‘first’, identifying one or more TCI states to use for reception of the PDSCH further comprises identifying to use the first TCI state for reception of the PDSCH;
when the second RRC configuration is set to ‘second’, identifying one or more TCI states to use for reception of the PDSCH further comprises identifying to use the second TCI state for reception of the PDSCH; and
when the second RRC configuration is set to ‘both’, identifying one or more TCI states to use for reception of the PDSCH further comprises identifying to use both the first and second TCI states for reception of the PDSCH.

19. The method of claim 18, wherein:
when the time offset is greater than or equal to the timing threshold, when the second RRC configuration is set to ‘none’ or when the indicator is present in the DCI, and:
when the indicator is set to ‘first’, identifying one or more TCI states to use for reception of the PDSCH further comprises identifying to use the first TCI state for reception of the PDSCH;
when the indicator is set to ‘second’, identifying one or more TCI states to use for reception of the PDSCH further comprises identifying to use the second TCI state for reception of the PDSCH; and
when the indicator is set to ‘both’, identifying one or more TCI states to use for reception of the PDSCH further comprises identifying to use both the first and second TCI states for reception of the PDSCH.

20. The method of claim 15, wherein:
the DCI indicates a first TCI state or a second TCI state; and
the method further comprises, when both the first and second TCI states are used for reception of the PDSCH, identifying to use:
the first TCI state for receiving a PDSCH demodulation reference signal (DM-RS) in a first DM-RS code-division multiplexing (CDM) group indicated by an antenna ports field in the DCI; and
the second TCI state for receiving a PDSCH DM-RS in a second DM-RS CDM group indicated by the antenna ports field in the DCI.
